(19) United States
(12) Patent Application Publication
(10) Pub. No.: US 2016/0078373 A1
(43) Pub. Date: Mar. 17, 2016

(54) METHOD FOR CONTROLLING COMMUNICATION DEVICE, METHOD FOR PROVIDING INFORMATION IN INFORMATION MANAGEMENT SYSTEM, AND COMPUTER-READABLE RECORDING MEDIUM

(71) Applicant: PANASONIC INTELLECTUAL PROPERTY CORPORATION OF AMERICA, Torrance, CA (US)

(72) Inventor: Takamitsu SASAKI, Kanagawa (JP)

(73) Assignee: PANASONIC INTELLECTUAL PROPERTY CORPORATION OF AMERICA, Torrance, CA (US)

(21) Appl. No.: 14/861,240

(22) Filed: Sep. 22, 2015

Related U.S. Application Data
(63) Continuation of application No. PCT/JP2014/002351, filed on Apr. 25, 2014.
(60) Provisional application No. 61/931,139, filed on Jan. 24, 2014.

(51) Int. Cl. G06Q 10/02; G06Q 10/10

(52) U.S. Cl. CPC G06Q 10/02; G06Q 10/1095

(57) ABSTRACT

A method causes a computer of a communication device to: determine candidate reservation dates and times of a ticket by excluding each date and time, on which a plan of the user is stored in a memory, from acquired available reservation dates and times of the ticket; display each display representing each candidate reservation time, and when an interval between one acquired available reservation date and time and a date and time on which the plan is stored in the memory is shorter than a predetermined value, the one acquired available reservation date and time being excluded from the determined candidate reservation dates and times; and display a reservation screen when selection of one region is detected in the calendar data, the reservation screen being used for setting one candidate reservation date and time corresponding to the selected one region as a reservation date and time of the ticket.

### TECHNICAL FIELD

The present disclosure relates to a method for controlling a communication device used in an information management system which performs a reservation process of a ticket such as a concert ticket or an airline ticket, a method for providing information in the information management system which performs a reservation process of the ticket, and a computer-readable recording medium.

### BACKGROUND ART

Conventionally, for example, there is a technique disclosed in Patent Document 1 as an information management system that performs a reservation process of a ticket such as an airline ticket. Patent Document 1 relates to a flight reservation system.

The flight reservation system mentioned above includes a web server on the Internet for making a flight reservation. A product storing product setting items including a departure airport, an arrival airport, a transfer airport, an airline used, an airline of transfer flight, a used (boarding) class, a used (boarding) class of airline of transfer flight, and a CRS category is displayed on a website. When a reservation input is made, a reservation process is performed by automatically discriminating an airline reservation system (CRS).

However, the conventional art described above requires further improvements.

### CITATION LIST

### Patent Document

Patent Document 1: Japanese Unexamined Patent Publication No. 2002-170015 (for example, FIG. 11 and the like)

### SUMMARY OF INVENTION

In one general aspect, the techniques disclosed here feature a method that causes a computer of a communication device to: determine candidate reservation dates and times of a ticket by excluding each date and time, on which a plan of the user is stored in a memory, from acquired available reservation dates and times of the ticket; display each display representing each candidate reservation time, and when an interval between one acquired available reservation date and time and a date and time on which the plan is stored in the memory is shorter than a predetermined value, the one acquired available reservation date and time being excluded from the determined candidate reservation dates and times; and display a reservation screen when selection of one region is detected in the calendar data, the reservation screen being used for setting one candidate reservation date and time corresponding to the selected one region as a reservation date and time of the ticket.

Accordingly, further improvements can be achieved. These general and specific aspects may be implemented using a system, a method, and a computer program, and any combination of systems, methods, and computer programs.

### BRIEF DESCRIPTION OF DRAWINGS

FIG. 1 is a diagram showing a first example of an overall configuration of a reservation system according to the present disclosure.

FIG. 2 is a diagram showing a second example of an overall configuration of a reservation system according to the present disclosure.

FIG. 3 is a diagram showing a third example of an overall configuration of a reservation system according to the present disclosure.

FIG. 4 is a diagram showing a fourth example of an overall configuration of a reservation system according to the present disclosure.

FIG. 5 is a block diagram showing a configuration pattern of a reservation system according to the first example.

FIG. 6 is a block diagram showing a configuration pattern of a reservation system according to the first example.

FIG. 7 is a block diagram showing a configuration pattern of a reservation system according to the first example.

FIG. 8 is a block diagram showing a configuration pattern of a reservation system according to the first example.

FIG. 9 is a block diagram showing a configuration pattern of a reservation system according to the second example.

FIG. 10 is a block diagram showing a configuration pattern of a reservation system according to the third example.

FIG. 11 is a block diagram showing a configuration pattern of a reservation system according to the third example.

FIG. 12 is a block diagram showing a configuration pattern of a reservation system according to the fourth example.

FIG. 13 is a diagram showing an example of a basic screen.

FIG. 14 is a diagram showing an example of a top screen.

FIG. 15 is a diagram showing an example of a top screen.

FIG. 16 is a diagram showing an example of a top screen.

FIG. 17 is a diagram showing an example of a reservation guide notification screen.

FIG. 18 is a diagram showing an example of a ticket confirmation screen.

FIG. 19 is a diagram showing a first example of a reservation date selection screen.

FIG. 20 is a diagram showing a second example of a reservation date selection screen.

FIG. 21 is a diagram showing an example of a reservation date selection screen for a month following the reservation date selection screen shown in FIG. 20.

FIG. 22 is a diagram showing a third example of a reservation date selection screen.

FIG. 23 is a diagram showing a fourth example of a reservation date selection screen.

FIG. 24 is a diagram showing an example of a reservation time selection screen.

FIG. 25 is a diagram showing a reservation time selection screen in a state in which a candidate reservation time is selected.

FIG. 26 is a diagram showing an example of a reservation content confirmation screen.

FIG. 27 is a diagram showing a first example of a reservation completion screen.

FIG. 28 is a diagram showing a second example of a reservation completion screen.

FIG. 29 is a diagram showing an example of a reservation detail confirmation screen.

FIG. 30 is a diagram showing a screen flow according to the present disclosure.

FIG. 31 is a diagram showing an example of a data configuration of customer history.

FIG. 32 is a diagram showing an example of a data configuration of customer information.

FIG. 33 is a diagram showing an example of a data configuration of a ticket list.

FIG. 34 is a diagram showing an example of a data configuration of recommended ticket information.

FIG. 35 is a diagram showing an example of a data configuration of a calendar plan list.

FIG. 36 is a diagram showing an example of a data configuration of a reservation available date list.

FIG. 37 is a diagram showing an example of a data configuration of a candidate reservation date list.

FIG. 38 is a sequence diagram showing a first example of an automatic startup process of a reservation application.

FIG. 39 is a sequence diagram showing a second example of an automatic startup process of a reservation application.

FIG. 40 is a sequence diagram showing a startup process of a reservation application when the reservation application is an embedded application.

FIG. 41 is a sequence diagram showing a startup process of a reservation application when the reservation application is an HTML application.

FIG. 42 is a sequence diagram of an overall process sequence of a first example of a reservation system according to the present disclosure.

FIG. 43 is a sequence diagram of an overall process sequence of a second example of a reservation system according to the present disclosure.

FIG. 44 is a sequence diagram of an overall process sequence of a third example of a reservation system according to the present disclosure.

FIG. 45 is a sequence diagram of an overall process sequence of a fourth example of a reservation system according to the present disclosure.

FIG. 46 is a sequence diagram of an overall process sequence of a fifth example of a reservation system according to the present disclosure.

FIG. 47 is a sequence diagram of an overall process sequence of a sixth example of a reservation system according to the present disclosure.

FIG. 48 is a sequence diagram showing a startup process of a calendar application when the calendar application is an embedded application.

FIG. 49 is a sequence diagram showing a startup process of a calendar application when the calendar application is an HTML application.

FIG. 50 is a flow chart showing a first example of an automatic startup process of a reservation application.

FIG. 51 is a flow chart showing a second example of an automatic startup process of a reservation application.

FIG. 52 is a flow chart showing an example of an overall process of a reservation application.

FIG. 53 is a flow chart showing details of a display process (S5202 in FIG. 52, S5407 in FIG. 54, and S5909 in FIG. 59) of a top screen.

FIG. 54 is a flow chart showing an example of a display process of a ticket confirmation screen (S5203 in FIG. 52, S5307 in FIG. 53, and S5807 in FIG. 58).

FIG. 55 is a flow chart showing a first example of a display process (S5204 in FIG. 52 and S5405 in FIG. 54) of a reservation date selection screen.

FIG. 56 is a flow chart showing a second example of a display process (S5204 in FIG. 52 and S5405 in FIG. 54) of a reservation date selection screen.

FIG. 57 is a flow chart showing a third example of a display process (S5204 in FIG. 52 and S5405 in FIG. 54) of a reservation date selection screen.

FIG. 58 is a flow chart representing a continuation of FIGS. 55 to 57.

FIG. 59 is a flow chart showing a display process (S5207 in FIG. 52) of a reservation completion screen.

FIG. 60 is a flow chart showing a process of a first example of a reservation server.

FIG. 61 is a flow chart showing a process of a second example of a reservation server.

FIG. 62 is a flow chart showing a process of a third example of a reservation server.

FIG. 63 is a flow chart showing an example of a process (S6003 in FIG. 60, S6103 in FIG. 61, and S6203 in FIG. 62) of calculating a price for each reservation available date and time.

FIG. 64 is a flow chart showing a first example of an extraction process of a candidate reservation date by a reservation server or a reservation terminal.

FIG. 65 is a flow chart showing a second example of an extraction process of a candidate reservation date by a reservation server or a reservation terminal.

FIG. 66 is a flow chart showing a third example of an extraction process of a candidate reservation date by a reservation server or a reservation terminal.

FIG. 67 is a flow chart showing a fourth example of an extraction process of a candidate reservation date by a reservation server or a reservation terminal.

FIG. 68 is a flow chart showing a fifth example of an extraction process of a candidate reservation date by a reservation server or a reservation terminal.

FIG. 69 is a flow chart showing a sixth example of an extraction process of a candidate reservation date by a reservation server or a reservation terminal.

### DETAILED DESCRIPTION

(Circumstances Leading to the Invention of an Aspect of the Present Disclosure)

When a user makes a reservation of a flight using the flight reservation system disclosed in Patent Document 1, the following processes are performed.

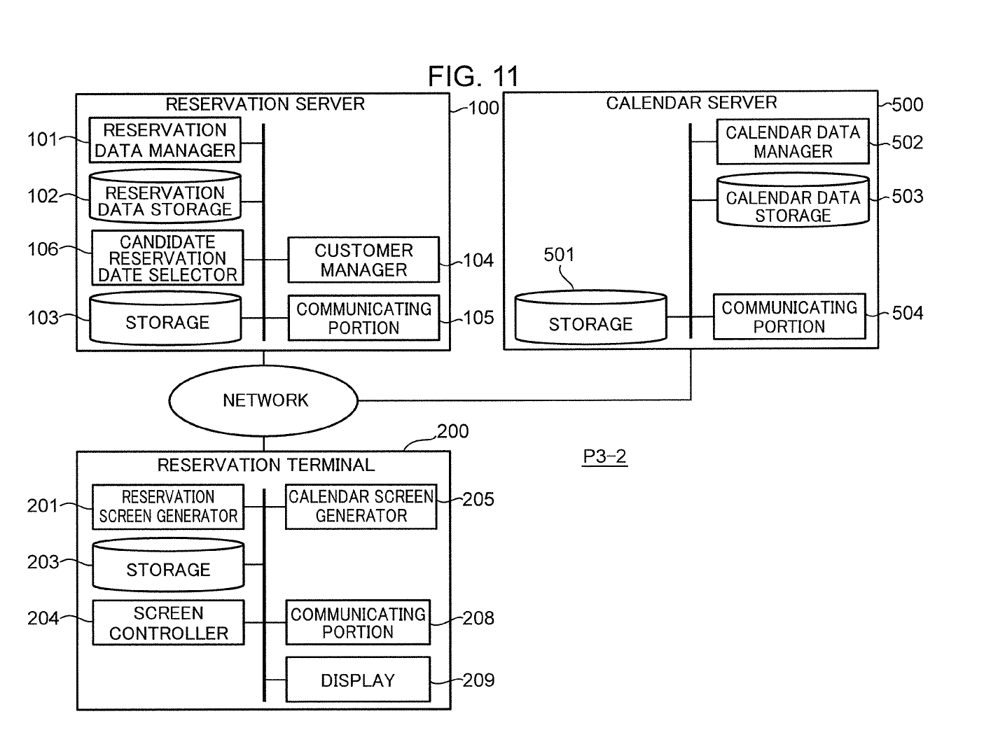

First, the user accesses a web server using a communication device. A web page including a setting screen for making a flight reservation is displayed on the communication device. The user uses the setting screen to respectively input a city of departure, a region, a boarding (used) class, and an airline (arbitrary). Since the web server displays a city list on the web page, the user selects a desired destination. The web server displays lists of different airlines, prices, product titles, and airfare types (boarding classes) on the web page as products of concern and contents thereof. As the operation using the list display advances and the user clicks a “go to reservation after available seat inquiry” icon on the screen, the communication device accesses a computer of an airline reservation system (CRS) set in advance and an available seat inquiry screen (FIG. 11 in Patent Document 1) is displayed on the web page. The user inputs a desired outbound departure date, inbound departure date, and the number of passengers on the available seat inquiry screen. The user confirms input results on an available seat inquiry result screen and clicks a “reserve” icon. Subsequently, the reservation process ends after performing several post-processes (paragraph [0006] in Patent Document 1).

Meanwhile, service operators recently provide a communication device of the user with a calendar function via a network. However, a reservation process by the flight reservation system is not linked with calendar data that is handled by the calendar function.

There may be cases where the user is already using the calendar function to manage the user's schedule. In this case, for example, when inputting a desired outbound departure date, inbound departure date, and the number of passengers on the available seat inquiry screen (FIG. 11 in Patent Document 1), the user must check whether or not the departure dates to be input do not overlap with other schedules of the user. Therefore, the user must cause calendar data that is handled by the calendar function to be displayed on the communication device of the user separately from the display screen included in a web page provided by the flight reservation system. Subsequently, the user compares the departure dates to be input with calendar data of the user. Therefore, the reservation process described above becomes complicated. As a result, the convenience offered by the calendar function cannot be advantageously utilized and, instead, the reservation process becomes even more complicated. Therefore, there is a risk that the user may make an erroneous input and register an incorrect reservation date.

In addition, there may be cases where, for example, even if a date to be input (for example, a departure date, a concert date, or a date of a sports event) overlaps with a date on which the user plans to go out, if a distance between, for example, an airport and an outing destination is short, a flight can be reserved for the departure date even though the departure date coincides with a date on which the user plans to go out. However, the user confirms a display screen included in the web page provided by the flight reservation system and the calendar data that is handled by the calendar function by separately viewing the display screen and the calendar data. Therefore, operations involving comparing and confirming both the display screen and the calendar data occur repetitively and may cause processing efficiency of a flight reservation to decline. Therefore, even when there is a time slot in which a reservation can be made by the user, the user may overlook the time slot. As a result, for example, there may be cases where the user is unable to register a reservation for a time slot due to the process of a flight reservation becoming complicated even though a reservation can be made for the time slot. In addition, there is a risk that the user may make an erroneous input and register a reservation for a wrong time slot.

In order to solve the above problems, the inventors have come up with the inventions with the following aspects.

An aspect of the present disclosure is a method for controlling a communication device having a display and being used in an information management system, the information management system performing a reservation process of a ticket via a network connected to a ticket issuing institution of the ticket,

the communication device having a memory for storing schedule information of a user of the communication device,

the method causing a computer of the communication device to:

display display data on the display, the display data being generated using the stored schedule information with calendar data, the calendar data representing each day on a per month or per week basis;

access the information management system via the network to acquire available reservation dates and times of the ticket from the information management system when performing the reservation process of the ticket;

determine candidate reservation dates and times of the ticket by excluding each date and time, on which a plan of the user is stored in the memory, from the acquired available reservation dates and times of the ticket;

display each display representing each candidate reservation time based on the candidate reservation dates and times, in each region corresponding to each day represented in the calendar data, wherein when an interval between i) one acquired available reservation date and time of the ticket and ii) a date and time on which a plan of the user is stored in the memory is shorter than a predetermined value, the one acquired available reservation date and time is excluded from the determined candidate reservation dates and times of the ticket; and

display a reservation screen on the display when selection of one region is detected in the calendar data, the one region corresponding to one day in the calendar data and representing one candidate reservation time, the reservation screen being used for setting one candidate reservation date and time corresponding to the selected one region as a reservation date and time of the ticket.

According to the present aspect, when the user desires to reserve the ticket (for example, a concert ticket, a ticket of a sports event, or an airline ticket), the user can cause a reservation screen for reserving the ticket to be displayed using the calendar data. In other words, the calendar data doubles as an instruction screen for causing a reservation screen of the ticket to be displayed. Therefore, the user can avoid the hassle of separately starting up and displaying the calendar data and the reservation screen and collating the separately displayed calendar data and reservation screen with each other. Therefore, efficiency of the reservation process of the ticket can be improved.

In addition, according to the present aspect, the calendar data is displayed on a display of a communication device of the user. Using the calendar data which is a shared medium, the user's plans are confirmed and candidate reservation times of the ticket are displayed at the same time on the communication device. Accordingly, the calendar data which is a shared medium is used as described above. As a result, the candidate reservation times of the ticket can be presented to the user on a same screen which displays the plans of the user. Therefore, for example, by referring to the candidate reservation time and another plan of the user before or after the candidate reservation time on a same day, determinations such as whether the ticket venue can be reached by the candidate reservation time on the same day may be readily made while considering a location of the other plan or a travel time from the location of the other plan to the ticket venue. As a result, for example, the hassle of having to repetitively adjust reservation dates and times with the ticket issuing institution due to the user being unable to reach the ticket venue by the candidate reservation time can be avoided and the reservation process of the ticket can be streamlined. As described above, both the plans of the user and the plan of the event related to the ticket can be confirmed at the same time. Therefore, the reservation process of the ticket can be streamlined.

Furthermore, according to the present aspect, candidate reservation times of the ticket are displayed in each region corresponding to each day that is represented in the calendar data after excluding each date and time on which a plan of the user is stored in the memory. Accordingly, since the calendar data that is a shared medium is used as described above, candidate reservation dates and times of the ticket can be presented to the user among dates and times on which plans of the user are not yet stored in the memory on a same screen as the display of the plans of the user. Therefore, by a stage where candidate reservation times of the ticket are displayed in a region corresponding to each day that is represented in the calendar data, each date and time on which a plan of the user is stored in the memory has already been excluded from the candidate reservation times of the ticket. Thus, the candidate reservation dates and times that are likely to be selected by the user can be presented in an efficient manner. As a result, the hassle of the user of having to exclude dates and times at which the user is unavailable from the candidate reservation dates and times due to the inclusion of such dates and times at which the user is unavailable in the candidate reservation dates and times can be avoided. In addition, the hassle of the user of having to change the user's plans to make room for the candidate reservation dates and times can be avoided. Therefore, the reservation process of the ticket can be streamlined.

In the aspect described above, for example, the method may further cause the computer of the communication device to:

transmit a reservation request to the information management system via the network based on a result of a reservation made using the reservation screen, the reservation request indicating the one candidate reservation date and time corresponding to the selected one region; and

perform registration of the one candidate reservation date and time corresponding to the selected one region in the information management system, as the reservation date and time of the ticket.

According to the present aspect, a process of registering a reservation date and time of the ticket to the information management system is completed.

In the aspect described above, for example, the method may further cause the computer of the communication device to display the reservation date and time of the ticket within the one region in the calendar data, when the registration has been completed in the information management system.

For example, when an operation for registering a reservation date and time of the ticket in the calendar data occurs separately after performing a reservation process of the ticket, since a registration operation in the calendar data is to be performed separately from the reservation process of the ticket, the processes become a hassle. When the user forgets to register the reservation date and time of the ticket in the calendar data, the user may forget to visit a location where the ticket is to be used (for example, a concert venue or an airport) even though the ticket has been reserved.

According to the present aspect, a reservation date and time of the ticket which has been registered in the information management system is displayed in a region corresponding to the reservation date and time represented in the calendar data. Accordingly, the calendar data includes the reservation date and time of the ticket. In other words, a result of the reservation of the ticket is reflected in the calendar data. Therefore, the user need not take the trouble of registering the reservation result in the calendar data. Thus, after performing a reservation process of the ticket, the user can be prevented from forgetting to visit a location where the ticket is to be used (for example, a concert venue or an airport) because the user forgot to register the reservation date and time of the ticket in the calendar data.

In the aspect described above, for example, the method may further cause the computer of the communication device to display on the display a message indicating completion of the registration, in association with the display of the calendar data.

According to the present aspect, a message indicating completion of the registration is displayed on the display in association with the display of the calendar data. Accordingly, the user can be effectively reminded using existing display resources as to for what purpose a reservation had been made and when the reservation was made.

In the aspect described above, for example,

the information management system may collect to manage customer information via the network, the customer information being associated with the user of the communication device, and

a notice may be received from the information management system via the network when it is determined in the information management system based on the customer information that a ticket, which is in accordance with preferences of the user of the communication device, is present, wherein the notice indicates that the ticket is present.

According to the present aspect, when it is determined based on the customer information that a ticket in accordance with the preferences of a user of the communication device is present, a notice to that effect is arranged to be received from the information management system via the network. Accordingly, if there is a ticket in accordance with the preferences of a user of the communication device, even when the user is not aware of that fact, a candidate reservation date and time of the ticket can be presented based on the customer information. Therefore, for example, even when the user of the communication device is not aware of the existence of the ticket, the user can reserve the ticket.

In the aspect described above, for example, the calendar data included in the display data may represent each day of a concerned month,

the method may further cause the computer of the communication device to:

in a case where the each display representing the each candidate reservation time of the ticket is included in respective displays of the concerned month and a following month, display a display notice in the display data which includes the calendar data representing each day of the concerned month, wherein the display notice indicates that each display representing each remaining candidate reservation time is to be displayed in each region corresponding to each day included in the display of the following month.

For example, when today is the end of a month, a display representing the candidate reservation time may sometimes be included not only in the concerned month but also in a following month. In such a case, when a display representing the candidate reservation time is to be selected in a region corresponding to any of days included in the concerned month that is presently displayed, for example, the user is to be asked to select a reservation date and time in a constrained manner with respect to plans of the user from a range that is narrower than an original range of candidate reservation dates and times. In addition, for example, when a display representing a candidate reservation time is not provided in a region corresponding to days included in the concerned month and a display representing a candidate reservation time is hidden in a region corresponding to days included in a display of the following month, the user may overlook the hidden display and fail to set a reservation date and time.

According to the present aspect, a display notice indicating that each display representing each remaining candidate reservation time is to be displayed in each region corresponding to each day included in the display of the following month is displayed in the display data including the calendar data representing each day of the concerned month. Accordingly, for example, when a display representing the candidate reservation time is included not only in the display of the concerned month but also in the display of the following month, an original candidate reservation date and time is to be presented to the user. Therefore, a situation can be avoided where, for example, the user is asked to select a reservation date and time in a constrained manner from a range that is narrower than an original range of candidate reservation dates and times. In addition, for example, when a display representing a candidate reservation time is not included in the display of the concerned month and a display representing a candidate reservation time is included in the display of the following month, the user can be prevented from overlooking the hidden display. As a result, a reservation date and time that is suitable for the user with respect to plans of the user can be selected from an original range of candidate reservation dates and times without omitting an original candidate reservation date and time.

In the aspect described above, for example, the calendar data included in the display data may represent each day of a concerned week,

the method may further cause the computer of the communication device to:

in a case where the each display representing the each candidate reservation time of the ticket is included in respective displays of the concerned week and a following week, display a display notice in the display data which includes the calendar data representing each day of the concerned week, wherein the display notice indicates that each display representing each remaining candidate reservation time is to be displayed in each region corresponding to each day included in the display of the following week.

For example, when today is a weekend, a display representing the candidate reservation time may sometimes be included not only in the concerned week but also in a following week. In such a case, when a display representing the candidate reservation time is to be selected in a region corresponding to any of days included in the concerned week that is presently displayed, for example, the user is to be asked to select a reservation date and time in a constrained manner with respect to plans of the user from a range that is narrower than an original range of candidate reservation dates and times. In addition, for example, when a display representing a candidate reservation time is not provided in a region corresponding to days included in the concerned week and a display representing a candidate reservation time is hidden in a region corresponding to days included in a display of the following week, the user may overlook the hidden display and fail to set a reservation date and time.

According to the present aspect, a display notice indicating that each display representing each remaining candidate reservation time is to be displayed in each region corresponding to each day included in the display of the following week is displayed in the display data including the calendar data representing each day of the concerned week. Accordingly, for example, when a display representing the candidate reservation time is included not only in the display of the concerned week but also in the display of the following week, an original candidate reservation date and time is to be presented to the user. Therefore, a situation can be avoided where, for example, the user is asked to select a reservation date and time in a constrained manner from a range that is narrower than an original range of candidate reservation dates and times. In addition, for example, when a display representing a candidate reservation time is not included in the display of the concerned week and a display representing a candidate reservation time is included in the display of the following week, the user can be prevented from overlooking the hidden display. As a result, a reservation date and time that is suitable for the user with respect to plans of the user can be selected from an original range of candidate reservation dates and times without omitting an original candidate reservation date and time.

In the aspect described above, for example,

a region corresponding to a day, which includes a plan of the user in the calendar data, may be displayed in a first display color, and

the each region corresponding to the each day, which includes the each display representing the each candidate reservation time of the ticket in the calendar data, may be displayed in a second display color different from the first display color.

According to the present aspect, a plan of the user and a candidate reservation time of the ticket are distinguished by and displayed in different display colors in the calendar data. Accordingly, a plan of the user and a candidate reservation time of the ticket can be easily distinguished from one another. Therefore, a misoperation involving overlooking a candidate reservation time of the ticket or a misoperation involving misidentifying a display representing a candidate reservation time of the ticket for a display of a plan of the user can be prevented. As a result, the user can be made aware of candidate reservation dates and times of the ticket in an appropriate manner and a misoperation involving misidentifying a display representing the candidate reservation time of the ticket can be prevented.

In the aspect described above, for example, a price of the ticket may be displayed, when the each display representing the each candidate reservation time of the ticket is displayed in the each region corresponding to the each day represented in the calendar data.

For example, there may be cases where prices of the ticket differ between when bought one month in advance and when bought two months in advance. In addition, prices of the ticket may sometimes differ between weekdays and weekends. When there are a plurality of candidate reservation dates and times of the ticket, the candidate reservation date and time is to be selected in relation to plans of the user. However, if prices of the ticket are to be displayed, the candidate reservation date and time can be selected by also taking the prices into consideration. According to the present aspect, the user can confirm the prices before selecting a reservation date and time from the candidate reservation dates and times. In addition, for example, the user can select a candidate reservation date and time with a lower price after confirming the prices.

In the aspect described above, for example, the method may further cause the computer of the communication device to:

in a case where a region corresponding to a given day represented in the calendar data does not have an enough area to display all of displays which represent a plurality of candidate reservation times corresponding to the given day, display a display representing a candidate reservation date of the ticket in the region corresponding to the given day, without displaying all of the displays representing the plurality of the candidate reservation times corresponding to the given day in the region corresponding to the given day.

A region corresponding to each day represented in the calendar data is limited in terms of display area. For example, there may be cases where another schedule is already registered in a region corresponding to a given day represented in the calendar data. In addition, there may be cases where a plurality of candidate reservation times are provided in a region corresponding to a given day represented in the calendar data even when no other schedules are registered in the region corresponding to the given day. In such cases, all of the displays of candidate reservation times corresponding to the given day cannot necessarily be displayed.

According to the present aspect, when all of the displays representing candidate reservation times corresponding to a given day represented in the calendar data cannot be displayed in a region corresponding to the given day, a display representing candidate reservation dates of the ticket is displayed in the region corresponding to the given day instead of displaying a display representing candidate reservation times corresponding to the given day. Accordingly, in this case, even when the candidate reservation dates and times are not displayed in the region corresponding to the given day, the fact that the given day is a candidate reservation date of the ticket can be notified. Therefore, a situation can be prevented where only a part of displays of candidate reservation times corresponding to the given day is displayed and a reservation process is performed based on a misidentification that candidate reservation times that are not displayed do not exist.

In such a case, an aspect may be adopted in which, for example, all of the displays of candidate reservation times corresponding to the given day are separately displayed by selecting a display representing a candidate reservation date of the ticket.

In the aspect described above, for example, the communication device may be configured to be able to register the plan of the user in the each region corresponding to the each day represented in the calendar data.

An aspect of the present disclosure is a method for providing information in an information management system which performs a reservation process of a ticket via a network connected to a ticket issuing institution of the ticket, the method comprising:

receiving, from a communication device of an authenticated user, an inquiry signal and schedule information of the user via the network, the inquiry signal being related to the reservation process of the ticket, the schedule information of the user being stored in a memory of the communication device;

acquiring first candidate data using a database in response to the inquiry signal, the database storing available reservation dates and times of the ticket, the first candidate data indicating the available reservation dates and times of the ticket;

determining, using the acquired first candidate data and the received schedule information, candidate reservation dates and times of the ticket by excluding each date and time, on which a plan of the user is included in the received schedule information, from the available reservation dates and times of the ticket indicated by the acquired first candidate data;

transmitting second candidate data indicating the determined candidate reservation dates and times to the communication device via the network, wherein the communication device displays each display representing each candidate reservation time based on the candidate reservation dates and times indicated by the second candidate data, within each region corresponding to each day represented in calendar data that is generated using the schedule information at the communication device, wherein when an interval between i) one acquired available reservation date and time of the ticket and ii) a date and time on which a plan of the user is stored in the memory is shorter than a predetermined value, the one acquired available reservation date and time is excluded from the determined candidate reservation dates and times of the ticket; and

when selection of one region in the calendar data is detected in the communication device, the one region corresponding to one day in the calendar data and representing one candidate reservation time, and when a reservation request, which indicates one candidate reservation date and time corresponding to the selected one region, is received from the communication device via the network, registering the one candidate reservation date and time indicated by the reservation request as a reservation date and time of the ticket in the information management system.

According to the present aspect, an information management system receives an inquiry signal related to a reservation process of a ticket and schedule information from a communication device. The information management system uses the received schedule information and first candidate data representing available reservation dates and times of the ticket to determine candidate reservation dates and times of the ticket by excluding each date and time, on which a plan of a user is included in the received schedule information, from the available reservation dates and times indicated by the acquired first candidate data. The information management system transmits second candidate data representing the determined candidate reservation dates and times to the communication device.

At the communication device, from the candidate reservation dates and times represented by the second candidate data, a display representing a candidate reservation time is displayed in a region corresponding to each day represented in calendar data that is generated using schedule information. At the communication device, selection of one region which corresponds to one day which is represented in the calendar data and representing one candidate reservation time is detected.

Upon receiving a reservation request indicating one candidate reservation date and time corresponding to the selected one region from the communication device via the network, the information management system registers the one candidate reservation date and time indicated by the reservation request as a reservation date and time of the ticket.

Therefore, even in an aspect configured such that the communication device is responsible for managing schedule information and the information management system is responsible for performing a process of determining a candidate reservation date and time as is the case of the present aspect, a reservation process of the ticket can be streamlined and efficiency thereof can be improved.

In the aspect described above, for example, the reservation date and time of the ticket may be displayed at the communication device within the one region represented in the calendar data when the registration has been completed in the information management system.

For example, when an operation for registering a reservation date and time of the ticket in the calendar data occurs separately after performing a reservation process of the ticket, since a registration operation in the calendar data is to be performed separately from the reservation process of the ticket, the processes become a hassle. When the user forgets to register the reservation date and time of the ticket in the calendar data, the user may forget to visit a location where the ticket is to be used (for example, a concert venue or an airport) even though the ticket has been reserved.

According to the present aspect, a reservation date and time of a ticket which has been registered in the information management system is displayed in a region corresponding to the reservation date and time represented in the calendar data at the communication device. Accordingly, the calendar data includes the reservation date and time of the ticket. Thus, after performing a reservation process of the ticket, the user can be prevented from forgetting to visit a location where the ticket is to be used (for example, a concert venue or an airport) because the user forgot to register the reservation date and time of the ticket in the calendar data.

In the aspect described above, for example, the information management system may collect to manage customer information via the network, the customer information being associated with the user of the communication device,

the method may further comprise:

transmitting a notice to the communication device via the network, when it is determined based on the customer information that a ticket, which is in accordance with preferences of the user of the communication device, is present, wherein the notice indicates that the ticket is present.

According to the present aspect, when the information management system determines, based on the customer information, that a ticket in accordance with the preferences of a user of the communication device is present, the information management system transmits a notice to that effect to the communication device via the network. Accordingly, if a ticket in accordance with the preferences of a user of the communication device is present, even when the user is not aware of that fact, a candidate reservation date and time of the ticket can be presented based on the customer information. Therefore, for example, even when the user of the communication device is not aware of the existence of the ticket, the user can reserve the ticket.

Another aspect of the present disclosure is a method for controlling a communication device having a display and being used in an information management system, the information management system performing a reservation process of a ticket via a network connected to a ticket issuing institution of the ticket,

the information management system managing schedule information of a user of the communication device,

the method causing a computer of the communication device to:

access the information management system via the network to acquire i) schedule information of the user of the communication device and ii) available reservation dates and times of the ticket from the information management system when performing the reservation process of the ticket;

display display data on the display, the display data being generated using the acquired schedule information with calendar data, the calendar data representing each day on a per month or per week basis;

determine candidate reservation dates and times of the ticket by excluding each date and time, on which a plan of the user is acquired from the information management system, from the acquired available reservation dates and times of the ticket;

display each display representing each candidate reservation time based on the determined candidate reservation dates and times, in each region corresponding to each day represented in the calendar data, wherein when an interval between i) one acquired available reservation date and time of the ticket and ii) a date and time on which a plan of the user is acquired from the information management system is shorter than a predetermined value, the one acquired available reservation date and time is excluded from the determined candidate reservation dates and times of the ticket; and

display a reservation screen on the display when selection of one region is detected in the calendar data, the one region corresponding to one day in the calendar data and representing one candidate reservation time, the reservation screen being used for setting one candidate reservation date and time corresponding to the selected one region as a reservation date and time of the ticket.

According to the present aspect, when performing a reservation process of a ticket, the communication device acquires i) schedule information of the user of the communication device and ii) available reservation dates and times of the ticket from the information management system. The communication device displays display data which is generated using the acquired schedule information and which includes calendar data on the display. The communication device uses the available reservation dates and times of the ticket to determine candidate reservation dates and times of the ticket by excluding each date and time, on which a plan of the user is acquired from the information management system, from the acquired available reservation dates and times.

The communication device displays a display representing a candidate reservation time based on the determined candidate reservation dates and times in a region corresponding to each day represented in the calendar data. When selection of one region which corresponds to one day which is represented in the calendar data and representing one candidate reservation time is detected, the communication device displays a reservation screen which is used for setting one candidate reservation date and time corresponding to the selected one region as a reservation date and time of the ticket on the display.

Therefore, even in an aspect configured such that the information management system is responsible for managing schedule information and the communication device is responsible for performing a process of determining a candidate reservation date and time as is the case of the present aspect, a reservation process of the ticket can be streamlined and efficiency thereof can be improved.

In the other aspect described above, for example, the method may further cause the computer of the communication device to:

transmit a reservation request to the information management system via the network based on a result of a reservation made using the reservation screen, the reservation request indicating the one candidate reservation date and time corresponding to the selected one region; and

perform registration of the one candidate reservation date and time corresponding to the selected one region in the information management system, as the reservation date and time of the ticket.

In the other aspect described above, for example, the method may further cause the computer of the communication device to display the reservation date and time of the ticket within the one region in the calendar data, when the registration has been completed in the information management system.

For example, when an operation for registering a reservation date and time of the ticket in the calendar data occurs separately after performing a reservation process of the ticket, since a registration operation in the calendar data is to be performed separately from the reservation process of the ticket, the processes become a hassle. When the user forgets to register the reservation date and time of the ticket in the calendar data, the user may forget to visit a location where the ticket is to be used (for example, a concert venue or an airport) even though the ticket has been reserved.

According to the present aspect, a reservation date and time of the ticket which has been registered in the information management system is displayed in a region corresponding to the reservation date and time represented in the calendar data. Accordingly, the calendar data includes the reservation date and time of the ticket. Thus, after performing a reservation process of the ticket, the user can be prevented from forgetting to visit a location where the ticket is to be used (for example, a concert venue or an airport) because the user forgot to register the reservation date and time of the ticket in the calendar data.

In the other aspect described above, for example, the method may further cause the computer of the communication device to display on the display a message indicating completion of the registration, in association with the display of the calendar data.

In the other aspect described above, for example,

the information management system may collect to manage customer information via the network, the customer information being associated with the user of the communication device, and

a notice may be received from the information management system via the network when it is determined in the information management system based on the customer information that a ticket, which is in accordance with preferences of the user of the communication device, is present, wherein the notice indicates that the ticket is present.

According to the present aspect, when it is determined based on the customer information that a ticket in accordance with the preferences of a user of the communication device is present, a notice to that effect is arranged to be received from the information management system via the network. Accordingly, if there is a ticket in accordance with the preferences of a user of the communication device, even when the user is not aware of that fact, a candidate reservation date and time of the ticket can be presented based on the customer information. Therefore, for example, even when the user of the communication device is not aware of the existence of the ticket, the user can reserve the ticket.

In the other aspect described above, for example, the communication device may be configured to be able to register the plan of the user in the each region corresponding to the each day represented in the calendar data.

Another aspect of the present disclosure is a method for providing information in an information management system which performs a reservation process of a ticket via a network connected to a ticket issuing institution of the ticket, the method comprising:

receiving an inquiry signal from a communication device of an authenticated user via the network, the inquiry signal being related to the reservation process of the ticket;

acquiring schedule information of the user of the communication device using a first database in response to the inquiry signal, the first database storing the schedule information of the user of the communication device;

acquiring first candidate data using a second database in response to the inquiry signal, the second database storing available reservation dates and times of the ticket, the first candidate data indicating the available reservation dates and times of the ticket;

determining, using the acquired schedule information and the acquired first candidate data, candidate reservation dates and times of the ticket by excluding each date and time, on which a plan of the user is included in the acquired schedule information, from the available reservation dates and times of the ticket indicated by the acquired first candidate data;

transmitting second candidate data indicating the determined candidate reservation dates and times to the communication device via the network, wherein the communication device displays each display representing each candidate reservation time based on the candidate reservation dates and times indicated by the second candidate data, within each region corresponding to each day represented in calendar data that is generated using the schedule information at the communication device, wherein when an interval between i) one acquired available reservation date and time of the ticket and ii) a date and time on which a plan of the user is included in the acquired schedule information is shorter than a predetermined value, the one acquired available reservation date and time is excluded from the determined candidate reservation dates and times of the ticket; and

when selection of one region is detected in the communication device, the one region corresponding to one day in the calendar data and representing one candidate reservation time, and when a reservation request, which indicates one candidate reservation date and time corresponding to the selected one region, is received from the communication device via the network, registering the one candidate reservation date and time indicated by the reservation request as a reservation date and time of the ticket in the information management system.

According to the present aspect, the information management system acquires schedule information of the user from a first database in response to an inquiry signal from the communication device. The information management system acquires first candidate data representing available reservation dates and times of the ticket in response to an inquiry signal from the communication device. The communication device uses the schedule information and the first candidate data to determine candidate reservation dates and times of the ticket by excluding each date and time, on which a plan of the user is included in the acquired schedule information, from the available reservation dates and times of the ticket indicated by the acquired first candidate data. The information management system transmits second candidate data representing the determined candidate reservation dates and times to the communication device.

At the communication device, based on the candidate reservation dates and times indicated by the second candidate data, each display representing each candidate reservation time is displayed within each region corresponding to each day represented in calendar data that is generated using the schedule information at the communication device. At the communication device, selection of one region which corresponds to one day which is represented in the calendar data and representing one candidate reservation time is detected.

Upon receiving a reservation request indicating one candidate reservation date and time corresponding to the selected one region from the communication device via the network, the information management system registers the one candidate reservation date and time indicated by the reservation request as a reservation date and time of the ticket.

Therefore, even in an aspect configured such that the information management system is responsible for both managing schedule information and performing a process of determining a candidate reservation date and time as is the case of the present aspect, a reservation process of the ticket can be streamlined and efficiency thereof can be improved.

In the other aspect described above, for example, the reservation date and time of the ticket may be displayed at the communication device within the one region represented in the calendar data when the registration has been completed in the information management system.

For example, when an operation for registering a reservation date and time of the ticket in the calendar data occurs separately after performing a reservation process of the ticket, since a registration operation in the calendar data is to be performed separately from the reservation process of the ticket, the processes become a hassle. When the user forgets to register the reservation date and time of the ticket in the calendar data, the user may forget to visit a location where the ticket is to be used (for example, a concert venue or an airport) even though the ticket has been reserved.

According to the present aspect, a reservation date and time of a ticket which has been registered in the information management system is displayed in a region corresponding to the reservation date and time represented in the calendar data at the communication device. Accordingly, the calendar data includes the reservation date and time of the ticket. Thus, after performing a reservation process of the ticket, the user can be prevented from forgetting to visit a location where the ticket is to be used (for example, a concert venue or an airport) because the user forgot to register the reservation date and time of the ticket in the calendar data.

In the other aspect described above, for example, the information management system may collect to manage customer information via the network, the customer information being associated with the user of the communication device,

the method may further comprise:

transmitting a notice to the communication device via the network, when it is determined based on the customer information that a ticket, which is in accordance with preferences of the user of the communication device, is present, wherein the notice indicates that the ticket is present.

According to the present aspect, when the information management system determines, based on the customer information, that a ticket in accordance with the preferences of a user of the communication device is present, the information management system transmits a notice to that effect to the communication device via the network. Accordingly, if a ticket in accordance with the preferences of a user of the communication device is present, even when the user is not aware of that fact, a candidate reservation date and time of the ticket can be presented based on the customer information. Therefore, for example, even when the user of the communication device is not aware of the existence of the ticket, the user can reserve the ticket.

### Embodiment

Hereinafter, a reservation system according to the present disclosure will be described. The reservation system according to the present disclosure is a system that manages reservations of a ticket such as an airline ticket and a concert ticket.

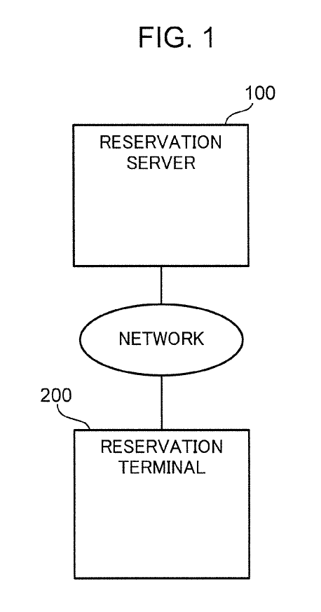

FIG. 1 is a diagram showing a first example of an overall configuration of the reservation system according to the present disclosure. The reservation system according to the first example includes a reservation server 100 and a reservation terminal 200. The reservation server 100 and the reservation terminal 200 are connected so as to be capable of communicating with each other via a network. For example, a public communication network such as the Internet or a mobile phone communication network can be adopted as the network over which various types of data are transmitted and received using the TCP/IP communication protocol.

The reservation server 100 is, for example, a cloud server constituted by one or more computers. In addition, the reservation server 100 receives information related to a reservation that is input by a user through the reservation terminal 200 and manages the information. In this case, for example, the reservation server 100 may be a service provider server that is managed by a service provider who provides a service according to the present disclosure to the user.

Moreover, in the reservation system according to the first example, the reservation server 100 corresponds to an example of the information management system.

The reservation terminal 200 is constituted by, for example, a button type mobile phone, a portable computer such as a smartphone and a tablet terminal, or a stationary computer. In addition, the reservation terminal 200 receives a reservation instruction from the user and transmits information related to the reservation to the reservation server 100 via the network. In this case, as the reservation terminal 200, a computer that performs the role of a home server in a house of the user may be adopted or a computer that does not perform such a role may be adopted. Moreover, while only one reservation terminal 200 is shown in FIG. 1, a plurality of reservation terminals 200 may exist so as to correspond to a plurality of users.

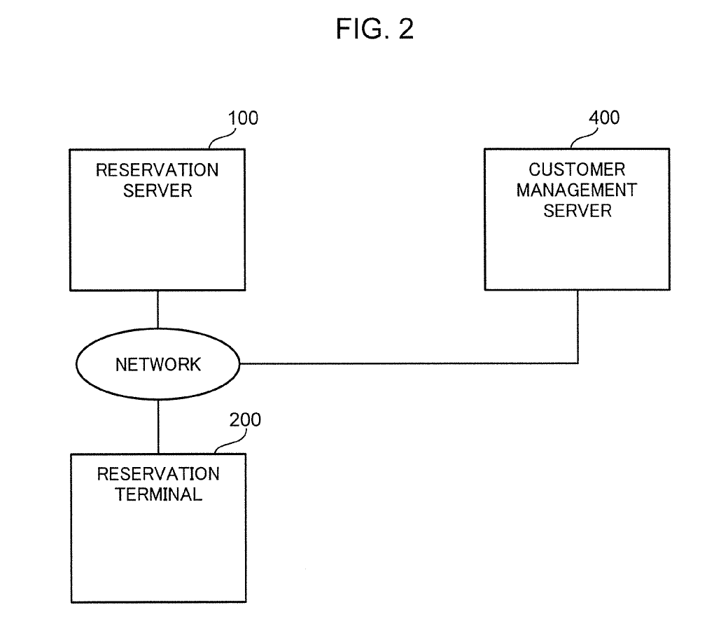

FIG. 2 is a diagram showing a second example of an overall configuration of the reservation system according to the present disclosure. The reservation system according to the second example differs from the reservation system according to the first example in that a customer management server 400 is further provided. The customer management server 400 is, for example, a cloud server constituted by one or more computers. In addition, the customer management server 400 manages each user. In the reservation system according to the second example, the customer management server 400 is given the responsibility of managing customers. In this case, as the customer management server 400, a manufacturer server can be adopted which is used by a manufacturer of an electric appliance to provide various services related to the electric appliance to a user having purchased the electric appliance. Moreover, in the reservation system according to the second example, the reservation server 100 and the customer management server 400 correspond to an example of the information management system.

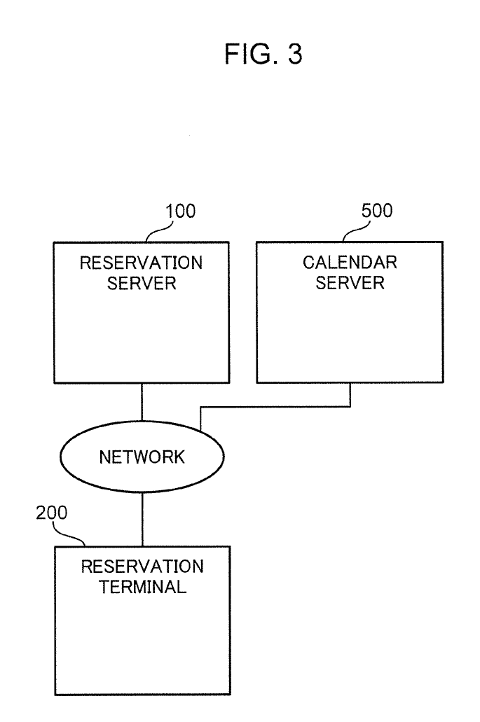

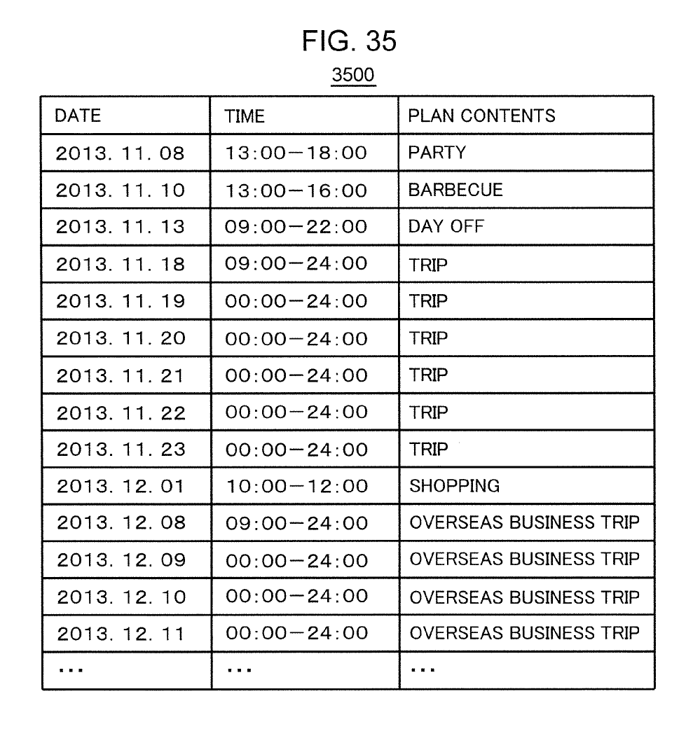

FIG. 3 is a diagram showing a third example of an overall configuration of the reservation system according to the present disclosure. The reservation system according to the third example differs from the reservation system according to the first example in that a calendar server 500 is further provided. The calendar server 500 is, for example, a cloud server constituted by one or more computers. In addition, the calendar server 500 manages schedule information of each of one or more users. In this case, as the schedule information, for example, a calendar plan list 3500 shown in FIG. 35 is adopted.

While schedule information is managed by the reservation server 100 or the reservation terminal 200 in the reservation systems according to the first and second examples, the calendar server 500 is given the responsibility of managing schedule information in the reservation system according to the third example. Moreover, in the reservation system according to the third example, the reservation server 100 and the calendar server 500 correspond to an example of the information management system.

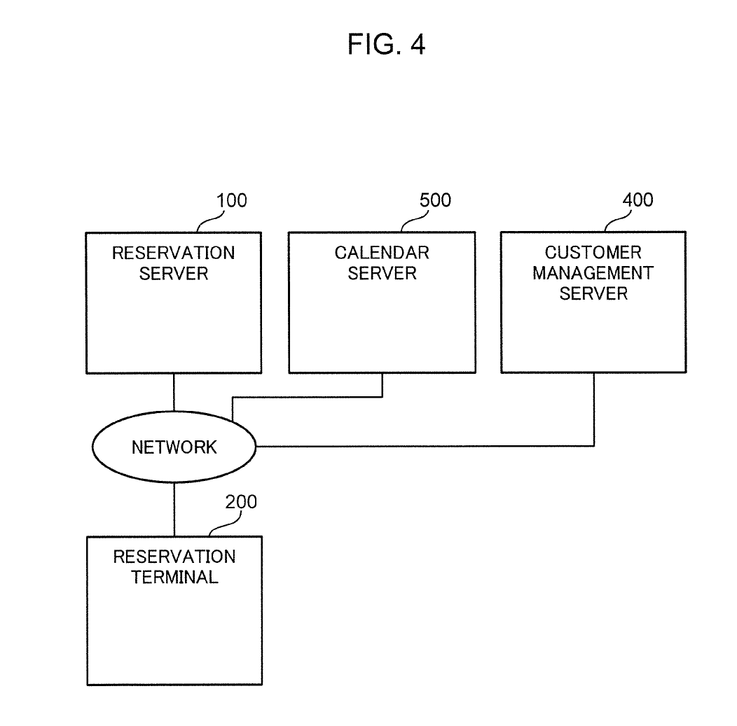

FIG. 4 is a diagram showing a fourth example of an overall configuration of the reservation system according to the present disclosure. The reservation system according to the fourth example incorporates all of the servers that have been described in the first to third examples. In other words, in the reservation system according to the fourth example, the customer management server 400 and the calendar server 500 are present as servers in addition to the reservation server 100.

In the reservation system according to the fourth example, the calendar server 500 is given the responsibility of managing schedule information and the customer management server 400 is given the responsibility of managing customers. Moreover, in the reservation system according to the fourth example, the reservation server 100, the customer management server 400, and the calendar server 500 correspond to an example of the information management system.

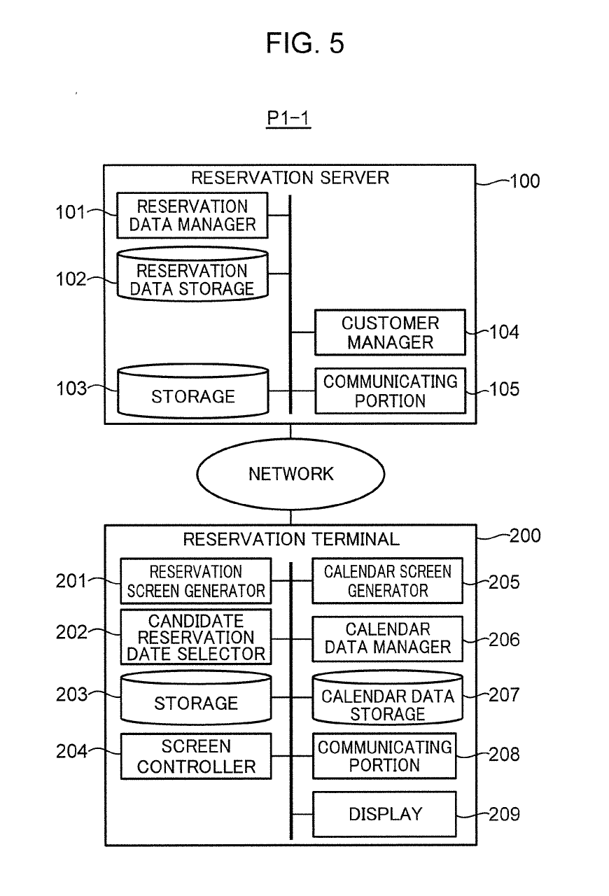

FIG. 5 is a block diagram showing a configuration pattern P1-1 of the reservation system according to the first example. In the reservation system shown in FIG. 5, the reservation server 100 includes a reservation data manager 101, a reservation data storage 102, a storage 103, a customer manager 104, and a communicating portion 105.

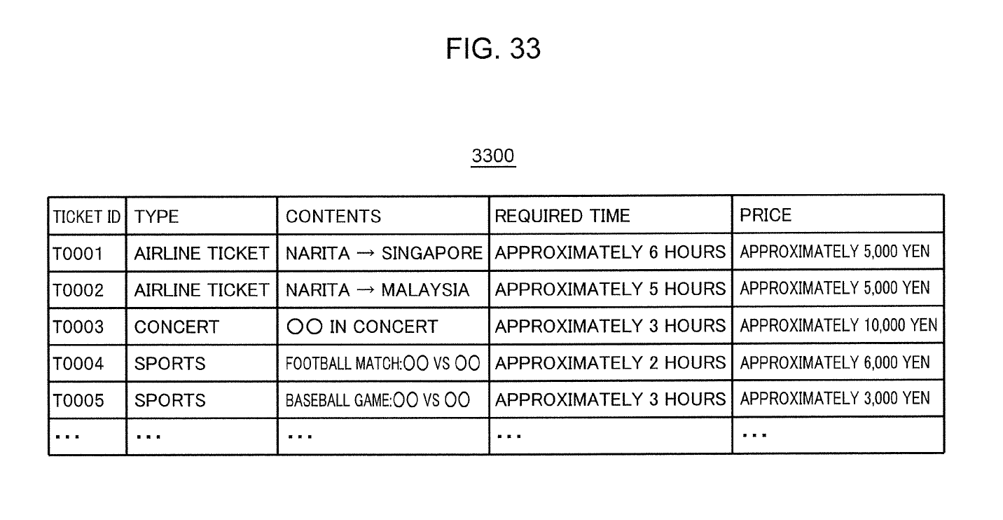

The reservation data manager 101 causes the reservation data storage 102 to store information related to a reservation that is input by a user through the reservation terminal 200 and manages the information related to the reservation. The reservation data manager 101 manages a ticket list 3300 (FIG. 33) of tickets issued by a ticket issuing institution. The ticket issuing institution is, for example, an airline, a promoter of an event such as a concert and a sports event, or the like.

The reservation data storage 102 is constituted by, for example, a non-volatile rewritable storage device and stores information related to a reservation.

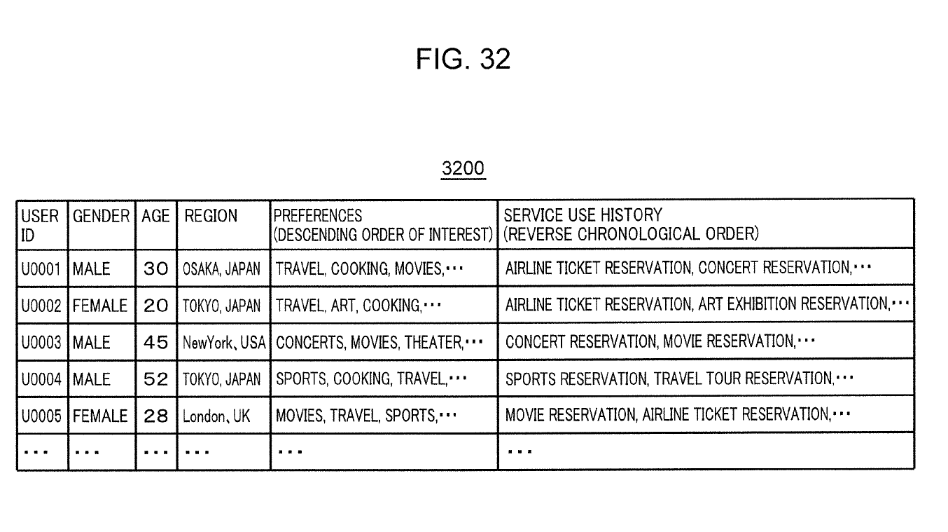

The storage 103 is constituted by, for example, a non-volatile rewritable storage device and stores various types of data that are used by the reservation server 100 when performing various processes. In the example shown in FIG. 5, since the customer manager 104 is present in the reservation server 100, the storage 103 stores customer information that is managed by the customer manager 104. In this case, for example, customer information 3200 shown in FIG. 32 can be adopted as the customer information.

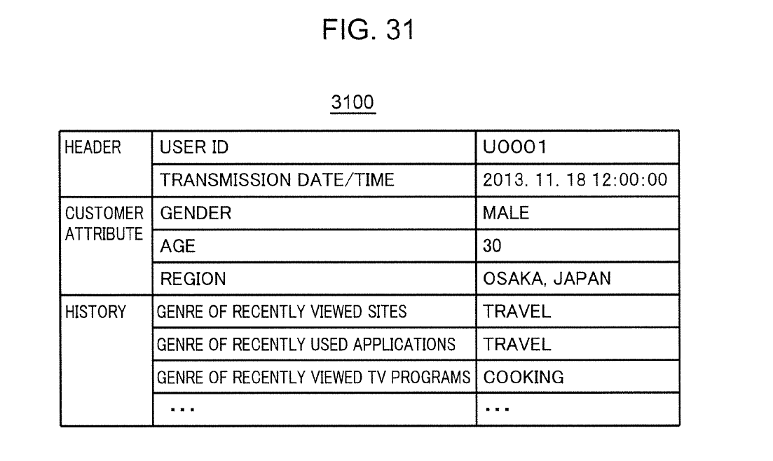

Based on customer history 3100 (FIG. 31) that is transmitted from the reservation terminal 200, the customer manager 104 generates the customer information 3200, stores the generated customer information 3200 in the storage 103, and manages the customer information 3200.

The communicating portion 105 connects the reservation server 100 to the network and enables the reservation server 100 to communicate with the reservation terminal 200 and the like.

In FIG. 5, the reservation terminal 200 includes a reservation screen generator 201, a candidate reservation date selector 202, a storage 203, a screen controller 204, a calendar screen generator 205, a calendar data manager 206, a calendar data storage 207, a communicating portion 208, and a display 209.

The reservation screen generator 201 generates image data of various screens used by a reservation application that causes a computer to function as the reservation terminal 200 and displays the image data on the display 209.

The candidate reservation date selector 202 extracts, from reservation available dates and times that represent dates and times at which a reservation of a ticket can be made, reservation available dates and times from which dates and times on which plans of the user are registered have been excluded as candidate reservation dates and times of the ticket.

Alternatively, the candidate reservation date selector 202 extracts, from reservation available dates that represent dates on which a reservation of the ticket can be made, reservation available dates from which dates on which plans of the user are registered have been excluded as candidate reservation dates of the ticket. Hereinafter, processes of extracting candidate reservation dates and times or candidate reservation dates which is performed by the candidate reservation date selector 202 will be collectively described as an extraction process of a candidate reservation date.

The storage 203 stores various data that is used by the reservation terminal 200 to perform various processes.

The screen controller 204 detects various operations performed by the user on the various screens displayed on the display 209. In the present disclosure, a touch panel included in the display 209 is adopted as an operating device that accepts operations by the user. Therefore, the screen controller 204 senses operations such as tapping, swiping, and flicking input by the user through the touch panel. In addition, when the screen controller 204 senses an operation involving tapping a GUI component displayed on the display 209, the screen controller 204 determines that the GUI component has been selected by the user. Moreover, when a keyboard or a mouse is adopted as the operating device, the screen controller 204 may sense an operation by the user on the keyboard or an operation by the user using the mouse. Furthermore, when the screen controller 204 detects an operation by the user during startup of the reservation application, the screen controller 204 notifies the detected contents to the reservation screen generator 201 and causes the reservation screen generator 201 to detect the operation by the user.

The calendar screen generator 205 generates image data of various screens used by a calendar application and displays the image data on the display 209. Moreover, the calendar application is an application that is installed in existing smartphones and the calendar screen generator 205 is a program module that is responsible for generating a calendar screen. In addition, in the present disclosure, a calendar screen is displayed in various screens of the reservation application. Image data of the screens of the reservation application is generated by the reservation screen generator 201. As such, the calendar screen that is generated by the calendar screen generator 205 will not be particularly described.

The calendar data manager 206 generates schedule information, stores the schedule information in the calendar data storage 207, and manages the schedule information.

The calendar data storage 207 stores schedule information.

The communicating portion 208 connects the reservation terminal 200 to the network and enables the reservation terminal 200 to communicate with the reservation server 100 and the like.

The display 209 is constituted by, for example, a liquid crystal display including a touch panel.

Moreover, in the reservation server 100 shown in FIG. 5, the reservation data manager 101 is realized by, for example, having a processor of the reservation server 100 execute a reservation server program that causes a computer to function as the reservation server 100. Furthermore, the reservation data storage 102 and the storage 103 are constituted by, for example, a rewritable non-volatile storage device. The communicating portion 105 is constituted by a communication device such as a modem.

In addition, in FIG. 5, the reservation screen generator 201 and the candidate reservation date selector 202 are realized by having a processor of the reservation terminal 200 execute a reservation application. Furthermore, the calendar screen generator 205 and the calendar data manager 206 are realized by having the processor of the reservation terminal 200 execute a calendar application.

In addition, the storage 203 and the calendar data storage 207 are constituted by, for example, a rewritable non-volatile storage device. Furthermore, the screen controller 204 is realized by, for example, having the processor of the reservation terminal 200 execute an operation system. The communicating portion 208 is constituted by a communication device such as a modem.

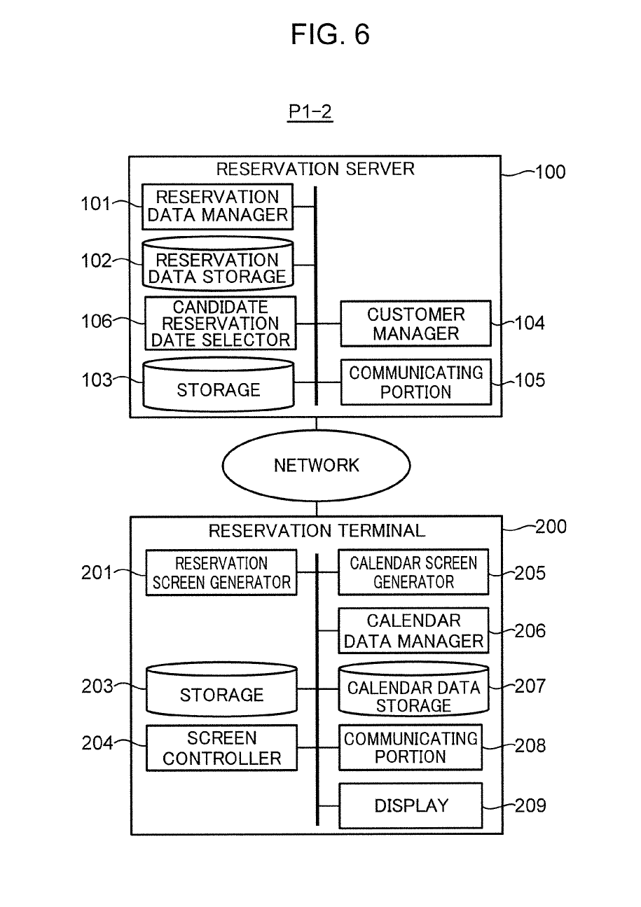

FIG. 6 is a block diagram showing a configuration pattern P1-2 of the reservation system according to the first example. In the configuration pattern P1-2, an extraction process of a candidate reservation date is performed by the reservation server 100 and management of schedule information is performed by the reservation terminal 200. To this end, the reservation server 100 includes a candidate reservation date selector 106.

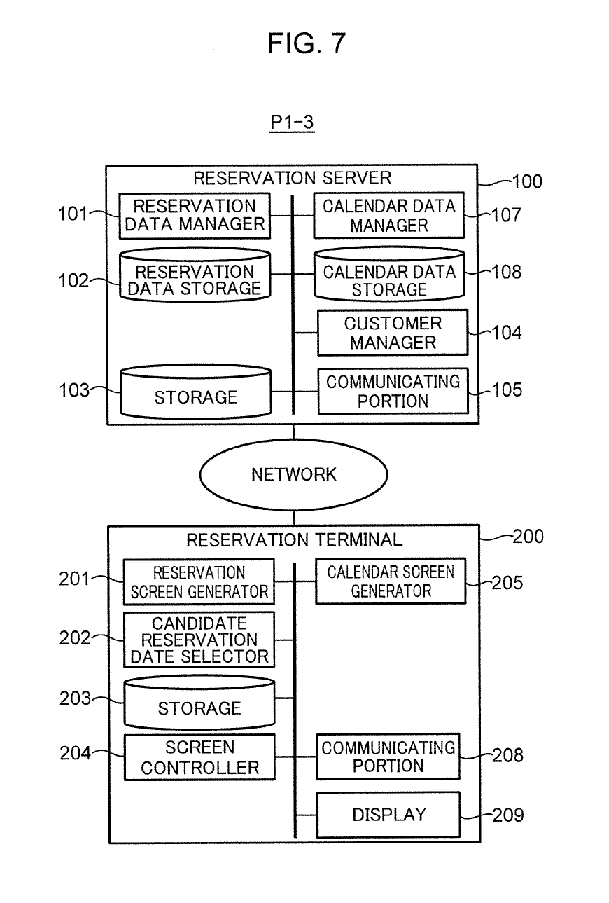

FIG. 7 is a block diagram showing a configuration pattern P1-3 of the reservation system according to the first example. In the configuration pattern P1-3, an extraction process of a candidate reservation date is performed by the reservation terminal 200 and management of schedule information is performed by the reservation server 100. Therefore, the reservation terminal 200 includes the candidate reservation date selector 202 and the reservation server 100 includes a calendar data manager 107 and a calendar data storage 108. In this pattern, the calendar screen generator 205 is constituted by a browser which, for example, acquires schedule information that is described in a script language (for example, HTML and JavaScript (registered trademark)) from the reservation server 100 and displays the schedule information on the display 209.

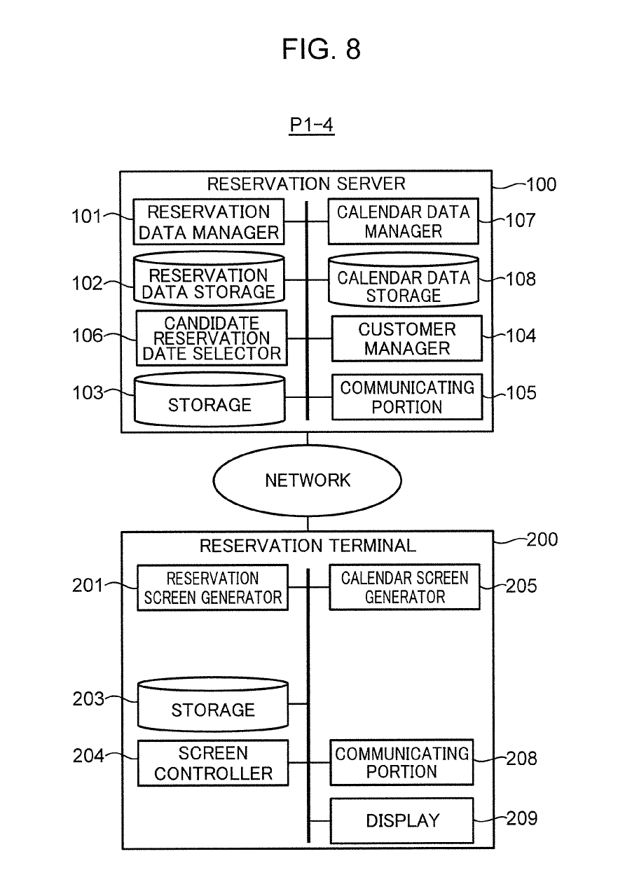

FIG. 8 is a block diagram showing a configuration pattern P1-4 of the reservation system according to the first example. In the configuration pattern P1-4, an extraction process of a candidate reservation date and management of schedule information are performed by the reservation server 100. Therefore, the reservation server 100 includes the candidate reservation date selector 106, the calendar data manager 107, and the calendar data storage 108.

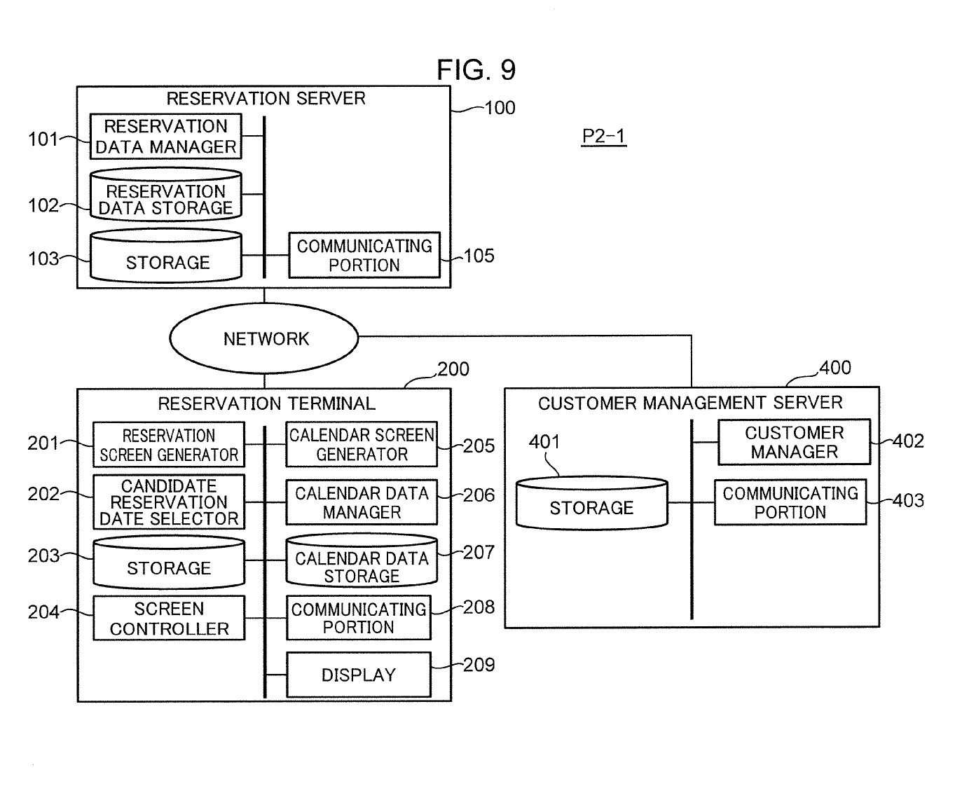

FIG. 9 is a block diagram showing a configuration pattern P2-1 of the reservation system according to the second example. In the configuration pattern P2-1, the customer management server 400 has been added to the configuration patterns P1-1 to P1-4. The customer management server 400 includes a storage 401, a customer manager 402, and a communicating portion 403.

The storage 401 stores, for example, customer information 3200 (FIG. 32) that is information related to a user.

The customer manager 402 stores customer information 3200 in the storage 401 and manages the customer information 3200.

The communicating portion 403 connects the customer management server 400 to the network.

In FIG. 9, the customer manager 402 is realized by, for example, having a processor of the customer management server 400 execute a customer management server program that causes a computer to function as the customer management server 400. Moreover, in FIG. 9, an extraction process of a candidate reservation date and management of schedule information are performed by the reservation terminal 200. However, this simply represents an example and even when the reservation system according to the second example is adopted, the extraction process of a candidate reservation date may be performed by any of the reservation server 100 and the reservation terminal 200 and the management of schedule information may be performed by any of the reservation server 100 and the reservation terminal 200.

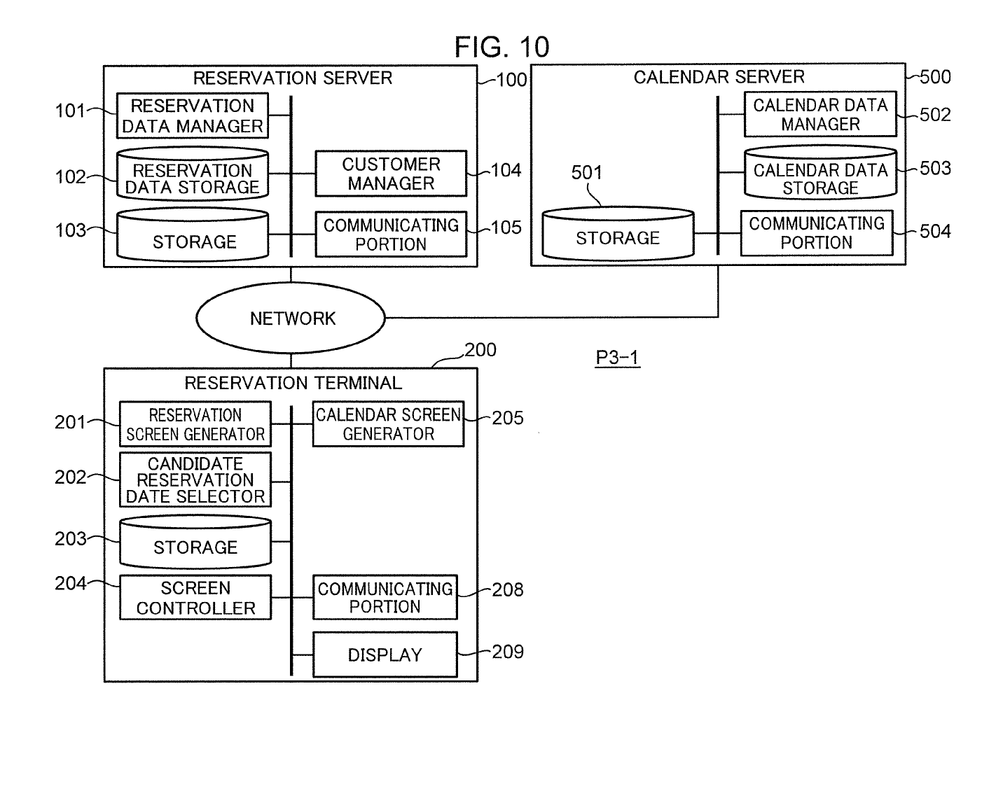

FIG. 10 is a block diagram showing a configuration pattern P3-1 of the reservation system according to the third example. In the configuration pattern P3-1, the calendar server 500 has been added to the configuration patterns P1-1 to P1-4.

The calendar server 500 includes a storage 501, a calendar data manager 502, a calendar data storage 503, and a communicating portion 504.

The storage 501 stores various types of data that are used by the calendar server 500 to perform various processes.

The calendar data manager 502 stores schedule information of each of one or more users in the calendar data storage 503 and manages the schedule information.

The calendar data storage 503 stores schedule information.

The communicating portion 504 connects the calendar server 500 to the network.

The calendar data manager 502 is realized by, for example, having a processor of the calendar server 500 execute a calendar server program that causes a computer to function as the calendar server 500. The storage 501 and the calendar data storage 503 are constituted by, for example, a rewritable non-volatile storage device. The communicating portion 504 is constituted by a communication device such as a modem. In the configuration pattern P3-1, an extraction process of a candidate reservation date is performed by the reservation terminal 200 and management of schedule information is performed by the calendar server 500. Therefore, calendar data managers and calendar data storages have been omitted from the reservation server 100 and the reservation terminal 200. Accordingly, the calendar screen generator 205 is constituted by a browser which generates image data of calendar data using the schedule information and which displays the image data on the display 209.

FIG. 11 is a block diagram showing a configuration pattern P3-2 of the reservation system according to the third example. The configuration pattern P3-2 differs from the configuration pattern P3-1 in that an extraction process of a candidate reservation date is performed by the reservation server 100. Therefore, the reservation server 100 includes the candidate reservation date selector 106.

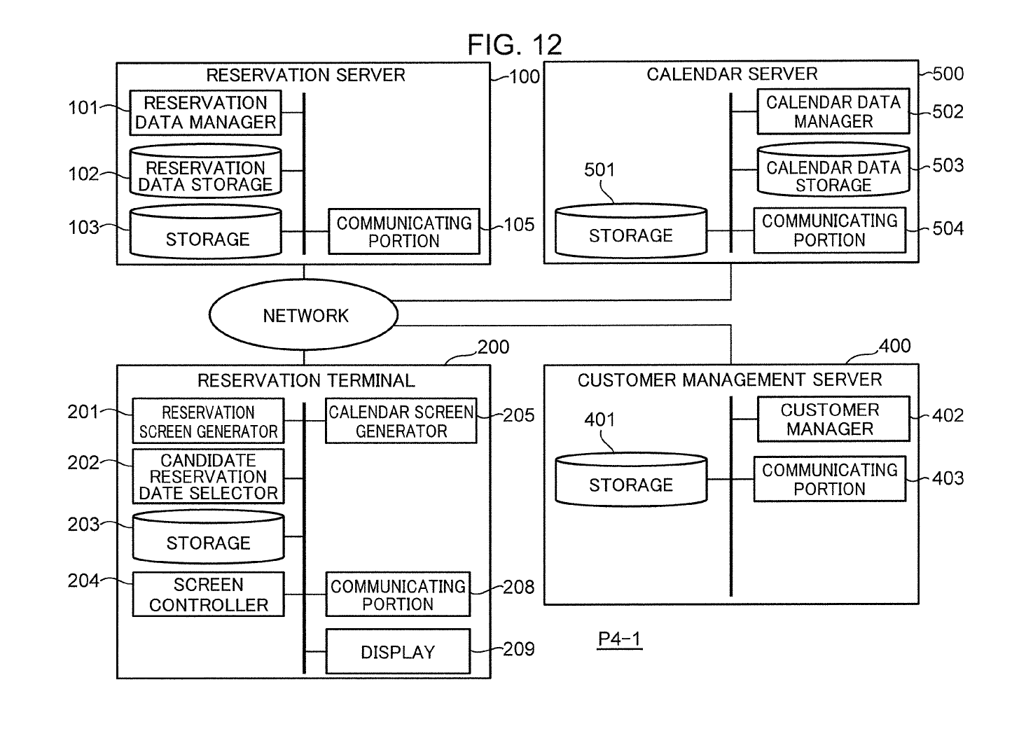

FIG. 12 is a block diagram showing a configuration pattern P4-1 of the reservation system according to the fourth example. In the configuration pattern P4-1, the calendar server 500 and the customer management server 400 have been added to the configuration patterns P1-1 to P1-4. In other words, in the configuration pattern P4-1, management of schedule information is performed by the calendar server 500 and management of customer information is performed by the customer management server 400. In addition, in the configuration pattern P4-1, an extraction process of a candidate reservation date is performed by the reservation terminal 200. To this end, the reservation terminal 200 includes the candidate reservation date selector 202.

Alternatively, in the configuration pattern P4-1, an extraction process of a candidate reservation date may be performed by the reservation server 100.

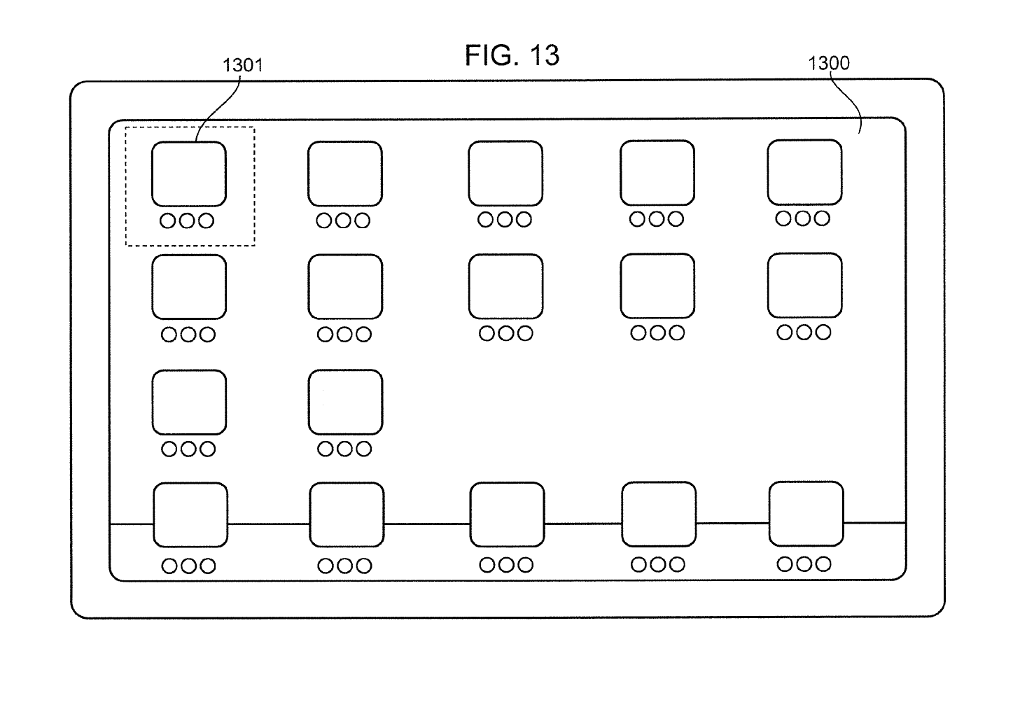

FIG. 13 is a diagram showing an example of a basic screen 1300. The basic screen 1300 is a basic screen that is displayed by an ordinary smartphone or a tablet terminal. The basic screen 1300 displays one or more icons for executing one or more applications in a matrix pattern. In addition, the one or more icons include a reservation application icon 1301 for executing a reservation application. In the example shown in FIG. 13, the reservation application icon 1301 is arranged at a top left position.

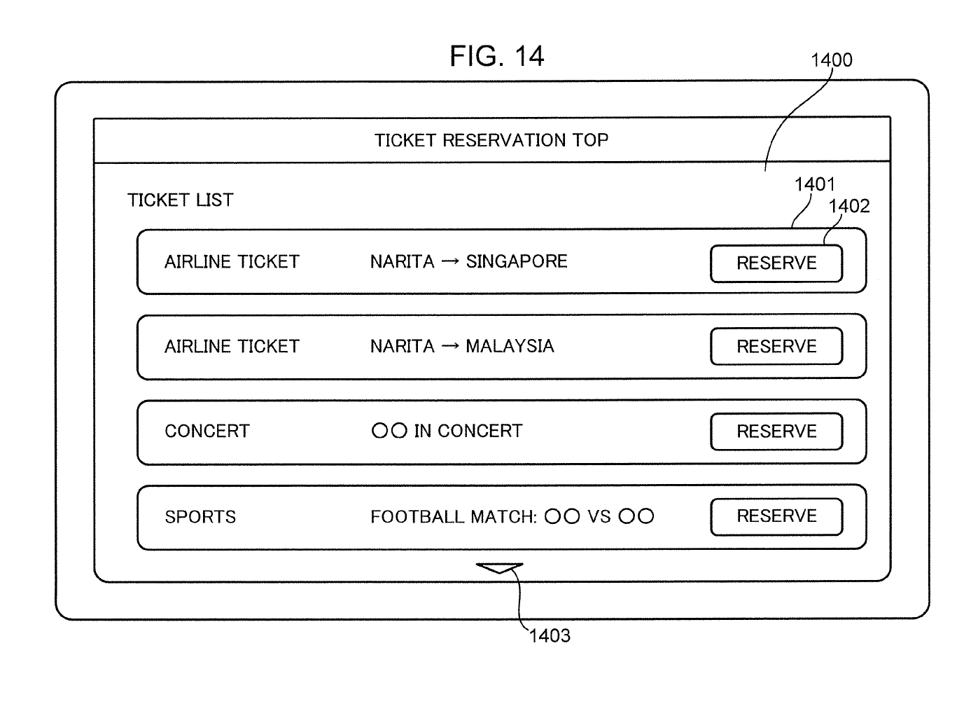

FIGS. 14 to 16 are diagrams showing examples of a top screen 1400. The top screen 1400 is a top screen of the reservation application and is a screen which is displayed on the display 209 when the reservation application icon 1301 is tapped on the basic screen 1300.

A heading that reads “Ticket reservation top” is displayed in an upper part of the top screen 1400 to explicitly indicate that the screen is a top screen of the reservation application. Characters reading “ticket list” are displayed below the heading to explicitly indicate that a list of tickets for which reservations can be made is displayed below.

Ticket display fields 1401 representing tickets for which reservations can be made are vertically aligned below the characters. The ticket display field 1401 displays a type of a ticket, contents of the ticket, and a reservation button 1402. In the example shown in FIG. 14, “airline ticket”, “concert”, and “sports” are displayed as ticket types. In the uppermost ticket display field 1401, “airline ticket” is displayed as the ticket type and “Narita→Singapore” is displayed as contents of the ticket.

The next page button 1403 is displayed in a lower part of the top screen 1400. When the next page button 1403 is tapped, the screen controller 204 detects the tapping. As a result, the reservation screen generator 201 displays a top screen 1400 for a second page which displays a list of ticket display fields 1401 that could not be displayed on the first page.

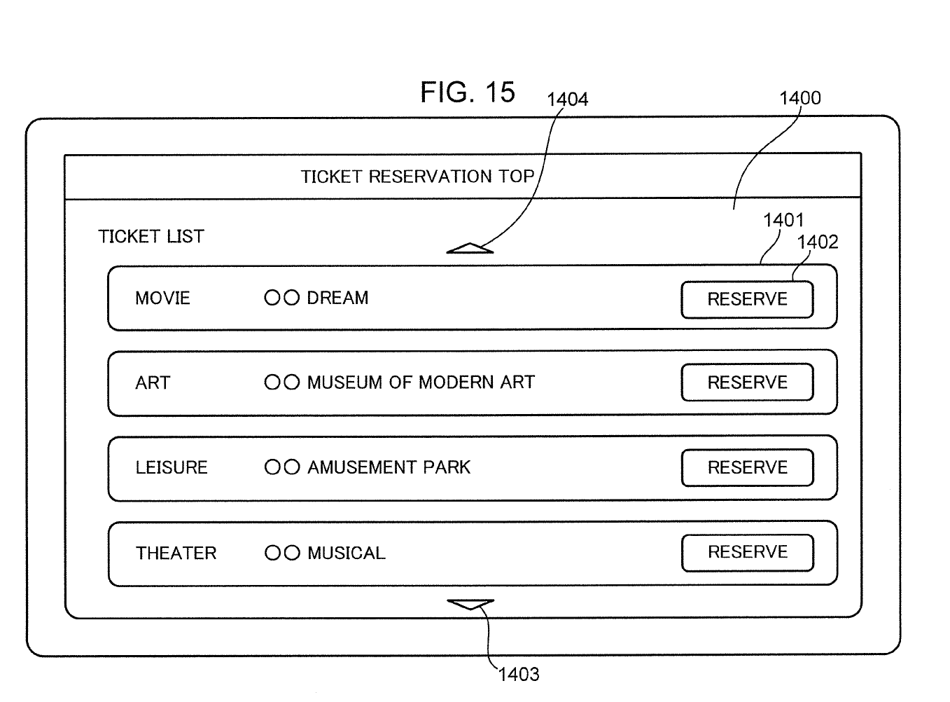

FIG. 15 shows an example of the top screen 1400 of the second page. In the example shown in FIG. 15, “movie”, “art”, “leisure”, and “theater” are displayed as ticket types. When the next page button 1403 displayed in a lower part of the top screen 1400 of the second page shown in FIG. 15 is tapped, the reservation screen generator 201 displays the top screen 1400 for a third page.

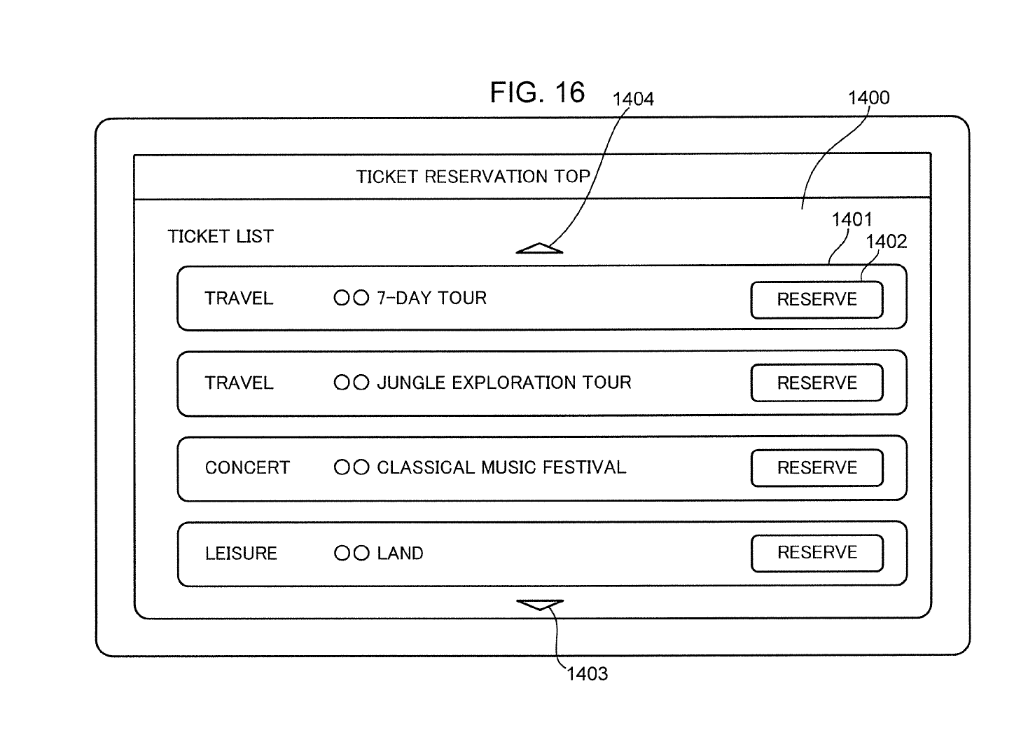

FIG. 16 shows an example of the top screen 1400 of the third page. In the example shown in FIG. 16, “travel”, “concert”, and “leisure” are displayed as ticket types.

A previous page button 1404 is displayed in an upper part of the top screens 1400 shown in FIGS. 15 and 16. When the previous page button 1404 is tapped in a state where the top screen 1400 shown in FIG. 16 is displayed, the reservation screen generator 201 displays the top screen 1400 of the second page that is shown in FIG. 15. In a similar manner, when the previous page button 1404 is tapped in a state where the top screen 1400 shown in FIG. 15 is displayed, the reservation screen generator 201 displays the top screen 1400 of the first page that is shown in FIG. 14.

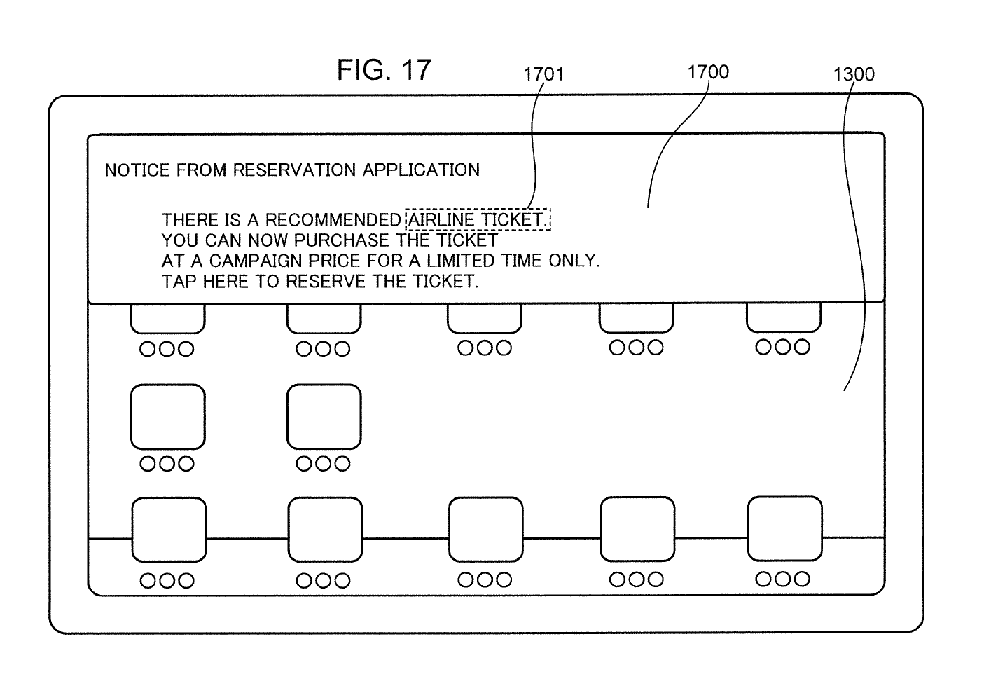

FIG. 17 is a diagram showing an example of a reservation guide notification screen 1700. The reservation guide notification screen 1700 is a notification screen of a push notification that is transmitted to the reservation terminal 200 of a user when the reservation system detects registration of a ticket that is in accordance with the preferences of the user. In this case, the reservation guide notification screen 1700 is displayed overlaid on the basic screen 1300 in a region that occupies about a top one-third of the basic screen 1300.

A text reading “Notice from reservation application. There is a recommended “airline ticket”. You can now purchase the ticket at a campaign price for a limited time only. Tap here to reserve the ticket.” is presented on the reservation guide notification screen 1700 shown in FIG. 17 to explicitly indicate that a new ticket has been registered. A ticket type 1701 is included in the text presented on the reservation guide notification screen 1700. In the example shown in FIG. 17, since guidance for a reservation of an airline ticket is provided, “airline ticket” is displayed as the ticket type. When the screen controller 204 detects that the user has tapped the reservation guide notification screen 1700, the reservation screen generator 201 causes a ticket confirmation screen 1800 to be displayed on the display 209.

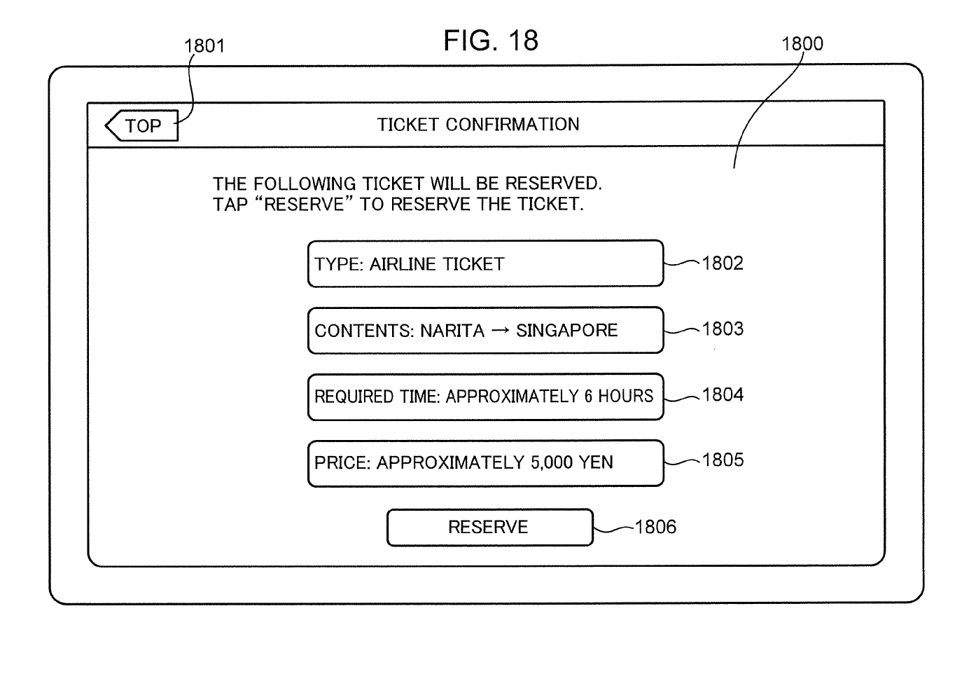

FIG. 18 is a diagram showing an example of the ticket confirmation screen 1800. The ticket confirmation screen 1800 is a screen that enables a user to confirm contents of a reservation of a ticket.

A heading that reads “Confirm ticket” is presented in an upper part of the ticket confirmation screen 1800 to explicitly indicate that the screen is a screen that enables the user to confirm contents of a reservation of a ticket.

In addition, a text reading “The following ticket will be reserved. Tap “reserve” to reserve the ticket.” is displayed below the heading display field of the ticket confirmation screen 1800 to prompt the user to reserve the ticket.

A ticket type display field 1802, a ticket content display field 1803, a required time display field 1804, and a price display field 1805 are, for example, displayed vertically aligned below the text.

The ticket type display field 1802 displays a ticket type. In this case, since the ticket is an airline ticket, “Type: airline ticket” is displayed in the ticket type display field 1802.

The ticket content display field 1803 displays contents of the ticket. In this case, “Contents: Narita→Singapore” is displayed in the ticket content display field 1803 as a departure point and an arrival point of the airline ticket.

The required time display field 1804 displays a required time for traveling from the departure point to the arrival point. In this case, since an average required time from Narita to Singapore is approximately 6 hours, “Required time: Approximately 6 hours” is displayed in the required time display field 1804.

The price display field 1805 displays a price to be paid by the user to purchase the ticket. In this case, since the price of the airline ticket is approximately 5,000 yen, “Price: approximately 5,000 yen” is displayed in the price display field 1805. Moreover, a required time and a price are registered in advance in the ticket list 3300 (FIG. 33) to be described later.

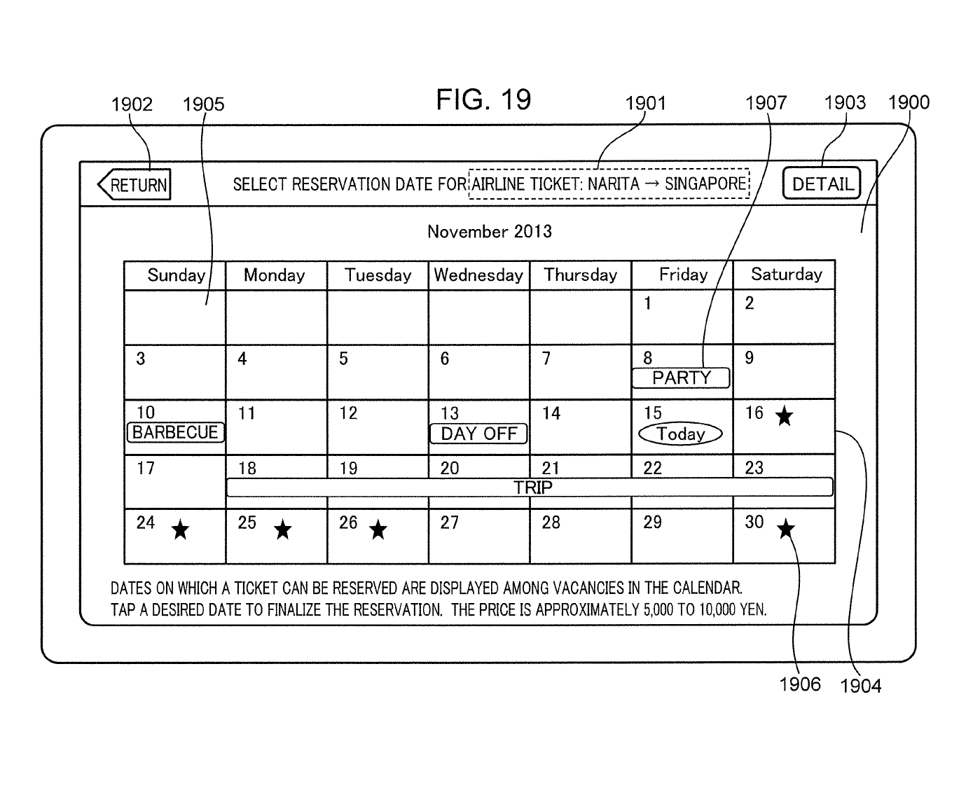

A reservation button 1806 with the description “reserve” is displayed below the price display field 1805. The reservation button 1806 is a button for switching the display screen of the display 209 to a reservation date selection screen 1900 (FIG. 19).

Moreover, a top button 1801 with the description “top” that is displayed in a top left part of the ticket confirmation screen 1800 is a button for switching the display screen of the display 209 to the top screen 1400 (FIG. 14). In addition, the ticket confirmation screen 1800 may be configured so as to enable seat selection for the ticket.

FIG. 19 is a diagram showing a first example of the reservation date selection screen 1900. The reservation date selection screen 1900 is a screen that enables a user to select a reservation date of a ticket. A heading that reads “Select reservation date for airline ticket: Narita→Singapore” is provided in an upper part of the reservation date selection screen 1900 to explicitly indicate that the screen is a screen for selecting a reservation date. The example shown in FIG. 19 presents the reservation date selection screen 1900 corresponding to an airline ticket. Therefore, “airline ticket: Narita→Singapore” is described as a ticket name 1901 in the heading. In other words, a type of a ticket that is a reservation object and contents of the ticket are described in a field corresponding to the ticket name 1901 in the heading.

The reservation date selection screen 1900 is provided with a calendar data display field 1904 in which a plan of the user that is generated using schedule information is shown in a calendar format. In this case, the calendar data display field 1904 is a field that displays a calendar in which days are presented on a per month or per week basis. In the example shown in FIG. 19, a calendar in which days are presented on a per month basis is adopted.

The calendar data display field 1904 is constituted by 35 rectangular boxes 1905 divided in a matrix pattern by the seven days of the week from Sunday to Saturday which are arranged horizontally and five weeks arranged vertically. In this case, one box 1905 is a region representing a day. A numeral indicating a day is displayed in each box 1905. Moreover, in the example shown in FIG. 19, a numeral indicating a day is not displayed in boxes 1905 corresponding to days which do not belong to a display target month but belong to the previous month or the following month. However, this is simply an example and days may be displayed in boxes 1905 corresponding to days which belong to the previous month or the following month. A year and a month which are display objects are displayed above the calendar data display field 1904. In the example shown in FIG. 19, since calendar data for November 2013 is displayed in the calendar data display field 1904, “November 2013” is displayed above the calendar data display field 1904.

The calendar data display field 1904 displays a schedule icon 1907 representing a schedule of a user input by the user using the calendar application. The example shown in FIG. 19 displays schedule icons 1907 such as “party” on the 8th, “barbeque” on the 10th, “day off” on the 13th, and “trip” from the 18th to the 23rd. In addition, in the example shown in FIG. 19, “today” is displayed in the box 1905 corresponding to the present day to explicitly indicate the present day to the user.

Furthermore, the calendar data display field 1904 displays a candidate symbol 1906 for explicitly indicating that a given day is a candidate reservation date of the ticket in a box 1905 corresponding to the candidate reservation date. While a star-shaped graphic is adopted as the candidate symbol 1906 in the example shown in FIG. 19, any graphic such as a circle and a square may be adopted as long as a candidate reservation date can be recognized.

As described above, the calendar data display field 1904 which displays both a schedule of the user and a candidate reservation date of a ticket is provided on the reservation date selection screen 1900. Therefore, the user can select a reservation date of a ticket using only the reservation date selection screen 1900.

For example, let us consider a case where the calendar data display field 1904 is not provided on the reservation date selection screen 1900. In this case, the user must separately start up a calendar application and select a reservation date of a ticket by collating the display of calendar data provided by the calendar application with the display on the reservation date selection screen 1900. In particular, when the reservation terminal 200 is a tablet terminal or a smartphone, since a small size of the display 209 makes it difficult to display the calendar data and the reservation date selection screen 1900 at the same time, the user must collate both screens while inputting operations for switching between both displays.

In consideration thereof, the present disclosure aims to improve efficiency of a reservation operation for setting a reservation date of a ticket by providing the calendar data display field 1904 on the reservation date selection screen 1900.

Furthermore, the candidate reservation dates that are displayed in the calendar data display field 1904 are reservation available dates on which a reservation for the ticket can be made from which dates on which the user has plans have been excluded. Therefore, only candidate reservation dates that are likely to be selected by the user are displayed in the calendar data display field 1904. As a result, the number of displayed candidate reservation dates can be narrowed down and the user can smoothly perform a reservation operation for setting a reservation date of a ticket.

A text reading “Dates on which a ticket can be reserved are displayed among vacancies in the calendar” is displayed below the calendar data display field 1904 to explicitly indicate that the dates with the candidate symbols 1906 are candidate reservation dates. This text is followed by a text reading “Tap a desired reservation date to finalize the reservation.” which prompts the user to select a reservation date from the candidate reservation dates. This text is, in turn, followed by a display of a text reading “The price is approximately 5,000 to 10,000 yen” which explicitly indicates the price of the ticket. Accordingly, information for making a determination on whether or not to make a reservation for the ticket is provided to the user.

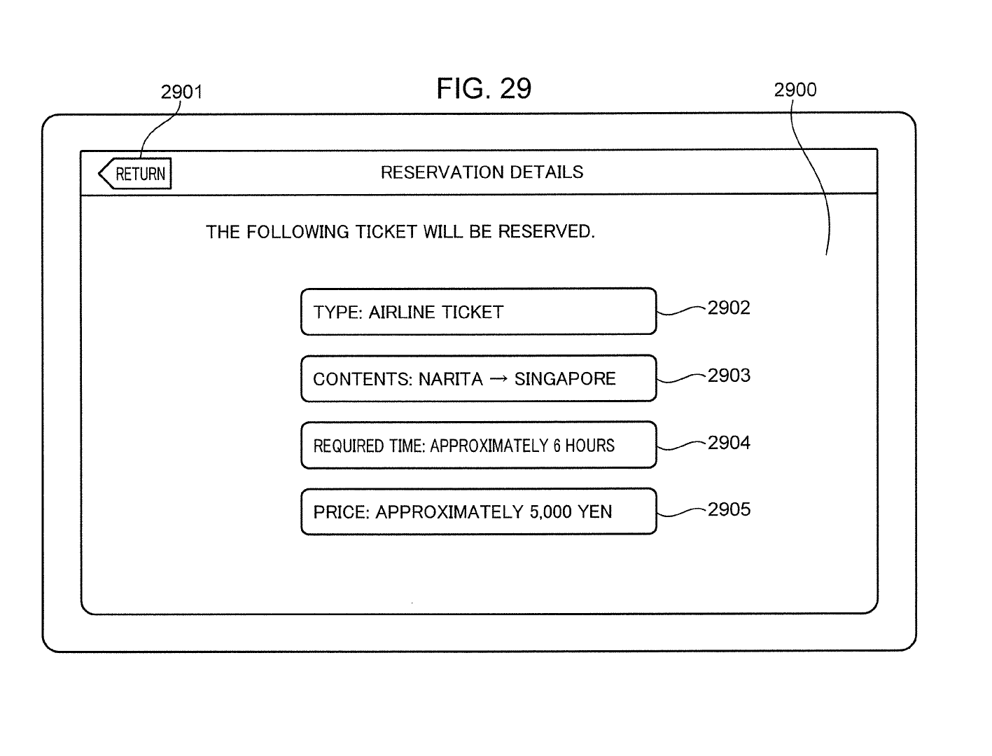

A return button 1902 with a description of “return” is displayed to the left of the display field of the ticket name 1901 on the reservation date selection screen 1900. The return button 1902 is a button for returning the display screen on the display 209 from the reservation date selection screen 1900 to the ticket confirmation screen 1800. In addition, a detail button 1903 with a description of “detail” is displayed to the right of the display field of the ticket name 1901 on the reservation date selection screen 1900. The detail button 1903 is a button for switching the display screen of the display 209 to a ticket detail confirmation screen 2900 (FIG. 29).

Moreover, while calendar data is displayed on a per month basis in the calendar data display field 1904 in FIG. 19, the calendar data may instead be displayed on a per week basis. In this case, the calendar data display field 1904 is constituted by, for example, 7 boxes 1905 divided in a matrix pattern by the seven days of the week from Sunday to Saturday which are arranged horizontally and one week arranged vertically.

In this case, days are displayed in the calendar data display field 1904 on a per week basis regardless of month even if the present week that is a display target is a week extends to the following month or the previous month. For example, in FIG. 19, the week in the first row is a week that extends from October to November, and when only this week is displayed in the calendar data display field 1904, a numeral indicating the day, the schedule icon 1907, and the candidate symbol 1906 are displayed for days which belong to October and which are blank fields.

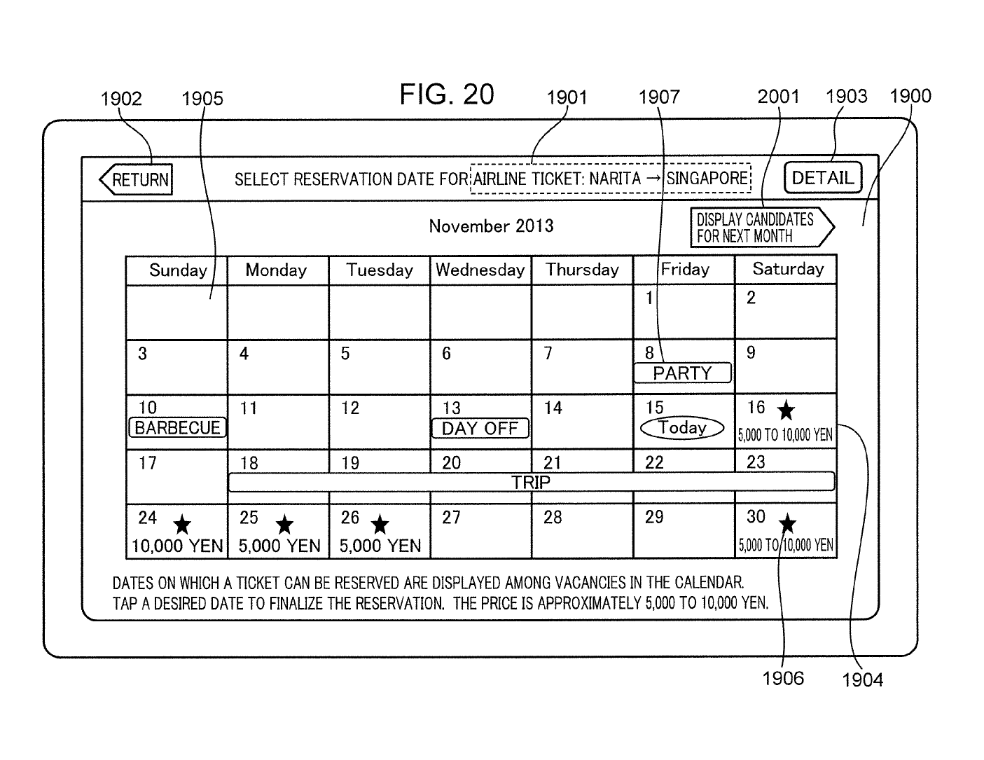

FIG. 20 is a diagram showing a second example of the reservation date selection screen 1900. On the reservation date selection screen 1900 according to the second example, a next month candidate display button 2001 has been added and a price is displayed in the box 1905 corresponding to a candidate reservation date.

The next month candidate display button 2001 is a button for causing calendar data of a next month to be displayed in the calendar data display field 1904. The next month candidate display button 2001 is displayed when candidate reservation dates are extracted so as to extend from the present month to the following month. When the screen controller 204 detects that the next month candidate display button 2001 has been tapped, the reservation screen generator 201 displays the reservation date selection screen 1900 that displays calendar data for the following month on the display 209.

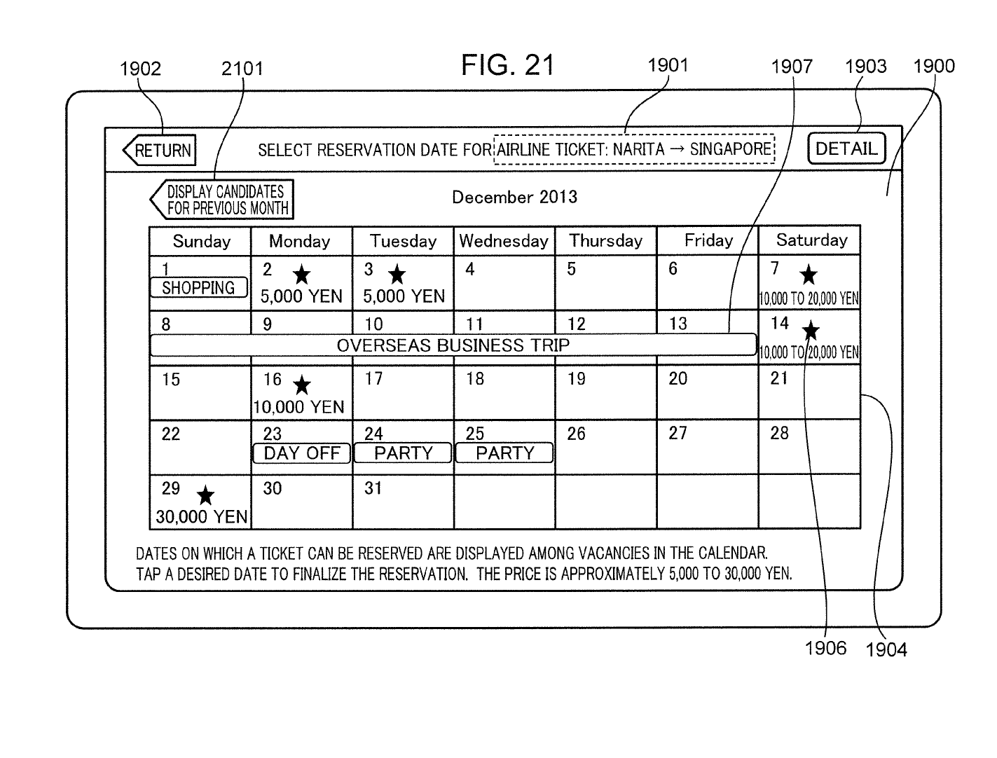

FIG. 21 is a diagram showing an example of the reservation date selection screen 1900 for the month following the reservation date selection screen 1900 shown in FIG. 20.

In the example shown in FIG. 21, since the present month is November 2013, calendar data for December 2013 that is the following month is displayed in the calendar data display field 1904. On the reservation date selection screen 1900 of the following month, a schedule of the user and a candidate reservation date are both displayed in the calendar data display field 1904 in a similar manner to the reservation date selection screen of the present month.

Therefore, even if the present day is at the end of the present month, by causing the reservation date selection screen 1900 displaying calendar data of the following month that is shown in FIG. 21 to be displayed, the user can select a reservation date without omitting candidate reservation dates of the following month.

In addition, a previous month candidate display button 2101 is displayed below the return button 1902 on the reservation date selection screen 1900 of the following month. The previous month candidate display button 2101 is a button for switching screen display of the display 209 to the reservation date selection screen 1900 of the present month that is shown in FIG. 20.

Therefore, when the screen controller 204 detects that the previous month candidate display button 2101 has been tapped, the reservation screen generator 201 switches screen display from the reservation date selection screen 1900 of the following month to the reservation date selection screen 1900 of the present month.

In addition, as shown in FIGS. 20 and 21, on the reservation date selection screen 1900 according to the second example, a price of the ticket is displayed in the box 1905 that corresponds to a candidate reservation date. At this point, the price of the ticket may differ between weekdays and weekends. In this case, explicitly indicating a price of the ticket for each candidate reservation date makes it easier for the user to select a candidate reservation date. Therefore, in the example shown in FIG. 20, a price of the ticket is displayed in the box 1905 that corresponds to a candidate reservation date. Accordingly, the user can select a candidate reservation date on which the price is lower.

In the example shown in FIG. 20, the price on Sunday the 24th is 10,000 yen, the price on Saturdays the 16th and 30th is 5,000 to 10,000 yen, and the prices on Monday the 25th and Tuesday the 26th are 5,000 yen. This indicates that prices are set higher on Sundays and Saturdays than on weekdays. Therefore, information suggesting that selecting weekdays may result in lower prices is explicitly indicated to the user.

Moreover, while an example in which prices differ depending on the day of the week is shown in FIG. 20, there may be cases where prices differ depending on whether or not it is a busy period. In this case, for a candidate reservation date corresponding to the busy period, a price that is higher than other candidate reservation dates is displayed. In Japan, December is customarily considered a busy period. Therefore, prices displayed on the reservation date selection screen 1900 of December that is shown in FIG. 21 are set relatively higher than the prices displayed on the reservation date selection screen 1900 of November that is shown in FIG. 20.

In addition, while the examples in FIGS. 20 and 21 represent cases where prices are constant on the same day, there may be cases where prices fluctuate depending on time slots even on the same day. For example, there are cases where prices are set higher for time slots corresponding to flights departing and arriving in daytime and flights with a fewer number of available seats. In such a case, prices depending on time slots may be displayed in the box 1905 of a candidate reservation date.

Moreover, when a mode in which calendar data is displayed on a per week basis is adopted in FIGS. 20 and 21, for example, a next week candidate display button is displayed in place of the next month candidate display button 2001 on the reservation date selection screen 1900. In this case, when the next week candidate display button is tapped, the reservation screen generator 201 may display the calendar data of the next week. Since a schedule of the user and candidate reservation dates are also displayed on the calendar data of the next week, the user can select a reservation date without omitting the candidate reservation dates of the next week.

Moreover, on the reservation date selection screens according to the first and second examples, the reservation screen generator 201 may display the schedule icon 1907 and the candidate symbol 1906 in different colors. Accordingly, the user can recognize the user's own schedule and candidate reservation dates in a more distinguishable manner.

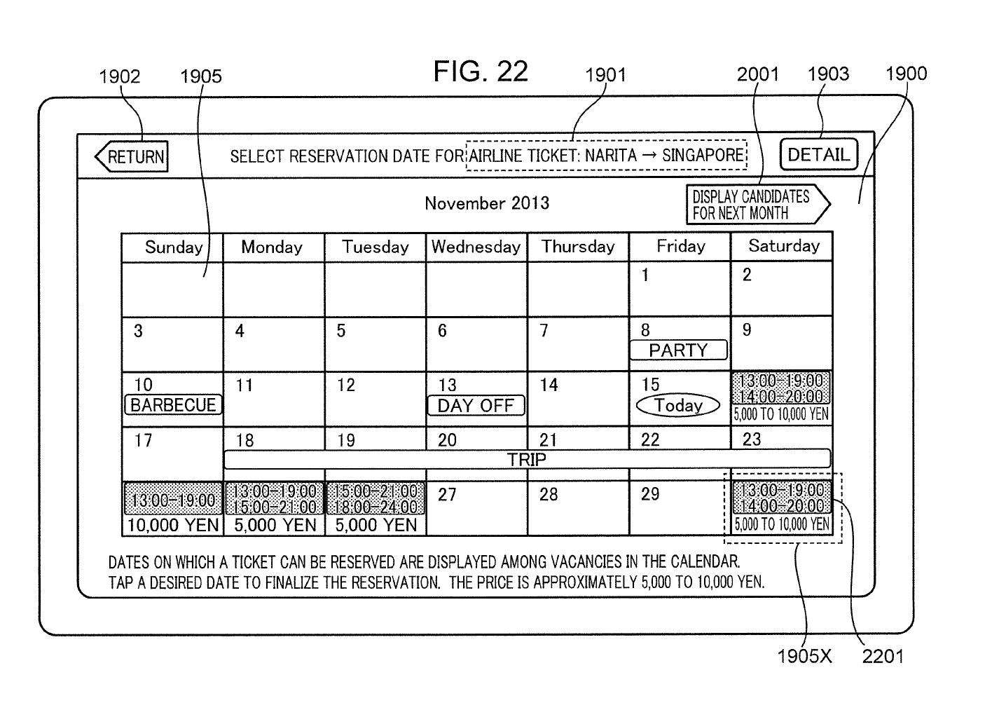

FIG. 22 is a diagram showing a third example of the reservation date selection screen 1900. The reservation date selection screen 1900 according to the third example differs from the reservation date selection screen 1900 according to the second example in that a candidate reservation date is indicated by a candidate reservation time 2201 instead of the candidate symbol 1906.

In FIG. 22, for example, a time slot of 13:00 to 19:00 and a time slot of 14:00 to 20:00 are displayed as the candidate reservation time 2201 in a box 1905X on the 30th.

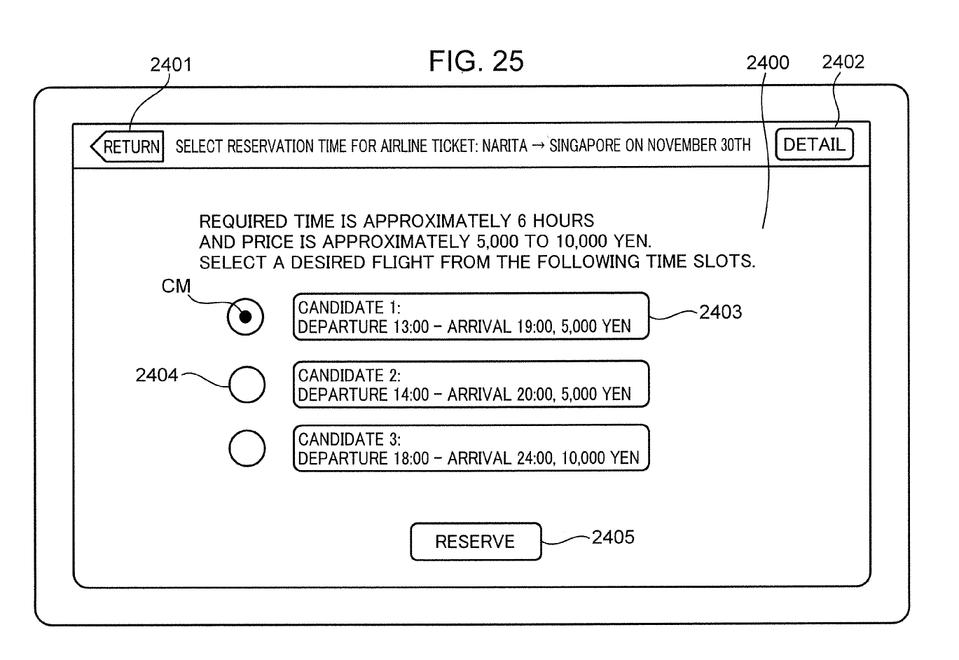

When the user taps a desired candidate reservation time 2201, a reservation time selection screen 2400 (FIG. 25) on which the candidate reservation time 2201 is initially selected is displayed on the display 209. For example, when the candidate reservation time 2201 of 13:00 to 19:00 is tapped, in FIG. 25, the reservation time selection screen 2400 is displayed on which a check mark CM is initially displayed in a check box 2404 corresponding to a time slot display field 2403 of 13:00 to 19:00.

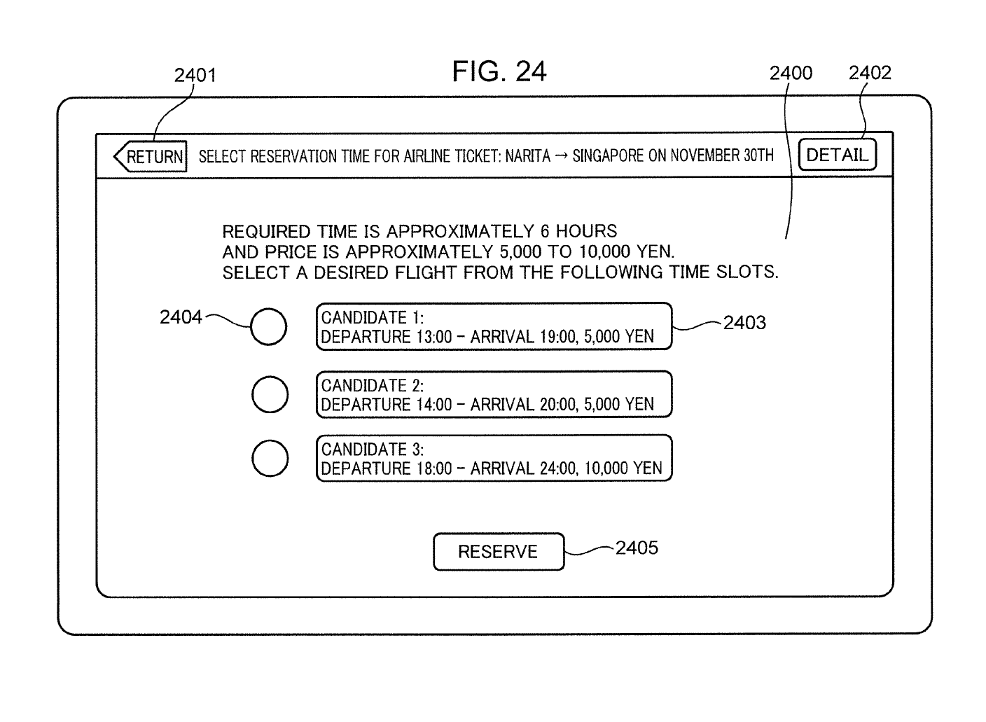

On the other hand, when the box 1905 corresponding to a candidate reservation date is tapped on the reservation date selection screens 1900 according to the first and second examples, the reservation time selection screen 2400 (FIG. 24) on which the check mark CM is not initially displayed is displayed. As a result, the user must tap the time slot display field 2403 that displays a desired candidate reservation time on the reservation time selection screen 2400 shown in FIG. 24.

Therefore, when the reservation date selection screen 1900 according to the third example is selected, the user need no longer tap a desired candidate reservation time on the reservation time selection screen 2400 and is saved the trouble of having to do so.

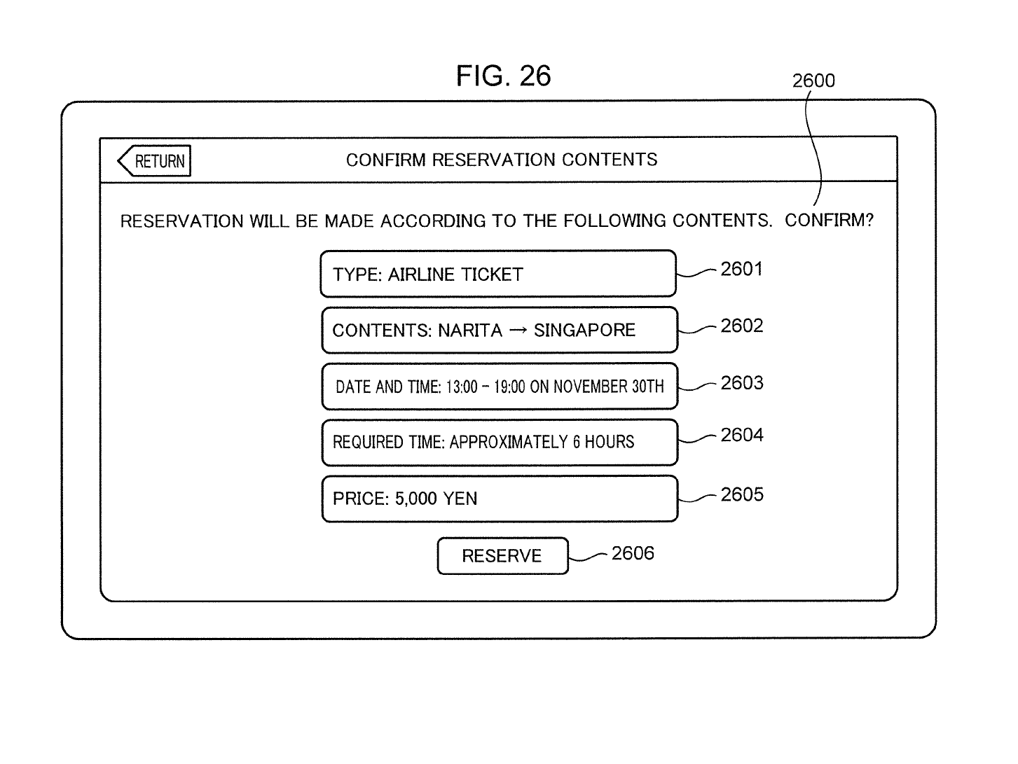

Alternatively, when the candidate reservation time 2201 is tapped on the reservation date selection screen 1900 according to the third example, the reservation screen generator 201 may cause a transition of the display screen to a reservation content confirmation screen 2600 (FIG. 26) without displaying the reservation time selection screen 2400. Accordingly, process steps of screen display are reduced and efficiency of the process can be improved.

In addition, in FIG. 22, when there is an excessive number of candidate reservation times 2201, the reservation screen generator 201 is unable to display all candidate reservation times 2201 in one box 1905 corresponding to a candidate reservation date. In such a case, the reservation screen generator 201 may not display the candidate reservation times 2201 in the box 1905. Specifically, the reservation screen generator 201 may be configured not to display the candidate reservation times 2201 in the box 1905 when the number of the candidate reservation times 2201 exceeds a prescribed upper limit value that can be displayed in the box 1905.

Alternatively, when all candidate reservation times 2201 cannot be displayed in one box 1905, the reservation screen generator 201 may only display candidate reservation times 2201 corresponding to the upper limit value in, for example, in an order of time slots from earliest to latest.

Moreover, when the candidate reservation times 2201 cannot be displayed in one box 1905, the reservation screen generator 201 may display the reservation time selection screen 2400 when the box 1905 is tapped. In addition, the reservation screen generator 201 may display the time slot display fields 2403 corresponding to all candidate reservation times on the reservation time selection screen 2400. Accordingly, the user can select the candidate reservation times 2201 that had been hidden on the reservation date selection screen 1900.

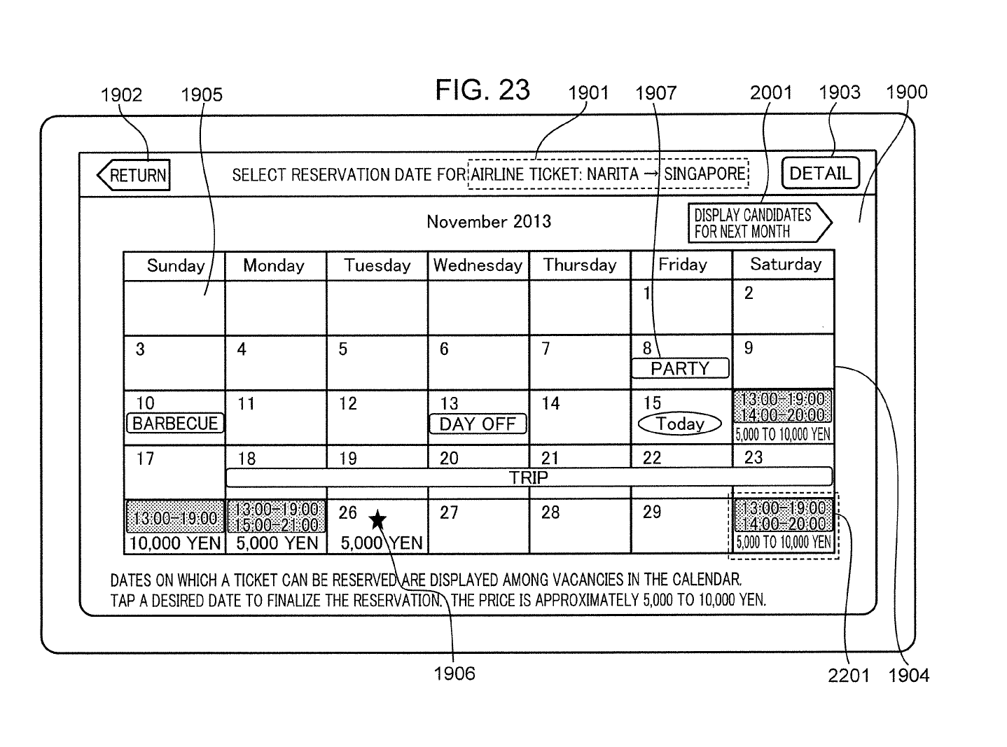

FIG. 23 is a diagram showing a fourth example of the reservation date selection screen 1900. The reservation date selection screen 1900 according to the fourth example is a combination of the reservation date selection screens 1900 according to the second and third examples. In other words, while the reservation screen generator 201 hides candidate reservation times 2201 when all candidate reservation times 2201 cannot be displayed in one box 1905 in the third example, the reservation screen generator 201 displays the candidate symbol 1906 in place of the candidate reservation time 2201 in the fourth example.

In FIG. 23, for example, since the number of candidate reservation times 2201 exceeds an upper limit value on the 26th, the reservation screen generator 201 displays the candidate symbol 1906 in the box 1905 corresponding to the 26th.

Moreover, on the reservation date selection screens according to the third and fourth examples, the reservation screen generator 201 may display the schedule icon 1907 and the candidate reservation times 2201 in different colors. Accordingly, the user can recognize the user's own schedule and candidate reservation dates in a more distinguishable manner.

FIG. 24 is a diagram showing an example of the reservation time selection screen 2400. The reservation time selection screen 2400 is a screen for having a user select a reservation time of a ticket. A heading that reads “Select reservation time for airline ticket: Narita→Singapore on November 30th” is provided in an upper part of the reservation time selection screen to explicitly indicate that the screen is for selecting a reservation time. A return button 2401 that is displayed to the left of the heading is a button for returning the screen display from the reservation time selection screen 2400 to the reservation date selection screen 1900.

A detail button 2402 that is displayed to the right of the heading is a button for switching the screen display from the reservation time selection screen 2400 to a reservation detail confirmation screen 2900 (FIG. 29).

On the reservation time selection screen 2400, a text reading “Required time is approximately 6 hours and price is approximately 5,000 to 10,000 yen. Select a desired flight from the following time slots.” is displayed below the heading to prompt the user to select a reservation time.

One or more time slot display fields 2403 are vertically aligned below the text. In addition, a check box 2404 is displayed to the left of each time slot display field 2403. The time slot display field 2403 displays candidate reservation times at which a reservation of a ticket can be made on a candidate reservation date that is tapped by the user on the reservation date selection screen 1900.

In the example shown in FIG. 24, since the box 1905 of November 30th has been tapped on the reservation date selection screen 1900, candidate reservation times on November 30th are displayed. In this example, three time slot display fields 2403 representing a departure and arrival time slot of 13:00 to 19:00, a departure and arrival time slot of 14:00 to 20:00, and a departure and arrival time slot of 18:00 to 24:00 are displayed. In addition, candidate numbers from candidate 1 to candidate 3 are displayed in the time slot display fields 2403 in an order of time slots from earliest to latest. Furthermore, prices corresponding to candidate reservation times are displayed in the time slot display fields 2403. In this example, for example, since the time slot of 18:00 to 24:00 represents a flight with a small number of available seats, the price is set higher than candidates 1 and 2 that represent other time slots.

The user selects a candidate reservation time by tapping a check box 2404 corresponding to the time slot display field 2403 that displays a desired candidate reservation time. For example, let us assume that the user taps the top check box 2404. As a result, the reservation screen generator 201 displays the check mark CM in the tapped check box 2404 as shown in FIG. 25.

FIG. 25 is a diagram showing the reservation time selection screen 2400 in a state in which a candidate reservation time is selected. Accordingly, the user can confirm the candidate reservation time selected by the user.

In addition, when a reservation button 2405 displayed at the bottom of the reservation time selection screen 2400 is tapped, the reservation screen generator 201 causes the reservation content confirmation screen 2600 (FIG. 26) to be displayed on the display 209.

FIG. 26 is a diagram showing an example of the reservation content confirmation screen 2600. The reservation content confirmation screen 2600 is a screen for the user to confirm reservation contents.

A heading that reads “Confirm reservation contents” is displayed at the top of the reservation content confirmation screen 2600 to explicitly indicate that the screen is a screen for confirming reservation contents. A text reading “A reservation will be made according to the following contents. Confirm?” is displayed below the heading to explicitly indicate that reservation contents are displayed in fields below.

A type display field 2601, a content display field 2602, a date and time display field 2603, a time display field 2604, and a price display field 2605 are displayed vertically aligned below the text. The type display field 2601 is a field that displays a type of the ticket that is a reservation object. In this case, “Type: airline ticket” is displayed.

The content display field 2602 is a field that displays contents of the ticket. In this case, since an airline ticket whose departure point is Narita and arrival point is Singapore has been reserved, “Contents: Narita→Singapore” is displayed.

The date and time display field 2603 is a field that displays a candidate reservation date and a candidate reservation time selected by the user. In this case, since a candidate reservation date of November 30th has been selected on the reservation date selection screen 1900 and a candidate reservation time of 13:00 to 19:00 has been selected on the reservation time selection screen 2400, “Date and time: 13:00 to 19:00 on November 30th” is displayed.

The time display field 2604 is a field for displaying a required time that is required for the flight. In this case, “Required time: approximately 6 hours” is displayed.

The price display field 2605 is a field that displays a price of the ticket. In this case, “Price: 5,000 yen” is displayed.

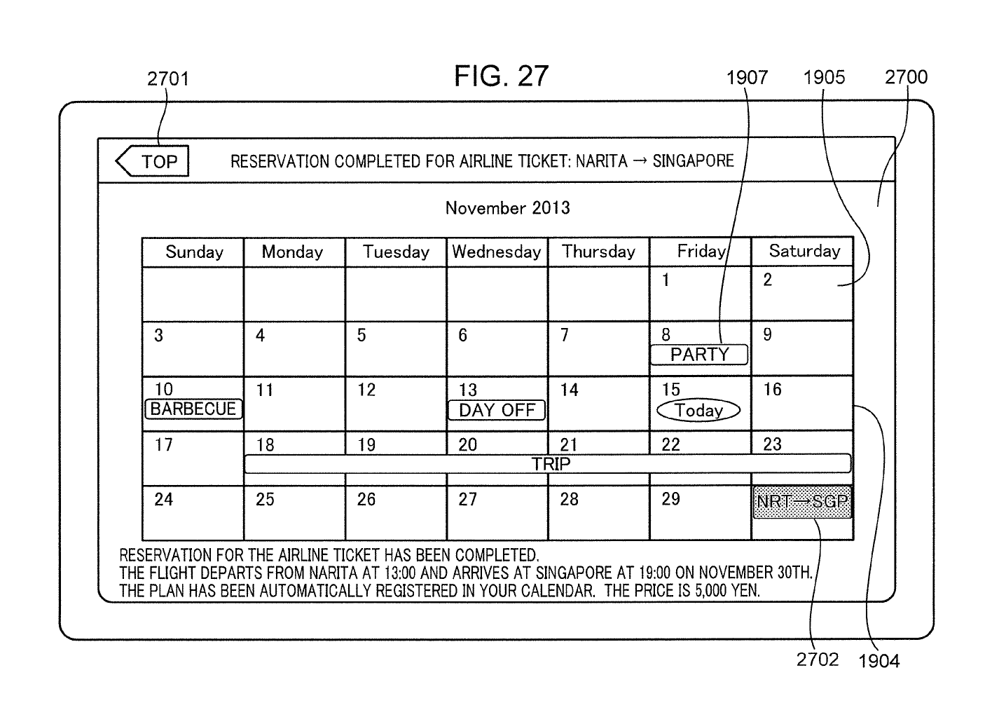

When the user consents to the reservation contents displayed on the reservation content confirmation screen 2600, the user taps the reservation button 2606. As a result, the reservation screen generator 201 displays a reservation completion screen 2700 (FIG. 27) on the display 209.

Alternatively, a purchasing process (settlement) may be performed in addition to making a ticket reservation on the reservation content confirmation screen 2600. In this case, the reservation screen generator 201 may display a purchase button in place of the reservation button 2606. In addition, when the purchase button is tapped, the reservation screen generator 201 may display a payment method selection screen for inputting, for example, a card number of a credit card.

FIG. 27 is a diagram showing a first example of the reservation completion screen 2700. A heading that reads “Reservation completed for airline ticket: Narita→Singapore” is provided in an upper part of the reservation completion screen 2700 to explicitly indicate that the screen is a screen for notifying the completion of a reservation.

The calendar data display field 1904 is displayed on the reservation completion screen 2700 in a similar manner to the reservation date selection screen 1900. A reservation icon 2702 indicating a reservation date is displayed in the box 1905 corresponding to the reservation date on which the user has made a reservation in the calendar data display field 1904. In the example shown in FIG. 27, “NRT→SGP” is displayed on the reservation icon 2702 to explicitly indicate that the ticket for which a reservation has been made is a flight from Narita to Singapore. In addition, in the example shown in FIG. 27, since the reservation date on which the user has made a reservation is the 30th, the reservation icon 2702 is displayed in the box 1905 corresponding to the 30th.

Furthermore, since there is no need to notify a candidate reservation date on the reservation completion screen 2700, the candidate symbol 1906 that represents a candidate reservation date and the candidate reservation time 2201 which have been displayed on the reservation date selection screen 1900 are hidden on the reservation completion screen 2700. Accordingly, the user can confirm a reservation date at a glance with the reservation icon 2702.

On the other hand, the schedule icon 1907 which is displayed on the reservation date selection screen 1900 is also displayed on the reservation completion screen 2700. Therefore, the user can confirm the user's own schedule on the reservation completion screen 2700 without having to separately start up a calendar application.

Moreover, on the reservation completion screen 2700, the reservation screen generator 201 may display the schedule icon 1907 and the reservation icon 2702 in different colors. Accordingly, the user can recognize the user's own schedule and reservation dates in a more distinguishable manner.

On the reservation completion screen 2700, a text reading “Reservation for the airline ticket has been completed. The flight departs from Narita at 13:00 and arrives at Singapore at 19:00 on November 30th. The plan has been automatically registered in your calendar. The price is 5,000 yen.” informing that a reservation has been completed is displayed below the calendar data display field 1904. Accordingly, completion of the reservation is explicitly indicated to the user.

Moreover, in the calendar data display field 1904 displayed on the reservation date selection screen 1900 and the reservation completion screen 2700 displayed above, the user can also register a schedule. In this case, for example, when the user taps the box 1905 corresponding to a desired date in the calendar data display field 1904, the reservation screen generator 201 causes a screen for inputting details of a schedule to be displayed. Subsequently, the reservation screen generator 201 notifies information input using the screen to the calendar data managers 107 and 206. Accordingly, the schedule input by the user through the calendar data display field 1904 is registered in the calendar data storages 108 and 207.

Moreover, a top button 2701 with the description “top” that is displayed in a top left part of the reservation completion screen 2700 is a button for switching the display screen of the display 209 to the top screen 1400 (FIG. 14).

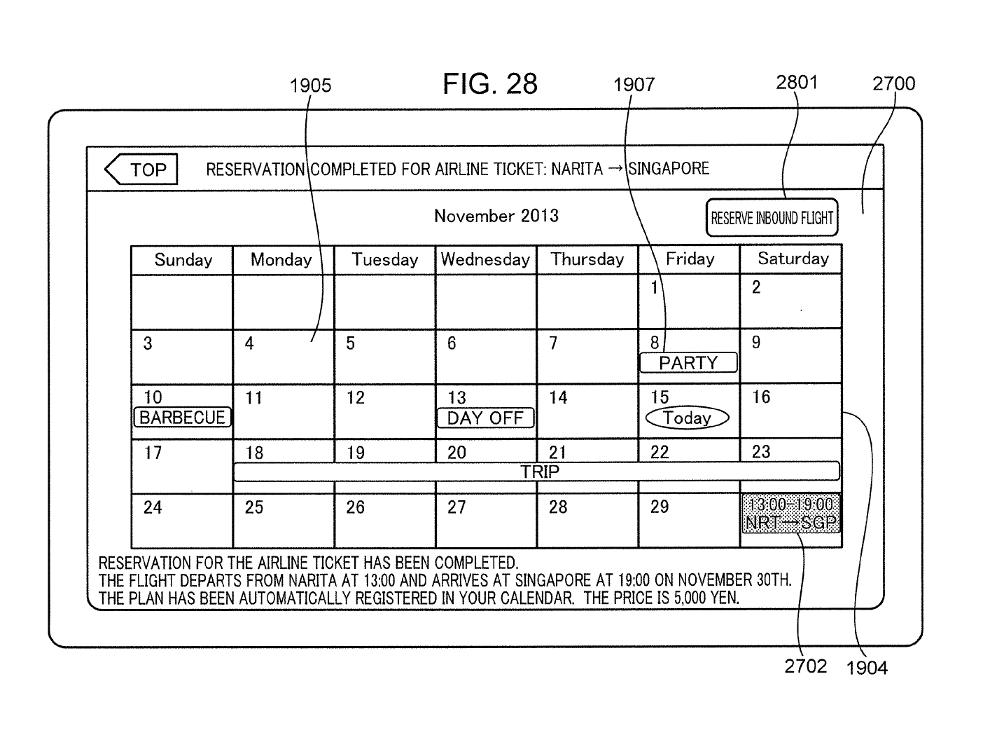

FIG. 28 is a diagram showing a second example of the reservation completion screen 2700. A difference from the first example is that departure and arrival times are displayed on the reservation icon 2702. In the example shown in FIG. 28, since the time slot of 13:00 to 19:00 represent the departure and arrival times, “13:00-19:00” is displayed in addition to a text reading “NRT→SGP” on the reservation icon 2702. Accordingly, the user can confirm the departure and arrival times in addition to a reservation date with the reservation icon 2702.

An additional reservation button 2801 is displayed on a right side in an upper part of the reservation completion screen 2700 according to the second example. The additional reservation button 2801 is a button for reserving an additional ticket. A description of “Reserve inbound flight” is provided on the additional reservation button 2801 to explicitly indicate that the button is for reserving an airline ticket for “Singapore→Narita”. When the user taps the additional reservation button 2801, the reservation screen generator 201 switches the display screen of the display 209 to the reservation date selection screen 1900 for reserving an airline ticket for “Singapore→Narita”.

FIG. 29 is a diagram showing an example of the reservation detail confirmation screen 2900. The reservation detail confirmation screen 2900 is a screen that is displayed when the detail button 1903 is tapped on the reservation date selection screen 1900 or when the detail button 2402 is tapped on the reservation time selection screen 2400.

The reservation detail confirmation screen 2900 is a screen for causing the user to confirm details of reservation contents. A heading that reads “Reservation details” is displayed at the top of the reservation detail confirmation screen 2900 to explicitly indicate that the screen is a screen for confirming details of reservation contents. A text reading “The following ticket will be reserved.” is displayed below the heading to explicitly indicate that details of reservation contents are displayed in fields below.

A type display field 2902, a content display field 2903, a time display field 2904, and a price display field 2905 are displayed vertically aligned below the text. These fields display the same contents as those displayed in the fields with the same names on the reservation content confirmation screen 2600 (FIG. 26).

Through the reservation detail confirmation screen 2900, information for making a determination on whether or not to make a reservation can be presented to the user.

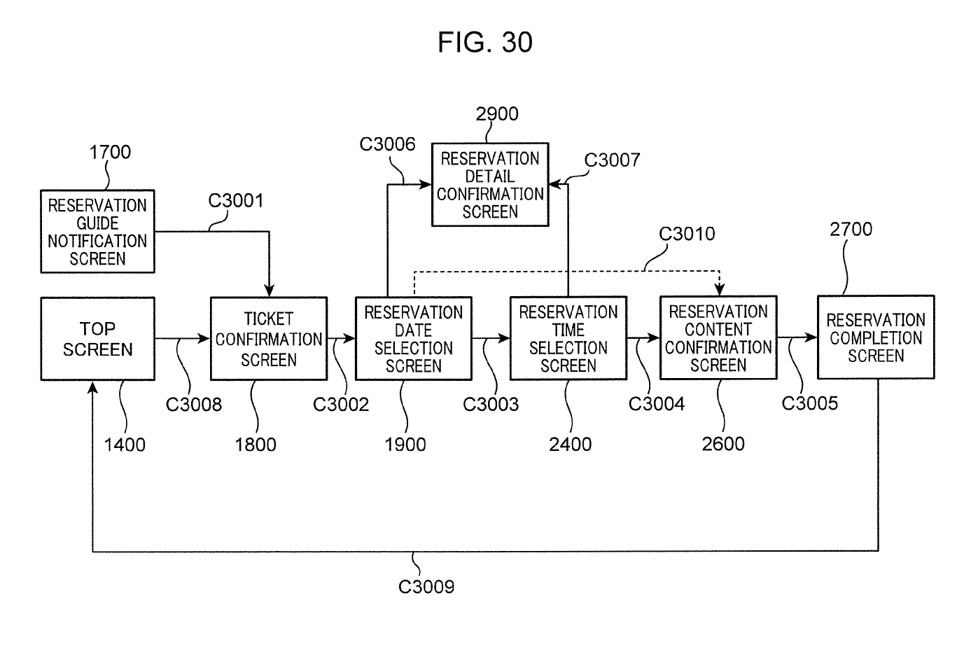

FIG. 30 is a diagram showing a screen flow according to the present disclosure. In the present disclosure, there are two start points in the screen flow. One start point is the reservation guide notification screen 1700 and another start point is the top screen 1400. The reservation guide notification screen 1700 is displayed when the reservation system detects registration of a ticket that is in accordance with the preferences of the user while the top screen 1400 is displayed when the user taps the reservation application icon 1301 on the basic screen 1300.

When the screen controller 204 detects that the reservation guide notification screen 1700 has been tapped, the reservation screen generator 201 switches the screen display to the ticket confirmation screen 1800 (C3001). When the screen controller 204 detects that the reservation button 1806 has been tapped on the ticket confirmation screen 1800, the reservation screen generator 201 switches the screen display to the reservation date selection screen 1900 (C3002).

When the screen controller 204 detects that the box 1905 representing a candidate reservation date has been tapped on the reservation date selection screen 1900, the reservation screen generator 201 switches the screen display to the reservation time selection screen 2400 (C3003). When the screen controller 204 detects that the time slot display field 2403 has been tapped on the reservation time selection screen 2400, the reservation screen generator 201 switches the screen display to the reservation content confirmation screen 2600 (C3004).

When the screen controller 204 detects that the reservation button 2606 has been tapped on the reservation content confirmation screen 2600, the reservation screen generator 201 switches the screen display to the reservation completion screen 2700 (C3005). When the screen controller 204 detects that the detail button 1903 has been tapped on the reservation date selection screen 1900, the reservation screen generator 201 switches the screen display to the reservation detail confirmation screen 2900 (C3006). In this case, when the screen controller 204 detects that the return button 2901 has been tapped on the reservation detail confirmation screen 2900, the reservation screen generator 201 returns the screen display to the reservation date selection screen 1900 (C3006).

In addition, when the screen controller 204 detects that the detail button 2402 has been tapped on the reservation time selection screen 2400, the reservation screen generator 201 switches the screen display to the reservation detail confirmation screen 2900 (C3007). In this case, when the screen controller 204 detects that the return button 2901 has been tapped on the reservation detail confirmation screen 2900, the reservation screen generator 201 returns the screen display to the reservation time selection screen 2400 (C3007).

When the screen controller 204 detects that the reservation button 1402 in the ticket display field 1401 has been tapped on the top screen 1400, the reservation screen generator 201 switches the screen display to the specialized institution confirmation screen 1800 (C3008).

When the screen controller 204 detects that the top button 2701 has been tapped on the reservation completion screen 2700, the reservation screen generator 201 switches the screen display to the top screen 1400 (C3009).

Moreover, in the case of the reservation date selection screen 1900 according to the third example (FIG. 22), when the screen controller 204 detects that the candidate reservation time 2201 has been tapped as described above, the reservation screen generator 201 may bypass the reservation time selection screen 2400 and display the reservation content confirmation screen 2600 (C3010).

FIG. 31 is a diagram showing an example of a data configuration of customer history 3100. The customer history 3100 is data indicating a history of activities of a customer. The customer history 3100 is periodically transmitted from the reservation terminal 200 to the reservation server 100 or the customer management server 400 which analyzes information on customers. In addition, the customer history 3100 is stored in plurality in the reservation server 100 or the customer management server 400 and is used when the reservation server 100 or the customer management server 400 analyzes the preferences of a customer. The reservation server 100 or the customer management server 400 stores the customer history 3100 of a plurality of customers.

The customer history 3100 includes a “header”, a “customer attribute”, and “history”. The “header” includes a “user ID” and a “transmission date and time”. The “user ID” is an identifier that is uniquely set for each user. The “transmission date and time” represents the time when the reservation terminal 200 transmits the customer history 3100 to the reservation server 100 or the customer management server 400.

The “customer attribute” includes a “gender”, an “age”, and a “region”. “Gender” represents the gender of the user. In the example shown in FIG. 31, “gender” includes the information of “male”. “Age” represents the age of the user. In the example shown in FIG. 31, “age” includes the information of “30 years old”. “Region” roughly represents a place of residence of the user. In the example shown in FIG. 31, “region” includes the information of “Osaka, Japan”.

“History” includes a “genre of recently viewed sites”, a “genre of recently used applications”, a “genre of recently viewed TV programs”, and the like. The “genre of recently viewed sites” represents a genre of a website that has been recently viewed by the user. In the example shown in FIG. 31, the “genre of recently viewed sites” includes the information of “travel”. The “genre of recently used applications” represents a genre of an application that has been recently used by the user. In the example shown in FIG. 31, the “genre of recently used applications” includes the information of “travel”. The “genre of recently viewed TV programs” represents a genre of a TV program that has been recently viewed by the user. In the example shown in FIG. 31, the “genre of recently viewed TV programs” includes the information of “cooking”.

The reservation server 100 or the customer management server 400 may, for example, assume a genre of a most frequently viewed website or a genre of a most frequently used application among a plurality of stored pieces of “history” of a customer to be a genre of preferences of the customer. The reservation server 100 or the customer management server 400 may analyze the preferences of a customer by any other method.

In addition, the reservation server 100 or the customer management server 400 may also collect customer history from terminals (for example, personal computers and so-called smartphones) other than the reservation terminal 200.

FIG. 32 is a diagram showing an example of a data configuration of customer information 3200. The customer information 3200 is data which represents information related to a customer and which is generated based on a result of an analysis of the customer history 3100 by the reservation server 100 or the customer management server 400. The reservation server 100 or the customer management server 400 generates the customer information 3200 based on the customer history 3100 that is transmitted from the reservation terminal 200 and manages the customer information 3200. The customer information 3200 that is managed by the reservation server 100 or the customer management server 400 includes information on a plurality of customers.

The customer information 3200 includes a “user ID”, a “gender”, an “age”, a “region”, a “preference”, and a “service use history”. The “user ID” is an identifier that is uniquely set for each user. “Gender” represents the gender of the user with a corresponding ID. “Age” represents the age of the user with a corresponding ID. “Region” roughly represents a place of residence of the user with a corresponding ID.

“Preferences” represent preferences of the user with a corresponding user ID. The “preferences” include genres sorted in a descending order of interest. The example shown in FIG. 32 reveals that interests of a user with a “user ID” of “U0001” include, in a descending order of interest, “travel”, “cooking”, and “movies”.

“Service use history” represents a history of services used by the user with a corresponding user ID. “Service use history” includes services used by the user which are sorted in reverse chronological order. The example shown in FIG. 32 reveals that the user with a “user ID” of “U0001” had most recently reserved an airline ticket and had made a reservation for a concert before that.

FIG. 33 is a diagram showing an example of a data configuration of the ticket list 3300 that is managed by the reservation server 100. Tickets which are issued by a ticket issuing institution and which can be reserved by the user are registered in the ticket list 3300. The ticket issuing institution is, for example, an airline, a promoter of an event such as a concert and a sports event, or the like. The ticket list 3300 is, for example, stored in the storage 103 and managed by the reservation data manager 101 of the reservation server 100.

The reservation terminal 200 acquires the ticket list 3300 from the reservation server 100 when the reservation screen generator 201 displays the top screen 1400.

Information on one ticket is registered in one record in the ticket list 3300. Registered information includes a “ticket ID”, a “type”, “contents”, a “required time”, and a “price”. The “ticket ID” is an identifier that is uniquely set for each ticket. The “ticket ID” is assigned by the reservation data manager 101 when a ticket is registered in the reservation server 100 by the ticket issuing institution.

The “type” represents a type of the ticket with a corresponding “ticket ID”. The example shown in FIG. 33 reveals that the “type” of the ticket with a “ticket ID” of “T0001” is an “airline ticket”. The “contents” represent contents of the ticket with a corresponding “ticket ID”. The example shown in FIG. 33 reveals that the “contents” of the ticket with a “ticket ID” of “T0001” is “Narita→Singapore”.

The “required time” represents a required time of the ticket with a corresponding “ticket ID”. The example shown in FIG. 33 reveals that the “required time” of the ticket with a “ticket ID” of “T0001” is “approximately 6 hours”. The “price” represents a price of the ticket with a corresponding “ticket ID”. The example shown in FIG. 33 reveals that the “price” for the ticket with a “ticket ID” of “T0001” is “approximately 5,000 yen”.

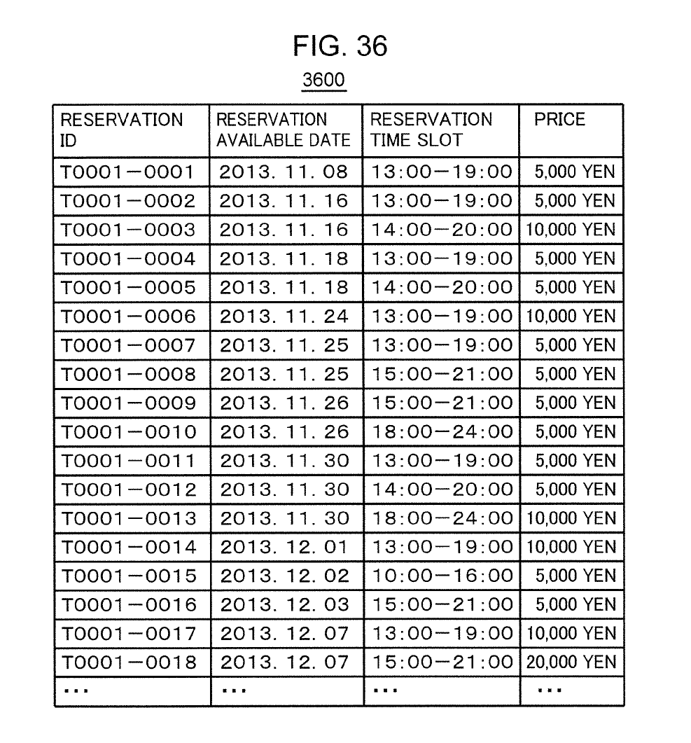

Moreover, a plurality of candidate dates are included for each ticket. The user can acquire the plurality of candidate dates from a reservation available date list 3600 (FIG. 36). The ticket list 3300 may include other information such as the number of tickets that are still available.

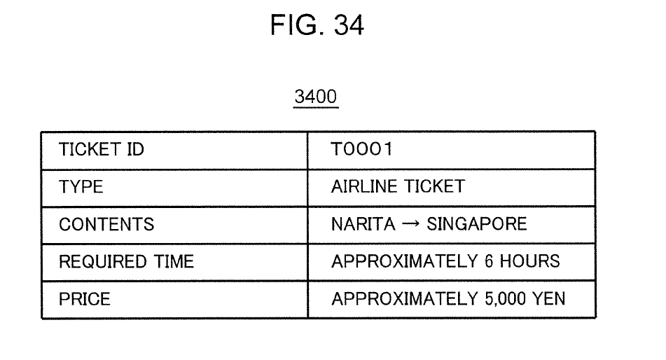

FIG. 34 is a diagram showing an example of a data configuration of recommended ticket information 3400. The recommended ticket information 3400 is data indicating a ticket that is in accordance with the preferences of the user. When a ticket that is in accordance with the preferences of the user is registered in the reservation server 100 by the ticket issuing institution, the reservation server 100 generates the recommended ticket information 3400. The reservation server 100 transmits the generated recommended ticket information 3400 to the reservation terminal 200 of a corresponding user.

The recommended ticket information 3400 includes a “ticket ID”, a “type”, “contents”, a “required time”, and a “price” in a similar manner to the ticket list 3300.

The recommended ticket information 3400 shown in FIG. 34 is transmitted from the reservation server 100 to the reservation terminal 200 of a user for which “travel” is set to the “preferences” field in the customer information 3200 (FIG. 32).

FIG. 35 is a diagram showing an example of a data configuration of the calendar plan list 3500. The calendar plan list 3500 (an example of the schedule information) is data in which schedules input by the user using a reservation application or a calendar application are registered. The calendar plan list 3500 is used when the reservation screen generator 201 generates the calendar data display field 1904 described earlier. Moreover, the calendar plan list 3500 is also used when the calendar screen generator 205 displays a calendar screen. In addition, the calendar plan list 3500 is provided for each user.

Specifically, the calendar plan list 3500 is data in which one or more records are allocated to one plan and to which a “day”, a “time”, and “plan contents” are registered. The “day” represents the day on which a concerned plan is to be carried out. The “time” represents the time at which a concerned plan is to be carried out. The “plan contents” represent contents of a concerned plan.

For example, a plan for a “party” to be held between 13:00 and 18:00 on Nov. 8, 2013 is registered to the record in the first row. Moreover, since the plan of the “party” ends on the same day, one record is allocated to the plan.

On the other hand, while a plan of a “trip” registered to the fourth to ninth rows is one plan, since the plan extends over six days, six records are allocated.

FIG. 36 is a diagram showing an example of a data configuration of a reservation available date list 3600. The reservation available date list 3600 is a list created by expanding the “ticket ID” of the ticket list 3300 (FIG. 33) with respect to a reservation available date. The reservation available date list 3600 is data that is generated by the reservation data manager 101 based on data registered in the reservation server 100 by a ticket issuing institution. In the example shown in FIG. 36, the reservation available date list 3600 represents a flight schedule of an airline ticket corresponding to a “ticket ID” of “T0001”.

Specifically, the reservation available date list 3600 is data in which one record is allocated to one reservation available date and time and to which an “reservation ID”, an “reservation available date”, an “reservation time slot”, and a “price” are registered.

The “reservation ID” is an identifier that is assigned by the reservation data manager 101 for each reservation available date and time of the “ticket ID” in the ticket list 3300. The “reservation available date” represents a date of a concerned reservation available date and time. The “reservation time slot” represents a time slot of a concerned reservation available date and time. A price as of the concerned reservation available date and time is registered in the “price”.

For example, a reservation available date and time with a price of 5,000 yen is registered for 13:00 to 19:00 on Nov. 8, 2013 as data with a “reservation ID” of “T0001-0001” in the record of the first row.

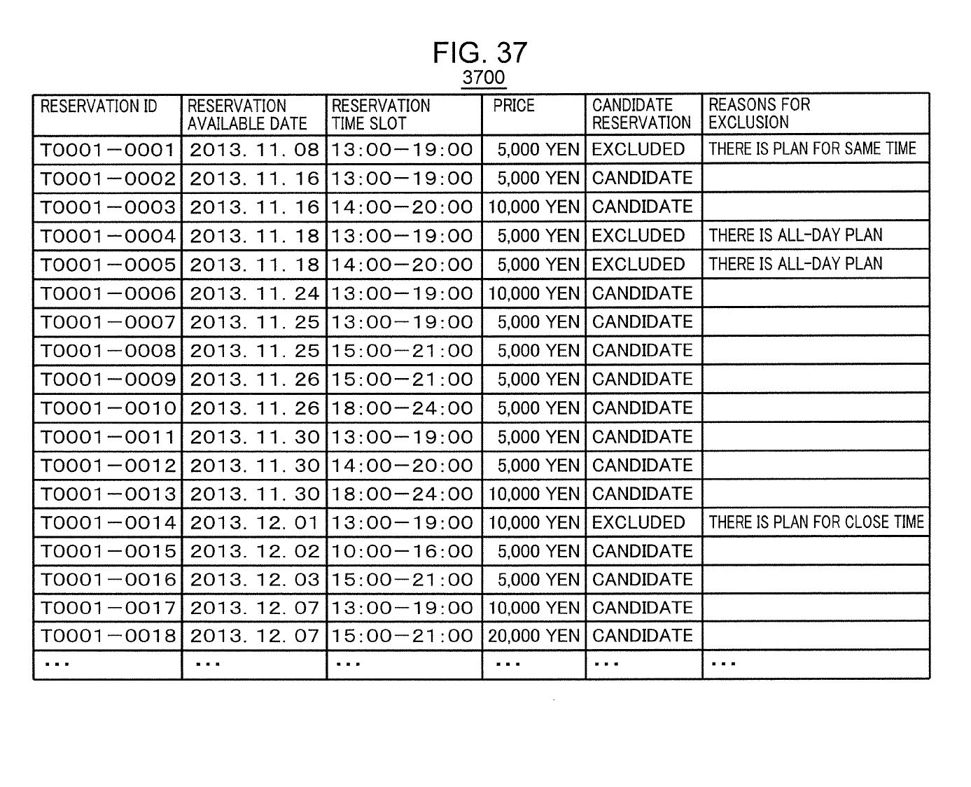

FIG. 37 is a diagram showing an example of a data configuration of a candidate reservation date list 3700. The candidate reservation date list 3700 is data which is created based on the reservation available date list 3600 and in which candidate reservation dates and times of a corresponding user are registered in the reservation available date list 3600. The candidate reservation date list 3700 is created for each user by the candidate reservation date selector 202 by referring to the calendar plan list 3500 and the reservation available date list 3600 of each user.

The candidate reservation date list 3700 is data in which one record is allocated to one reservation available date and time. An “reservation ID”, an “reservation available date”, an “reservation time slot”, a “price”, a “candidate reservation”, and “reasons for exclusion” are registered in the candidate reservation date list 3700. The “reservation ID”, the “reservation available date”, the “reservation time slot”, and the “price” are the same as data with the same names in the reservation available date list 3600.

In the “candidate reservation”, “candidate” is registered if a corresponding reservation available date and time is extracted as a candidate reservation date and time and “excluded” is registered if the corresponding reservation available date and time is excluded from the candidate reservation dates and times. The “reasons for exclusion” represents reasons for exclusion in a case where a corresponding reservation available date and time is excluded from the candidate reservation dates and times.

Hereinafter, assuming that the calendar plan list 3500 belongs to a user A, an extraction process of a candidate reservation date and time of the user A will be described.

For example, “13:00 to 19:00” on “November 8th, 2013” is registered as a reservation available date and time in a first row (with an “reservation ID” of “T0001-0001”) in the candidate reservation date list 3700. On the other hand, a plan of “party” is registered in the calendar plan list 3500 for the same time slot. Therefore, the candidate reservation date selector 202 excludes the reservation available date and time of the first row from the candidate reservation dates and times with respect to the user A. Therefore, “excluded” is registered as the “candidate reservation” in the record of the first row in the candidate reservation date list 3700 and “there is plan for concerned time” is registered as the “reasons for exclusion”. At this point, if a plan of the user is registered in a part of a time slot indicated by a reservation available date and time, the candidate reservation date selector 202 may exclude the reservation available date and time from the candidate reservation dates and times.

For example, “13:00 to 19:00” on “November 16th, 2013” is registered as a reservation available date and time in a second row (with an “reservation ID” of “T0001-0002”) in the candidate reservation date list 3700. On the other hand, there are no plans registered in the calendar plan list 3500 for the same time slot. Therefore, the candidate reservation date selector 202 extracts the reservation available date and time of the second row as a candidate reservation dates and times with respect to the user A. Therefore, “candidate” is registered as the “candidate reservation” in the record of the second row in the candidate reservation date list 3700 and nothing is registered as the “reasons for exclusion”.

For example, “there is all-day plan” is registered as the “reasons for exclusion” in a record of a fourth row (with an “reservation ID” of “T0001-0004”) in the candidate reservation date list 3700. This is because a plan is registered for 24 hours in the calendar plan list 3500 on the day to which the reservation available date and time of the record in the fourth row belongs.

For example, “plans for close time” is registered as the “reasons for exclusion” in a record of a 14th row (with an “reservation ID” of “T0001-0014”) in the candidate reservation date list 3700. This is because, while the reservation available date and time of this record is “13:00 to 19:00” on “December 1st, 2013”, a finish time for a plan to do shopping is registered one hour prior to “13:00” in the calendar plan list 3500 and an interval between the finish time of a time slot for this plan and a start time of the reservation available date and time is short. In this manner, even if a time slot represented by a reservation available date and time and a time slot represented by a plan of the user do not overlap each other, the candidate reservation date selector 202 may exclude the reservation available date and time from candidate reservation dates and times if an interval between the time slots is shorter than a specified value. Accordingly, the user can use the ticket without being rushed.

In this case, while the candidate reservation date selector 202 extracts a candidate reservation date and time by comparing a time slot represented by a reservation available date and time with a time slot represented by a candidate reservation date and time, the present disclosure is not limited thereto. For example, the candidate reservation date selector 202 may extract a candidate reservation date by comparing a reservation available date with a candidate reservation date.

For example, let us assume that a plan is registered in a time slot of 9:00 to 10:00 on Nov. 16, 2013 in the calendar plan list 3500. In this case, since a reservation available date and time of a second row in the candidate reservation date list 3700 is “13:00 to 19:00” on “November 16th, 2013”, although the time slots do not overlap each other, the reservation available date and time is excluded from the candidate reservation dates and times because the dates overlap each other.

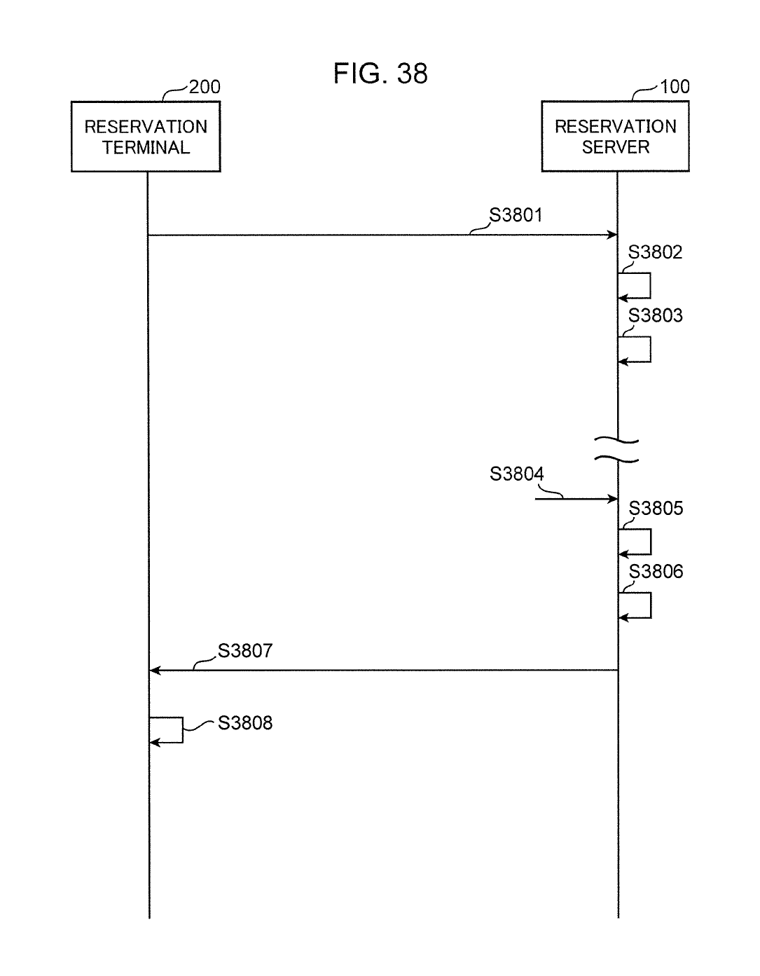

FIG. 38 is a sequence diagram showing a first example of an automatic startup process of a reservation application. In this case, the automatic startup process refers to a process for automatically starting up the reservation application without causing the user to input an operation to start up the reservation application. In the first example, the reservation server 100 stores customer history 3100 (FIG. 31) and manages customer information 3200 (FIG. 32).

First, the reservation terminal 200 transmits customer history 3100 (FIG. 31) to the reservation server 100 (S3801). At this point, for example, the reservation terminal 200 may transmit the customer history 3100 at regular time intervals or may transmit the customer history 3100 when new history is created.

Next, the reservation server 100 stores the transmitted customer history 3100 (S3802). In this case, the customer history 3100 is received by the communicating portion 105 and stored in the storage 103.

Subsequently, the reservation server 100 analyzes preferences of a customer based on the customer history 3100 and updates the customer information 3200 based on a result of the analysis (S3803).

Next, at a given timing, information on a new ticket is registered in the reservation server 100 by a ticket issuing institution (S3804). Based on the registration, the ticket list 3300 (FIG. 33) is updated by the reservation data manager 101 (S3805).

Subsequently, based on the customer information 3200, the reservation data manager 101 determines whether or not there is a customer whose preference is in accordance with the ticket registered in S3804 (S3806). When it is determined that there is a customer whose preference is in accordance with the ticket registered in S3804, the reservation data manager 101 generates the recommended ticket information 3400 and transmits the generated recommended ticket information 3400 to the reservation terminal 200 of the determined customer (when there are a plurality of determined customers, to the reservation terminals 200 of the determined customers) via the communicating portion 105 (S3807). In this case, the communicating portion 105 of the reservation server 100 transmits the recommended ticket information 3400 to the reservation terminal 200 to which a user ID in the customer information 3200 has been registered.

For example, when a discount ticket for a restaurant is registered in S3804, in the example shown in FIG. 32, recommended ticket information is transmitted to the reservation terminals 200 of three users whose “user IDs” are “U0001”, “U0002”, and “U0004” and for which “cooking” is registered among top three preferences in the “preferences” field in the customer information 3200.

For example, when a discount ticket for a tennis court is registered in S3804, in the example shown in FIG. 32, recommended ticket information is transmitted to the reservation terminals 200 of two users whose “user IDs” are “U0004” and “U0005” and for which “sports” is registered among top three preferences in the “preferences” field in the customer information 3200.

Next, the reservation terminal 200 starts up the reservation application (S3808). In this case, the reservation screen generator 201 displays the reservation guide notification screen 1700 on the display 209. Moreover, the processes of S3807 and S3808 are not executed if it is determined that there are no customers whose preference is in accordance with the ticket registered in S3804. Accordingly, when there is a customer whose preference is in accordance with the ticket registered in S3804, the reservation application is automatically started up.

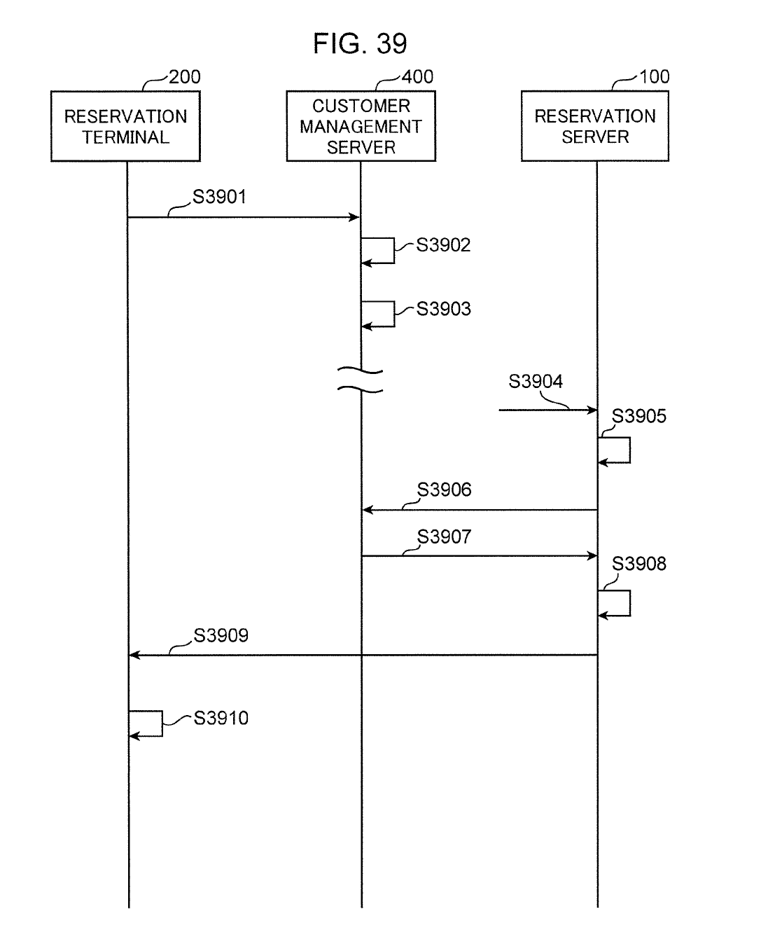

FIG. 39 is a sequence diagram showing a second example of an automatic startup process of the reservation application. In the second example, the customer management server 400 stores the customer history 3100 (FIG. 31) and manages the customer information 3200 (FIG. 32).

First, the reservation terminal 200 transmits the customer history 3100 (FIG. 31) to the customer management server 400 (S3901). Next, the customer management server 400 stores the transmitted customer history 3100 (S3902). In this case, the communicating portion 403 receives the customer history 3100 and the customer manager 402 stores the customer history 3100 in the storage 401.

Subsequently, the customer management server 400 analyzes preferences of a customer based on the customer history 3100 and updates the customer information 3200 based on a result of the analysis (S3903).

Next, at a given timing, information on a new ticket is registered in the reservation server 100 by a ticket issuing institution (S3904). Then, the ticket list 3300 (FIG. 33) is updated by the reservation data manager 101 (S3905).

Subsequently, the reservation data manager 101 issues a request to the customer management server 400 for information on a customer whose preference is in accordance with the ticket registered in S3904 (S3906). In this case, the reservation data manager 101 identifies a genre such as “restaurant” and “travel” from the ticket registered in S3804 and requests information on a customer whose preference is in accordance with the identified genre.

Next, if there is a customer in accordance with the genre that has been requested in S3906 based on the customer information 3200, the customer management server 400 transmits the information on the customer to the reservation server 100 (S3907).

Subsequently, when information on a customer is transmitted in S3907, the reservation data manager 101 generates the recommended ticket information 3400 (S3908). Subsequent processes S3909 and S3910 are the same as S3807 and S3808 in FIG. 38. Moreover, the processes of S3908 to S3910 are not executed if information on a customer is not transmitted in S3907. Accordingly, when information on a customer whose preference is in accordance with the ticket registered in S3904 is transmitted in S3907, the reservation application is automatically started up.

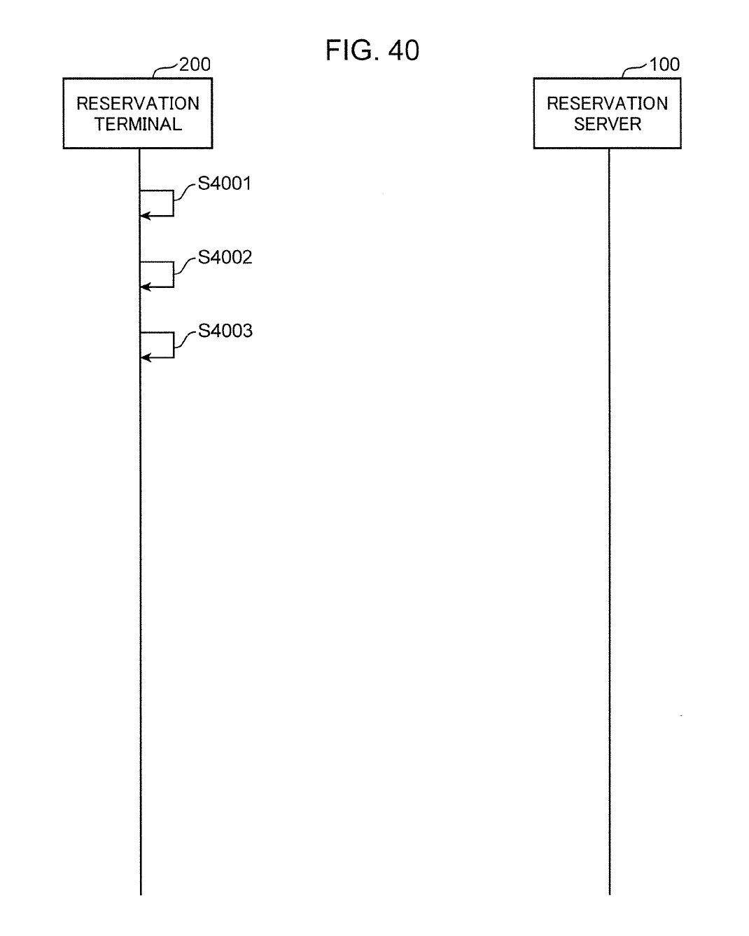

FIG. 40 is a sequence diagram showing a startup process of the reservation application when the reservation application is an embedded application. In this case, an embedded application refers to an application which is stored in a local memory (for example, a rewritable non-volatile storage device) of the reservation terminal 200 and which is read out from the local memory upon each startup.

First, the reservation terminal 200 starts up the reservation application (S4001). In this case, startup of the reservation application is triggered by an input of an operation for starting up the reservation application by the user or by transmission of the recommended ticket information 3400.

Next, the reservation terminal 200 reads the reservation application from the local memory (S4002). In this case, the reservation application is read from the local memory by, for example, a processor of the reservation terminal 200.

Subsequently, the reservation terminal 200 displays a screen of the reservation application on the display 209 (S4003). At this point, the top screen 1400 is displayed when the startup of the reservation application is triggered by the input of an operation by the user and the reservation guide notification screen 1700 is displayed when the startup of the reservation application is triggered by the transmission of the recommended ticket information 3400.

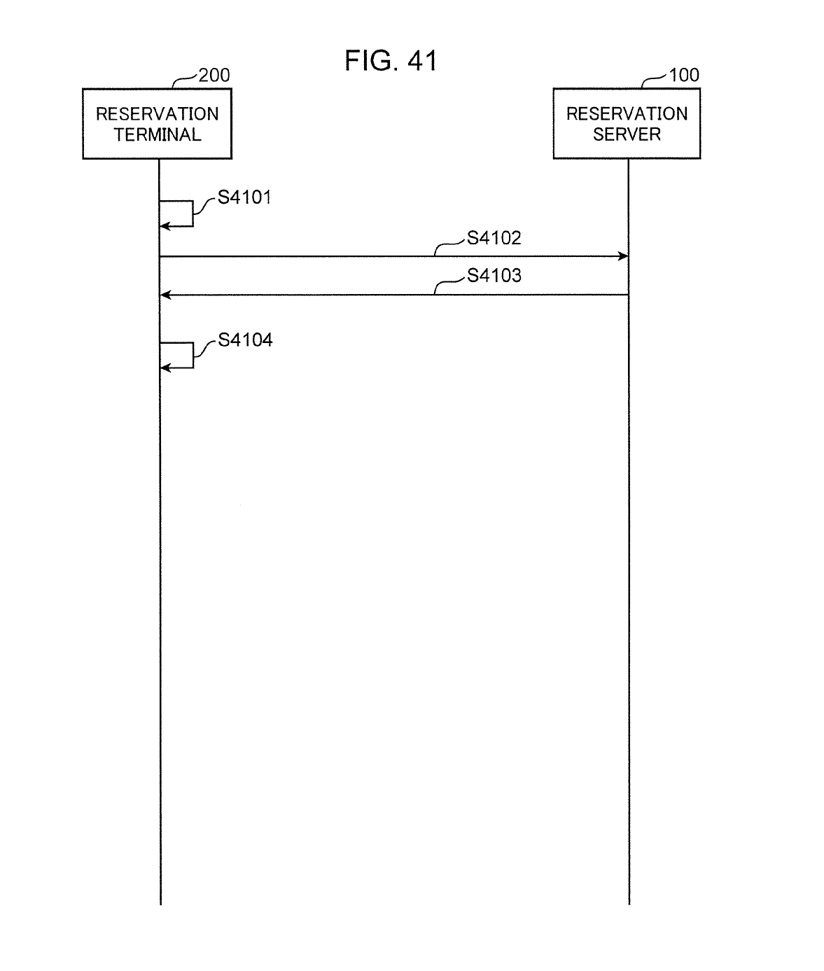

FIG. 41 is a sequence diagram showing a startup process of the reservation application when the reservation application is an HTML application. In this case, an HTML (Hyper Text Markup Language) application refers to, for example, an application which is described in a script language such as HTML and JavaScript that is executable by a browser and which is downloaded by the reservation terminal 200 from the reservation server 100 upon each startup of the application.

First, the reservation terminal 200 starts up the reservation application (S4101). The triggers for the startup of the reservation application are the same as in S4001. Next, the reservation terminal 200 transmits an acquisition request for the reservation application to the reservation server 100 (S4102). Subsequently, the reservation server 100 transmits the reservation application to the reservation terminal 200 (S4103). Next, the reservation terminal 200 displays a screen of the reservation application (S4104). Details of the display at this point are the same as in S4003.

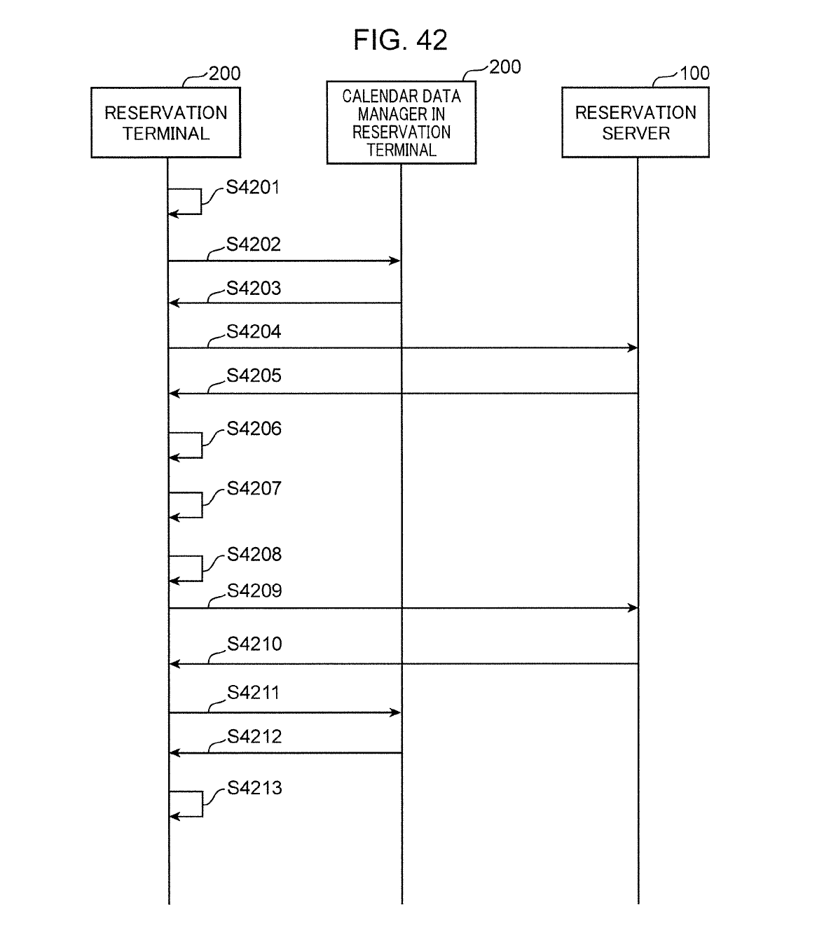

FIG. 42 is a sequence diagram of a process sequence S1-1 that is an overall process sequence of a first example of the reservation system according to the present disclosure. In this case, in the process sequence S1-1, the calendar data manager 206 is included in the reservation terminal 200 and the reservation terminal 200 executes an extraction process of a candidate reservation date. In addition, “S1” in the process sequence S1-1 denotes that a configuration of the reservation system is any of those shown in FIGS. 5 to 9.

First, the reservation terminal 200 displays a screen of the reservation application on the display 209 (S4201). At this point, the reservation date selection screen 1900 is displayed on which no candidate reservation dates are shown.

Next, the reservation screen generator 201 of the reservation terminal 200 notifies an acquisition request for the calendar plan list 3500 to the calendar data manager 206 (S4202). Subsequently, the calendar data manager 206 notifies the calendar plan list 3500 to the reservation screen generator 201 (S4203).

Next, using the communicating portion 208, the reservation screen generator 201 of the reservation terminal 200 transmits an acquisition request for reservation available dates and times to the reservation server 100 (S4204). Subsequently, the reservation server 100 transmits reservation available dates and times to the reservation terminal 200 (S4205).

Next, the candidate reservation date selector 202 of the reservation terminal 200 executes an extraction process of a candidate reservation date using the calendar plan list 3500 and the reservation available dates and times (S4206). Subsequently, using an extraction result, the reservation screen generator 201 displays a candidate reservation date and time or a candidate reservation date in the calendar data display field 1904 (S4207). For example, when a mode is adopted in which a candidate reservation date is displayed, the candidate symbol 1906 is displayed in the box 1905 corresponding to the candidate reservation date on the reservation date selection screen 1900. Alternatively, when a mode is adopted in which a candidate reservation date and time is displayed, the candidate reservation time 2201 is displayed in the box 1905 corresponding to the candidate reservation date and time on the reservation date selection screen 1900. Moreover, when a mode is adopted in which a price is displayed together with a candidate reservation date and time or a candidate reservation date, a price is displayed in the box 1905 corresponding to the candidate reservation date and time or the candidate reservation date. In this case, the candidate reservation date selector 202 may acquire a price corresponding to the reservation available date and time in S4205 and display the price in the corresponding box 1905.

Next, the screen controller 204 of the reservation terminal 200 accepts an operation for selecting a candidate reservation date and time by the user (S4208). In this case, the user may input an operation for selecting a candidate reservation date and time on the reservation date selection screen 1900 and the reservation time selection screen 2400.

Subsequently, the reservation screen generator 201 transmits a reservation request to the reservation server 100 using the communicating portion 208 (S4209). The reservation request includes the candidate reservation date and time selected by the user and is transmitted when the reservation button 2606 is tapped on the reservation content confirmation screen 2600.

At this point, the reservation data manager 101 of the reservation server 100 registers the candidate reservation date and time indicated in the reservation request as a reservation date and time in the reservation available date list 3600 that is stored in the reservation data storage 102. In this case, an “reservation accepted” (not shown) field may be provided in the reservation available date list 3600 and the reservation data manager 101 may register a user ID of a user having made a reservation in the “reservation accepted” field of a reservation available date and time corresponding to the reservation date and time indicated by the reservation request. Accordingly, the reservation server 100 can manage the reservation date and time of a reservation made by the user.

Next, the reservation data manager 101 of the reservation server 100 transmits a reservation result that represents the accepted reservation date and time to the reservation terminal 200 using the communicating portion 105 (S4210).

Subsequently, the candidate reservation date selector 202 notifies a registration request for the reservation date and time represented by the transmitted reservation result to the calendar data manager 206 (S4211). Accordingly, the calendar data manager 206 registers the reservation date and time represented by the reservation result in the calendar plan list 3500 stored in the calendar data storage 207.

Next, the calendar data manager 206 notifies the calendar plan list 3500 in which the reservation date and time has been registered to the reservation screen generator 201 (S4212).

Subsequently, the reservation screen generator 201 generates the reservation completion screen 2700 using the notified calendar plan list 3500 and displays the reservation completion screen 2700 on the display 209 (S4213). In this case, as shown in FIG. 27 or 28, the reservation completion screen 2700 on which the reservation icon 2702 is displayed in the box 1905 corresponding to the reservation date and time is displayed on the display 209.

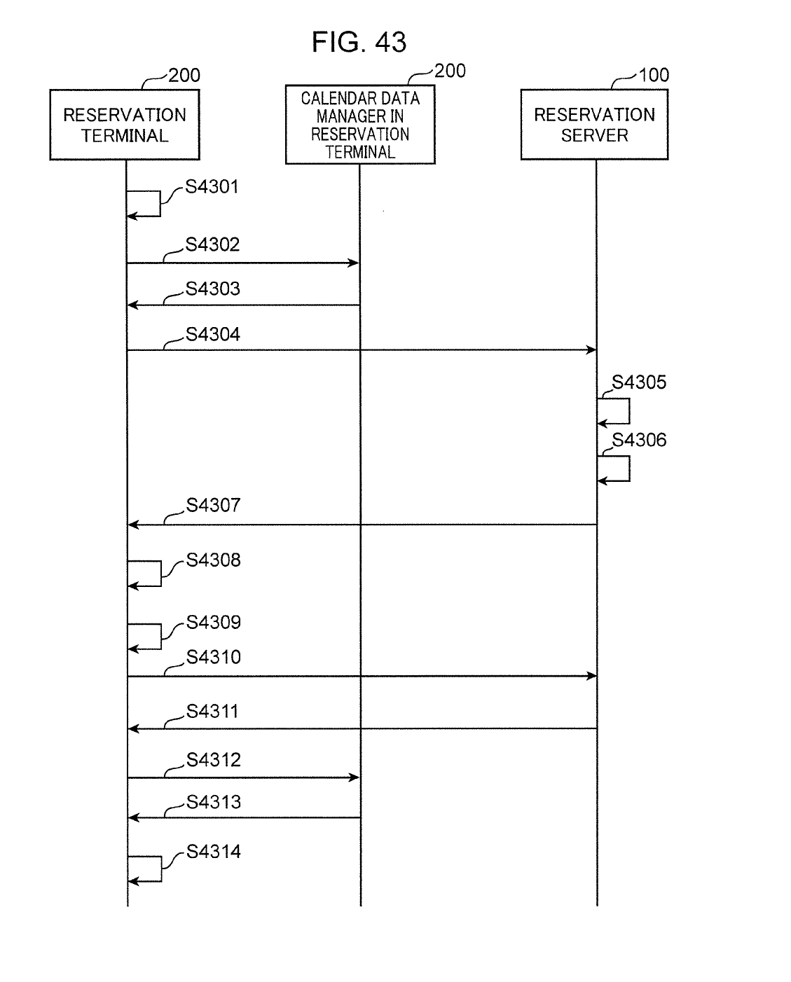

FIG. 43 is a sequence diagram of a process sequence S1-2 that is an overall process sequence of a second example of the reservation system according to the present disclosure. In this case, in the process sequence S1-2, the calendar data manager 206 is included in the reservation terminal 200 and the reservation server 100 executes an extraction process of a candidate reservation date.

S4301 to S4303 are the same as S4201 to S4203 in FIG. 42. In S4304, the reservation terminal 200 transmits an acquisition request for a candidate reservation date and time or a candidate reservation date to the reservation server 100 (S4304). In this case, the calendar plan list 3500 is included in the acquisition request. Accordingly, the reservation server 100 can acquire the calendar plan list 3500.

Next, the reservation data manager 101 of the reservation server 100 acquires reservation available dates and times from the reservation available date list 3600 stored in the reservation data storage 102 (S4305). Subsequently, the candidate reservation date selector 106 executes an extraction process of a candidate reservation date using the calendar plan list 3500 and the acquired reservation available dates and times (S4306). Details of the extraction process are the same as in S4206 in FIG. 42.

Next, the candidate reservation date selector 106 transmits an extraction result to the reservation terminal 200 using the communicating portion 105 (S4307). S4308 to S4314 are the same as S4207 to S4213 in FIG. 42.

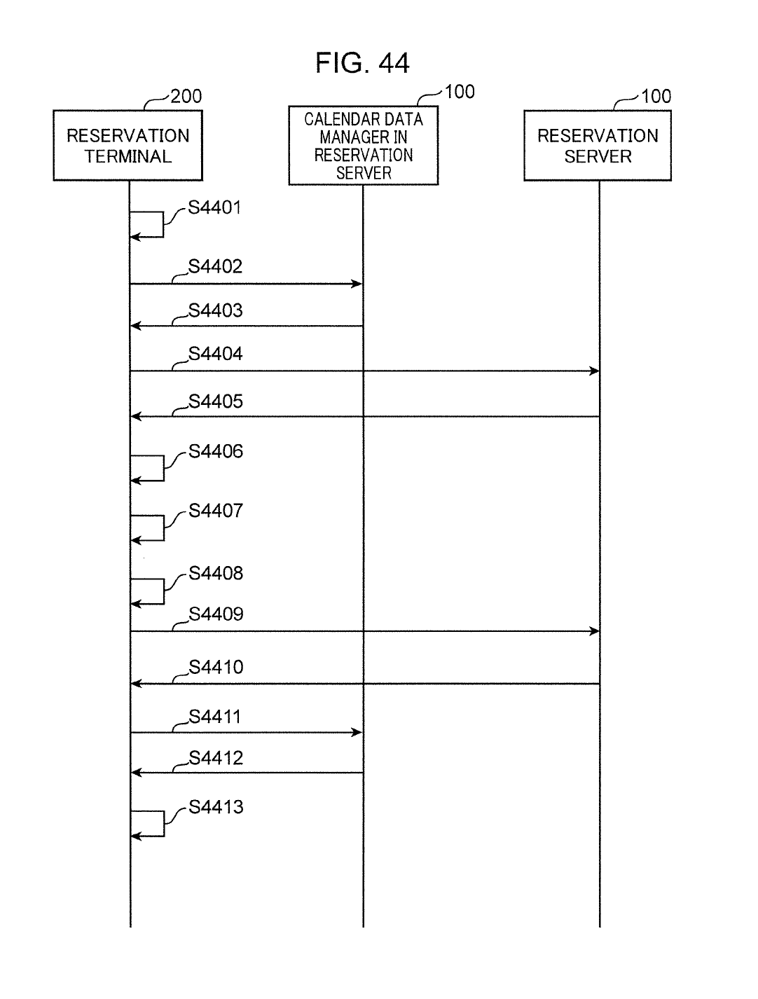

FIG. 44 is a sequence diagram of a process sequence S1-3 that is an overall process sequence of a third example of the reservation system according to the present disclosure. In this case, in the process sequence S1-3, the calendar data manager 107 is included in the reservation server 100 and the reservation terminal 200 executes an extraction process of a candidate reservation date.

S4401 is the same as S4201 in FIG. 42. Next, the reservation screen generator 201 of the reservation terminal 200 transmits an acquisition request for the calendar plan list 3500 to the reservation server 100 (S4402). Subsequently, the calendar data manager 107 of the reservation server 100 acquires the calendar plan list 3500 of the user who owns the reservation terminal 200 which had transmitted the acquisition request from the calendar data storage 108 and transmits the calendar plan list 3500 to the reservation terminal 200 (S4103).

S4404 to S4413 are the same as S4204 to S4213 in FIG. 42.

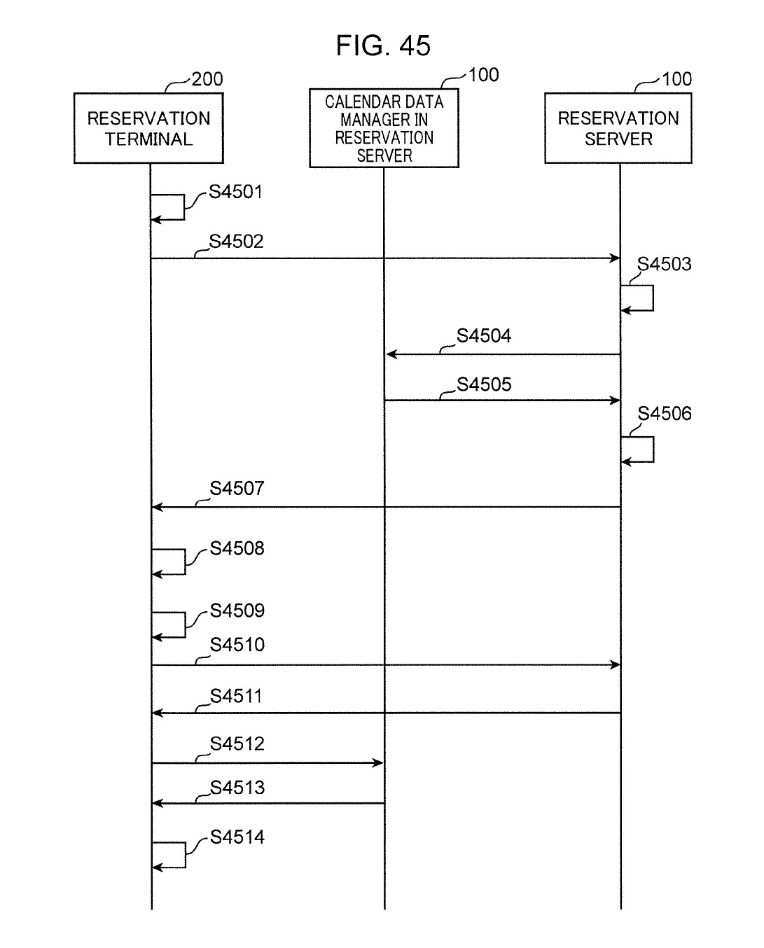

FIG. 45 is a sequence diagram of a process sequence S1-4 that is an overall process sequence of a fourth example of the reservation system according to the present disclosure. In this case, in the process sequence S1-4, the calendar data manager 107 is included in the reservation server 100 and the reservation server 100 executes an extraction process of a candidate reservation date.

S4501 is the same as S4201 in FIG. 42. Next, the reservation screen generator 201 of the reservation terminal 200 transmits an acquisition request for reservation available dates and times to the reservation server 100 (S4502).

Subsequently, the candidate reservation date selector 106 of the reservation server 100 acquires reservation available dates and times from the reservation available date list 3600 stored in the reservation data storage 102 (S4503). Next, the candidate reservation date selector 106 notifies an acquisition request for the calendar plan list 3500 of the user who owns the reservation terminal 200 which had transmitted the acquisition request to the calendar data manager 107 (S4504).

Subsequently, the calendar data manager 107 acquires the calendar plan list 3500 of the corresponding user and notifies the calendar plan list 3500 to the candidate reservation date selector 106 (S4505). S4506 to S4514 are the same as S4306 to S4314 in FIG. 43.

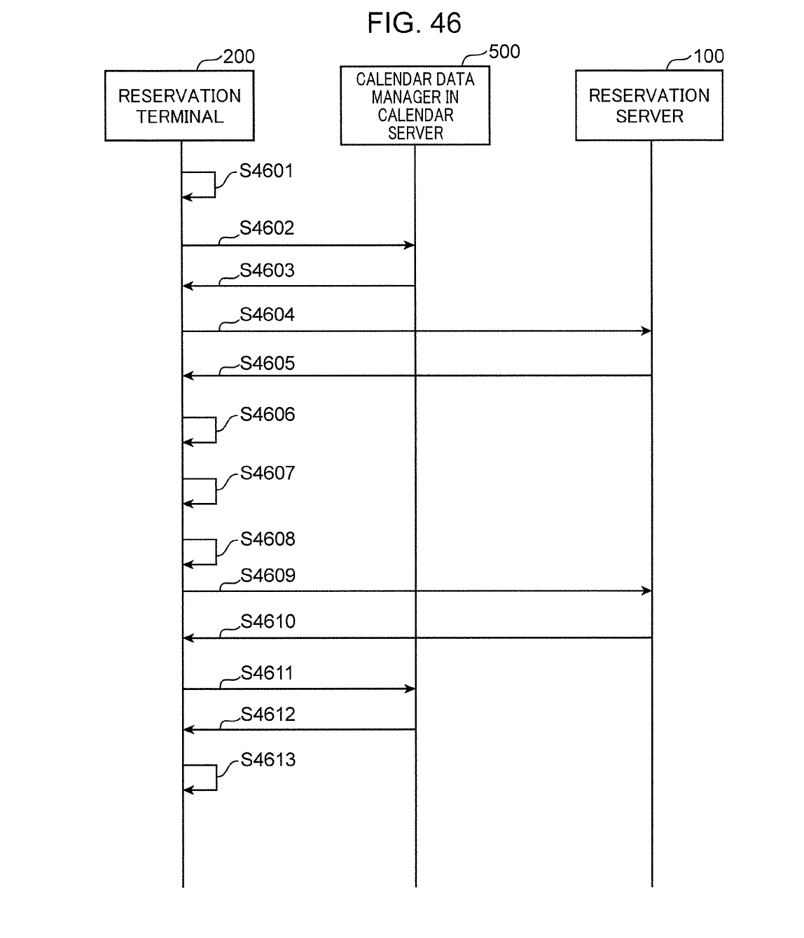

FIG. 46 is a sequence diagram of a process sequence S2-1 that is an overall process sequence of a fifth example of the reservation system according to the present disclosure. In this case, in the process sequence S2-1, the calendar data manager 502 is included in the calendar server 500 and the reservation terminal 200 executes an extraction process of a candidate reservation date. In addition, “S2” in the process sequence S2-1 denotes that a configuration of the reservation system is any of those shown in FIGS. 10 to 12.

S4601 is the same as S4201 in FIG. 42. Next, the reservation screen generator 201 of the reservation terminal 200 transmits an acquisition request for the calendar plan list 3500 to the calendar server 500 (S4602). Subsequently, the calendar data manager 502 of the calendar server 500 acquires the calendar plan list 3500 of the user who owns the reservation terminal 200 which had transmitted the acquisition request from the calendar data storage 108 and transmits the calendar plan list 3500 to the reservation terminal 200 (S4603). S4604 to S4613 are the same as S4404 to S4413 in FIG. 44.

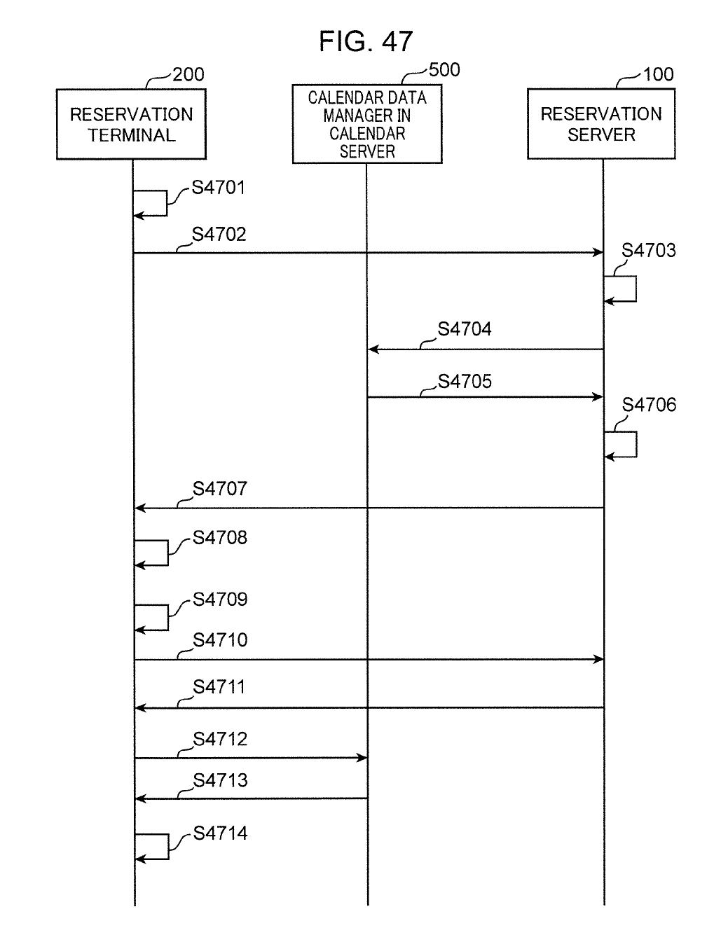

FIG. 47 is a sequence diagram of a process sequence S2-2 that is an overall process sequence of a sixth example of the reservation system according to the present disclosure. In this case, in the process sequence S2-2, the calendar data manager 502 is included in the calendar server 500 and the reservation server 100 executes an extraction process of a candidate reservation date.

S4701 is the same as S4201 in FIG. 42. S4702 and S4703 are the same as S4502 and S4503 in FIG. 45. Next, the candidate reservation date selector 106 notifies an acquisition request for the calendar plan list 3500 of the user who owns the reservation terminal 200 which had transmitted the acquisition request to the calendar server 500 (S4704).

Subsequently, the calendar data manager 502 of the calendar server 500 acquires the calendar plan list 3500 of the corresponding user from the calendar data storage 503 and notifies the calendar plan list 3500 to the reservation server 100 (S4705). S4706 to S4714 are the same as S4506 to S4514 in FIG. 45.

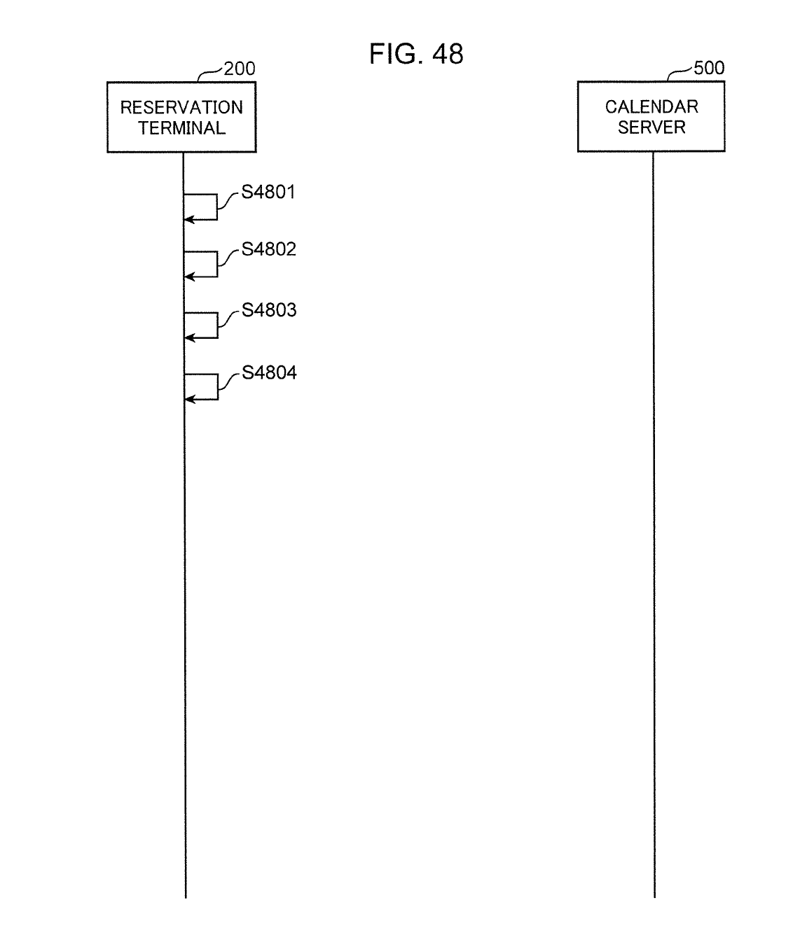

FIG. 48 is a sequence diagram showing a startup process of a calendar application when the calendar application is an embedded application. First, the reservation terminal 200 starts up the calendar application (S4801). In this case, the startup of the calendar application by the reservation terminal 200 is triggered by an input of an operation for starting up the calendar application by the user.

Next, the reservation terminal 200 reads the calendar application from the local memory (S4802). In this case, the calendar application is read from the local memory by, for example, a processor of the reservation terminal 200.

Subsequently, the calendar screen generator 205 acquires the calendar plan list 3500 from the calendar data manager 206 (S4803).

Next, the calendar screen generator 205 displays a screen of the calendar application on the display 209 (S4804).

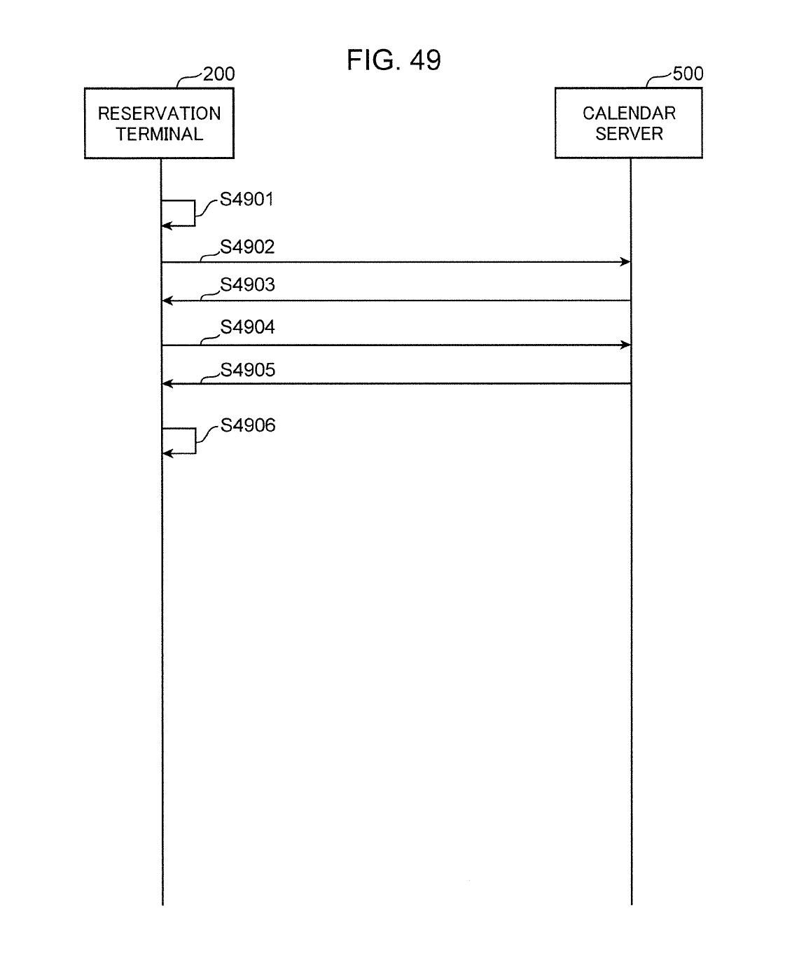

FIG. 49 is a sequence diagram showing a startup process of the calendar application when the calendar application is an HTML application.

First, the reservation terminal 200 starts up the calendar application (S4901). The trigger for the startup of the calendar application is the same as in S4801. Next, the reservation terminal 200 transmits an acquisition request for the calendar application to the calendar server 500 (S4902). Subsequently, the calendar server 500 transmits the calendar application to the reservation terminal 200 (S4903). Next, the calendar screen generator 205 of the reservation terminal 200 transmits an acquisition request for the calendar plan list 3500 of the user who owns the reservation terminal 200 to the calendar server 500 (S4904). Subsequently, the calendar server 500 transmits the calendar plan list 3500 of the corresponding user to the reservation terminal 200 (S4905). Next, the calendar screen generator 205 displays a screen of the calendar application using the transmitted calendar plan list 3500 (S4906).

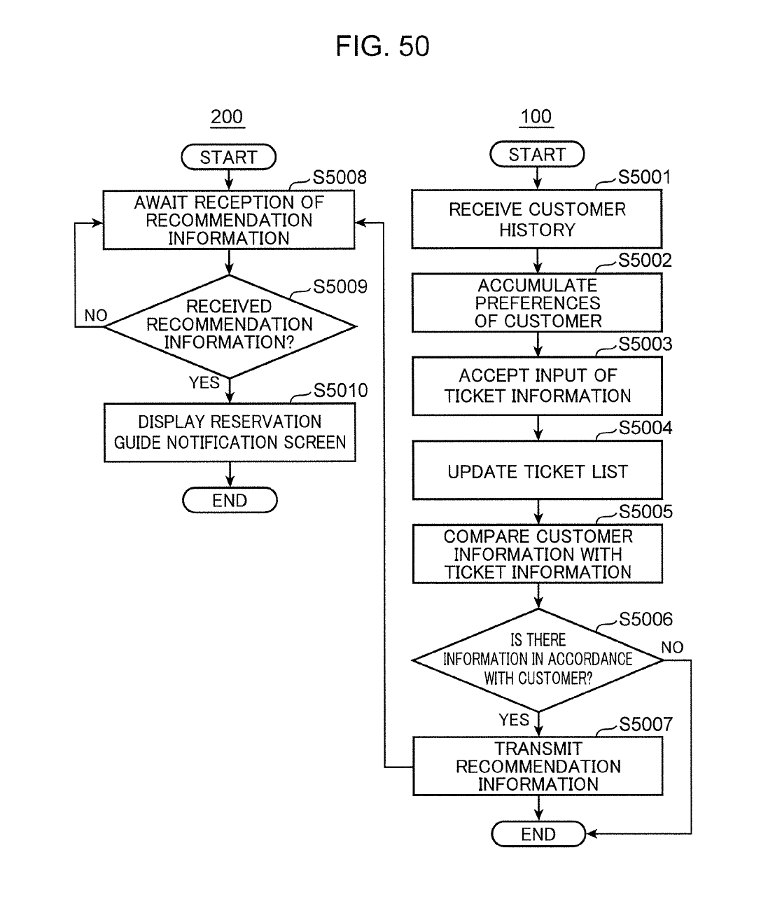

FIG. 50 is a flow chart showing a first example of an automatic startup process of the reservation application. In FIG. 50, the reservation server 100 manages the customer information 3200 (FIG. 32). The flow chart in FIG. 50 corresponds to the sequence diagram shown in FIG. 38.

First, the reservation server 100 receives the customer history 3100 (FIG. 31) from the reservation terminal 200 (S5001). Next, the reservation server 100 manages the customer information 3200 generated by accumulating preferences of a customer (S5002).

Subsequently, the reservation server 100 accepts an input of ticket information from an outside ticket issuing institution and registers the ticket information (S5003). Next, the reservation server 100 updates the ticket list 3300 (FIG. 33) by incorporating the accepted ticket information (S5004). Subsequently, the reservation server 100 compares the managed customer information 3200 and the ticket list 3300 with each other (S5005).

Next, the reservation server 100 determines whether or not there is information in accordance with the customer in the ticket list 3300 (S5006). When there is no information in accordance with the customer (NO in S5006), the process by the reservation server 100 is ended.

On the other hand, when there is information in accordance with the customer in S5006 (YES in S5006), the reservation server 100 generates the recommended ticket information 3400, transmits the generated recommended ticket information 3400 to the reservation terminal 200 of the corresponding user (S5007), and the process by the reservation server 100 is ended.

Meanwhile, the reservation terminal 200 is standing by to receive the recommended ticket information 3400 (S5008 and NO in S5009). Subsequently, when the recommended ticket information 3400 is received (YES in S5009), the reservation screen generator 201 displays the reservation guide notification screen 1700 on the display 209 (S5010) and the process by the reservation terminal 200 is ended.

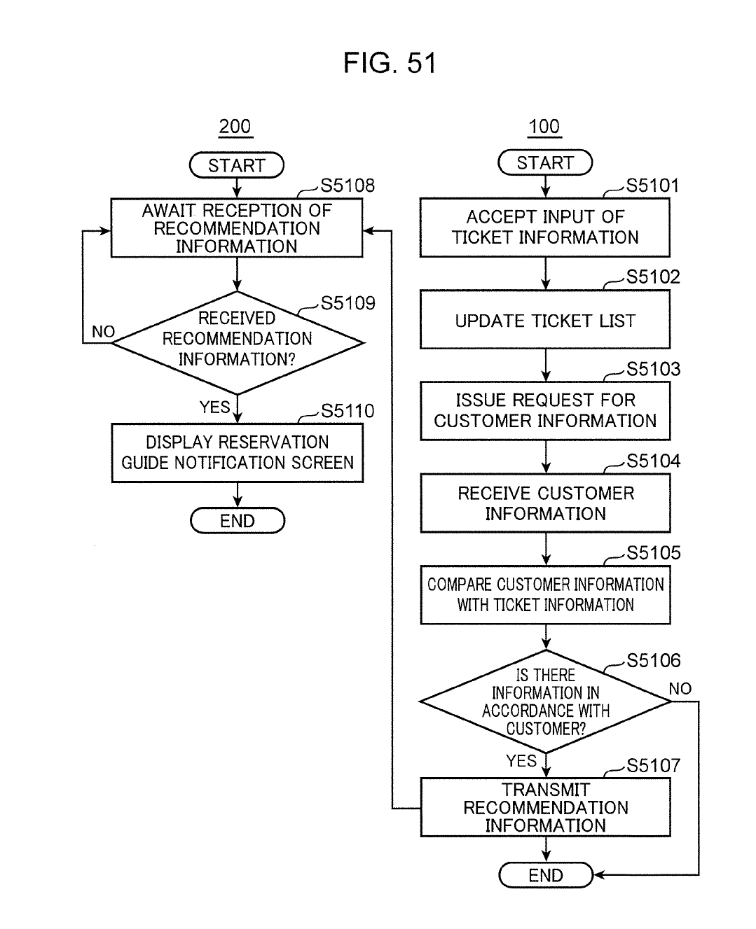

FIG. 51 is a flow chart showing a second example of the automatic startup process of the reservation application. In FIG. 51, the customer management server 400 manages the customer information 3200 (FIG. 32). The flow chart in FIG. 51 corresponds to the sequence diagram shown in FIG. 39.

S5101 and S5102 are the same as S5003 and S5004 in FIG. 50. Subsequent to S5102, the reservation server 100 transmits a request for the customer information 3200 (FIG. 32) to the customer management server 400 (S5103). Next, the reservation server 100 receives the customer information 3200 from the customer management server 400 (S5104).

S5105 to S5107 subsequent to S5104 are the same as S5005 to S5007 in FIG. 50. S5108 to S5110 performed by the reservation terminal 200 are the same as S5008 to S5010 in FIG. 50.

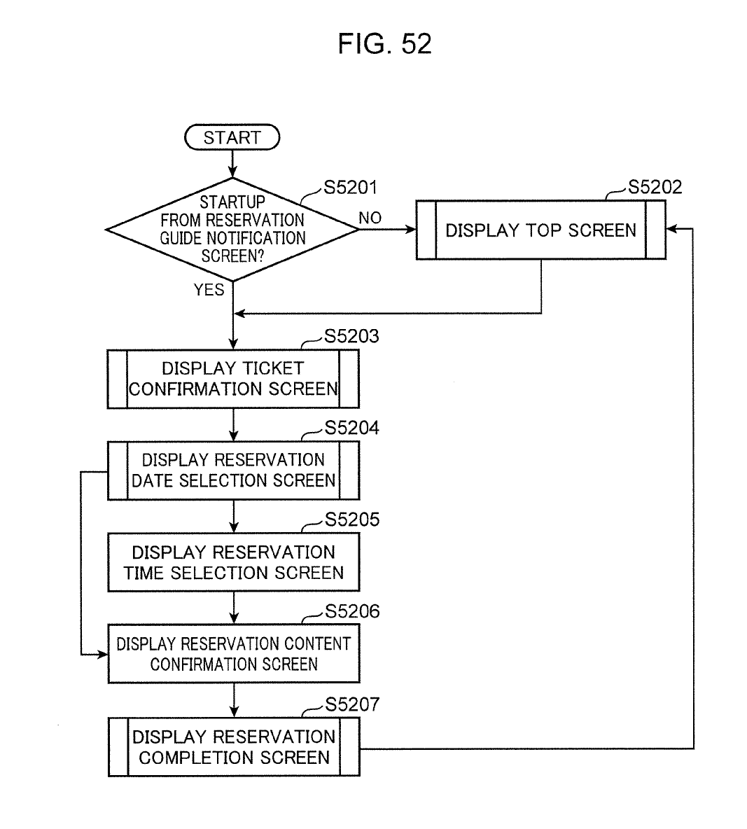

FIG. 52 is a flow chart showing an example of an overall process of the reservation application. First, in a case of a startup from the reservation guide notification screen 1700 (YES in S5201), the reservation screen generator 201 executes a display process of the ticket confirmation screen 1800 (S5203). On the ticket confirmation screen 1800, the reservation screen generator 201 advances the process to S5202 when the top button 1801 is tapped and advances the process to S5204 when the reservation button 1806 is tapped. Details of the display process of the ticket confirmation screen 1800 will be described later.

On the other hand, when the startup is not from the reservation guide notification screen 1700 (NO in S5201), the reservation screen generator 201 executes a display process of the top screen 1400 (S5202) and advances the process to S5203. Details of the display process of the top screen 1400 will be described later.

For example, when the reservation guide notification screen 1700 is tapped, the reservation screen generator 201 makes a determination of YES in S5201. In addition, when the reservation application icon 1301 is tapped on the basic screen 1300, the reservation screen generator 201 makes a determination of NO in S5201.

Next, the reservation screen generator 201 executes a display process of the reservation date selection screen 1900 (S5204). Details of the display process of the reservation date selection screen 1900 will be described later.

Subsequently, the reservation screen generator 201 displays the reservation time selection screen 2400 on the display 209 (S5205). When the reservation button 2405 is tapped on the reservation time selection screen 2400, the reservation screen generator 201 displays the reservation content confirmation screen 2600 on the display 209 (S5206). Next, the reservation screen generator 201 executes a display process of the reservation completion screen 2700 (S5207). When the top button 2701 is tapped on the reservation completion screen 2700, the reservation screen generator 201 advances the process to S5202. Details of the display process of the reservation completion screen 2700 will be described later.

Moreover, as described earlier, in the case of the reservation date selection screen 1900 according to the third example (FIG. 22), when the candidate reservation time 2201 is tapped, the reservation screen generator 201 may skip S5205 and advance the process to S5206.

Moreover, the reservation application may be ended at an arbitrary timing by an operation such as tapping a home button of the reservation terminal 200.

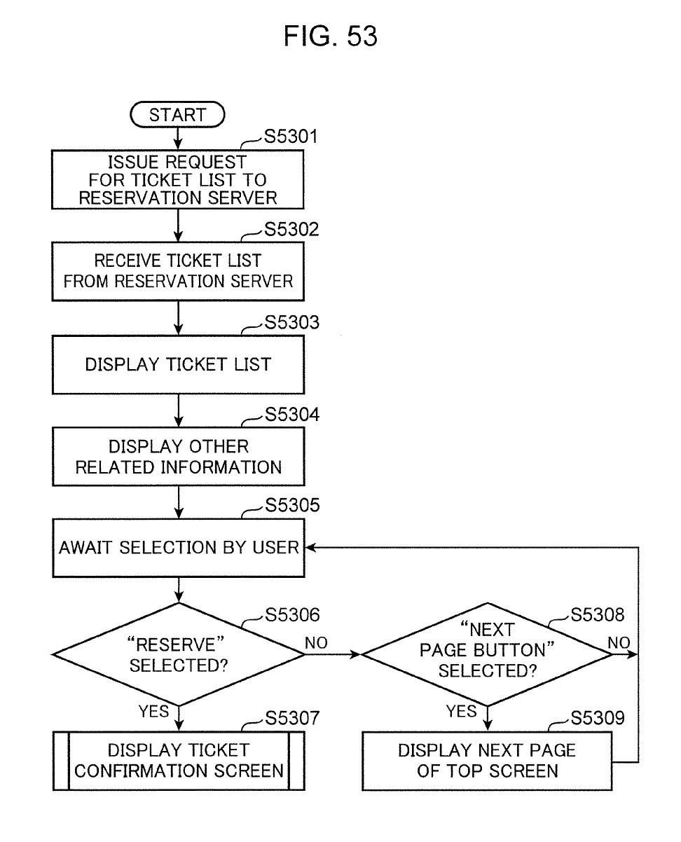

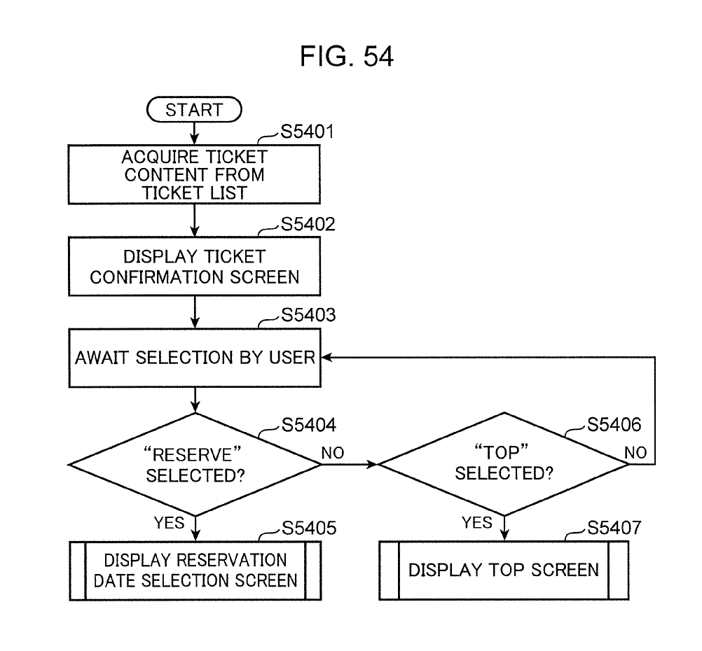

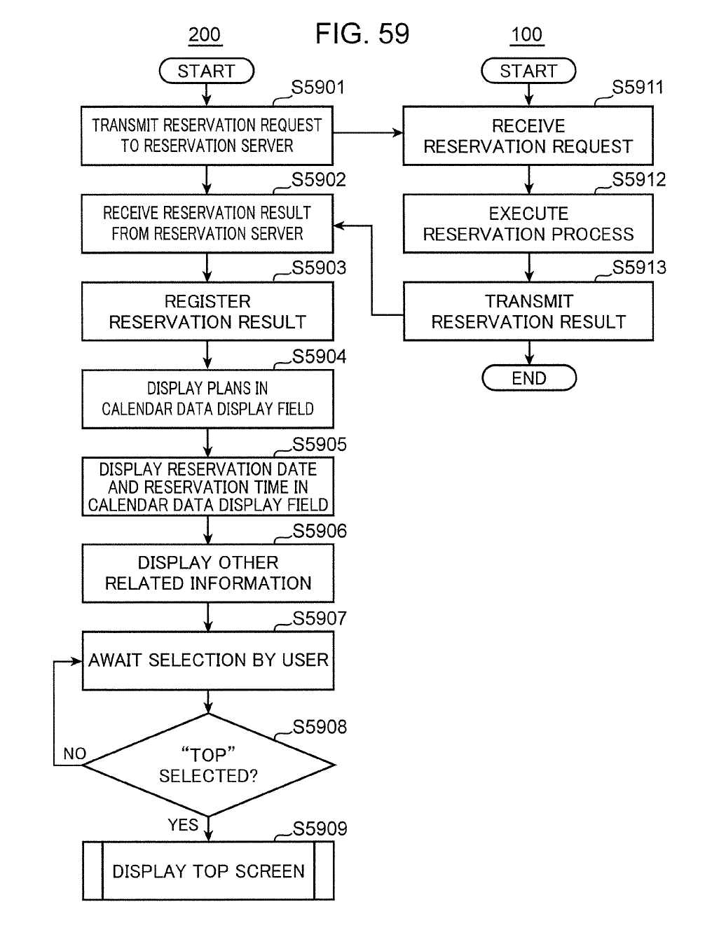

FIG. 53 is a flow chart showing details of the display process of the top screen 1400 (S5202 in FIG. 52, S5407 in FIG. 54 (to be described later), and S5909 in FIG. 59 (to be described later)).

First, the reservation terminal 200 transmits a request for the ticket list 3300 to the reservation server 100 (S5301). Next, the reservation terminal 200 receives the ticket list 3300 from the reservation server 100 (S5302).

Subsequently, the reservation screen generator 201 displays the top screen 1400 displaying a ticket list as shown in FIG. 14 on the display 209 (S5303). Accordingly, a list of tickets registered in the ticket list 3300 is displayed on the top screen 1400.

Next, the reservation screen generator 201 displays other related information on the top screen 1400 (S5304). In this case, examples of related information include screen components such as the reservation button 1402, the next page button 1403, and characters that form headings.

Consequently, the top screen 1400 shown in FIG. 14 is completed.

Next, the reservation screen generator 201 enters a standby state for a selection operation by the user (S5305). Subsequently, when the reservation button 1402 is tapped (YES in S5306), the reservation screen generator 201 executes a display process of the ticket confirmation screen 1800 (S5307).

Alternatively, when the next page button 1403 is tapped (selected) (NO in S5306 and YES in S5308), the reservation screen generator 201 displays the top screen 1400 of the next page on the display 209 (S5309) and returns the process to S5305. Moreover, when both S5306 and S5308 are NO or, in other words, when no operation is input by the user, the process is returned to S5305 and the standby state for a selection operation by the user is maintained.

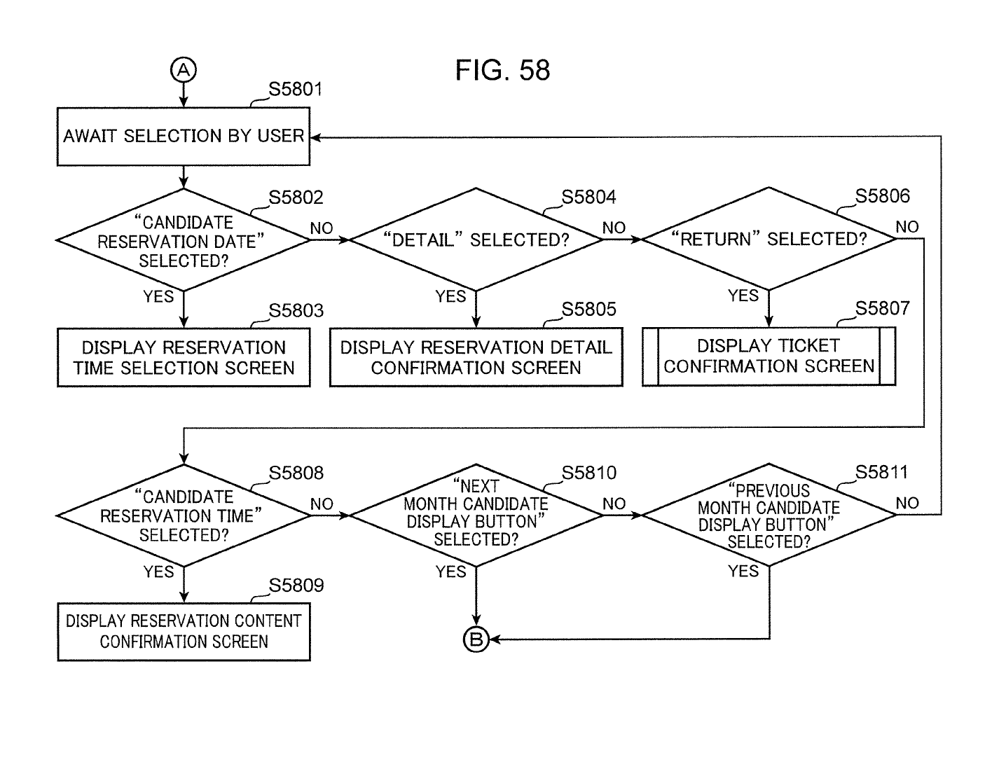

FIG. 54 is a flow chart showing an example of a display process of the ticket confirmation screen 1800 (S5203 in FIG. 52, S5307 in FIG. 53, and S5807 in FIG. 58 (to be described later)).

First, the reservation screen generator 201 acquires contents of a ticket of concern using the ticket list 3300 (S5401). At this point, in a case of a startup from the reservation guide notification screen 1700, a ticket indicated in the recommended ticket information 3400 corresponds to the ticket of concern, and in a case of a startup from the top screen 1400, a ticket selected by the user corresponds to the ticket of concern.

Next, the reservation screen generator 201 displays the ticket confirmation screen 1800 on the display 209 (S5402).

Subsequently, the reservation screen generator 201 enters a standby state for a selection operation by the user (S5403).

When the reservation button 1806 is tapped and “make reservation” is selected by the user (YES in S5404), the reservation screen generator 201 executes a display process of the reservation date selection screen 1900 (S5405).

In addition, when the top button 1801 is tapped and “top” is selected by the user (NO in S5404 and YES in S5406), the reservation screen generator 201 executes a display process of the top screen 1400 (S5407). Moreover, when both S5404 and S5406 are NO or, in other words, when no operation is input by the user, the process is returned to S5403 and the standby state for a selection operation by the user is maintained.

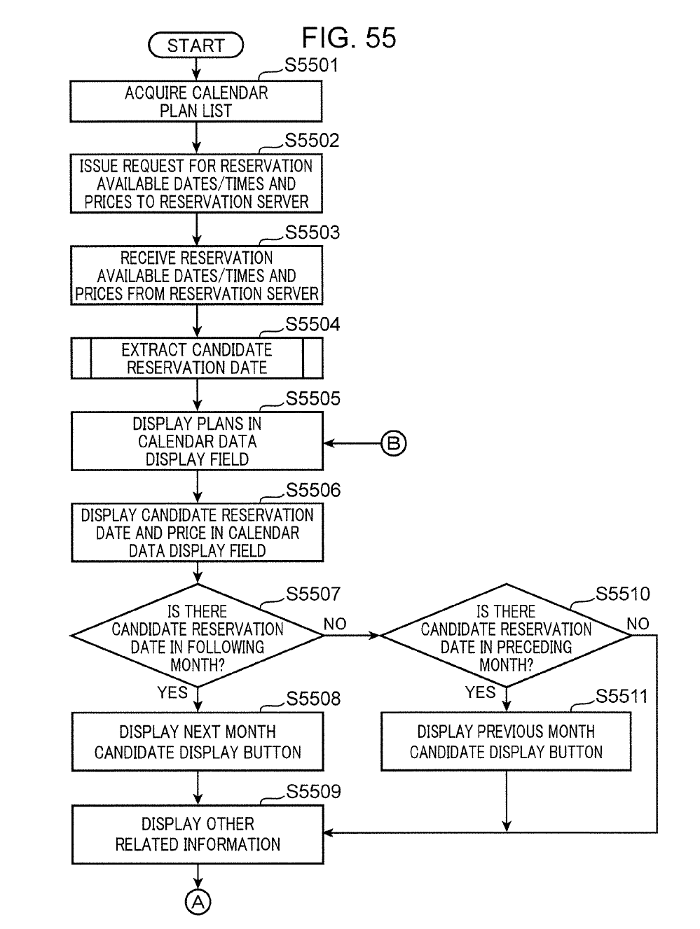

FIGS. 55 and 58 are flow charts showing a first example of a display process of the reservation date selection screen 1900 (S5204 in FIG. 52 and S5405 in FIG. 54). The flow charts correspond to the process sequences S1-1, S1-3, and S2-1 in which the reservation terminal 200 performs an extraction process of a candidate reservation date.

First, the reservation screen generator 201 of the reservation terminal 200 acquires the calendar plan list 3500 from the reservation server 100, the calendar server 500, or the reservation terminal 200 (S5501). In the process sequence S1-1, since the calendar plan list 3500 is managed by the reservation terminal 200, the reservation screen generator 201 may acquire the calendar plan list 3500 from the calendar data storage 207. In the process sequence S1-3, since the calendar plan list 3500 is managed by the reservation server 100, the reservation screen generator 201 may acquire the calendar plan list 3500 from the reservation server 100. In the process sequence S2-1, since the calendar plan list 3500 is managed by the calendar server 500, the reservation screen generator 201 may acquire the calendar plan list 3500 from the calendar server 500.

Next, the reservation screen generator 201 transmits an acquisition request for reservation available dates and times and a price to the reservation server 100 (S5502). Subsequently, the reservation screen generator 201 receives reservation available dates and times and a price from the reservation server 100 (S5503). Next, the candidate reservation date selector 202 executes an extraction process of a candidate reservation date (S5504).

Subsequently, the reservation screen generator 201 displays plans of the user in the calendar data display field 1904 (S5505). In this case, the reservation screen generator 201 displays the schedule icon 1907 in the box 1905 corresponding to a reservation available date and time on which a plan of the user is registered in the calendar plan list 3500. At this point, the reservation screen generator 201 may describe the text that is registered in “plan contents” in the calendar plan list 3500 on the schedule icon 1907.

Next, using an extraction result of a candidate reservation date, the reservation screen generator 201 displays a candidate reservation date and a price for a ticket in the calendar data display field 1904 (S5506). In this case, the reservation screen generator 201 displays the candidate symbol 1906 or the candidate reservation time 2201 in the box 1905 corresponding to a reservation available date and time for which “candidate” is registered as the “candidate reservation” in the candidate reservation date list 3700 that is obtained by the extraction process. In addition, the reservation screen generator 201 displays a price in the corresponding box 1905 using a price calculated from the “price” registered in the candidate reservation date list 3700.

Subsequently, if there is a candidate reservation date in the month following the month of the reservation date selection screen 1900 that is currently being displayed (YES in S5507), the reservation screen generator 201 displays the next month candidate display button 2001 on the reservation date selection screen 1900 (S5508). On the other hand, if there is a candidate reservation date in the month preceding the month of the reservation date selection screen 1900 that is currently being displayed (NO in S5507 and YES in S5510), the reservation screen generator 201 displays the previous month candidate display button 2101 on the reservation date selection screen 1900 (S5511). If there are no candidate reservation dates in the previous month (NO in S5510), the process advances to S5509.

Next, the reservation screen generator 201 displays other related information on the reservation date selection screen 1900 (S5509) and advances the process to S5801 in FIG. 58. In this case, related information includes screen components such as the return button 1902, the detail button 1903, and headings.

In S5801 in FIG. 58, the reservation screen generator 201 enters a standby state for an input of a selection operation by the user (S5801). Next, when the box 1905 corresponding to a candidate reservation date is tapped and a “candidate reservation date” is selected by the user (YES in S5802), the reservation screen generator 201 displays the reservation time selection screen 2400 on the display 209 (S5803). Moreover, when the candidate reservation date is selected by the user by tapping the candidate reservation time 2201 in a case where the reservation date selection screen 1900 displaying the candidate reservation time 2201 is adopted, the reservation time selection screen 2400 is displayed on which a time slot that is indicated by the candidate reservation time 2201 is selected by default.

In addition, when the detail button 1903 is tapped and “detail” is selected by the user on the reservation date selection screen 1900 (NO in S5802 and YES in S5804), the reservation screen generator 201 displays the reservation detail confirmation screen 2900 on the display 209 (S5805).

Furthermore, when the return button 1902 is tapped and “return” is selected by the user on the reservation date selection screen 1900 (NO in S5804 and YES in S5806), the reservation screen generator 201 executes a display process (FIG. 54) of the ticket confirmation screen 1800 (S5807).

Next, when the candidate reservation time 2201 is tapped and “candidate reservation time” is selected by the user (NO in S5806 and YES in S5808), the reservation screen generator 201 displays the reservation content confirmation screen 2300 on the display 209 (S5809). S5809 is the same as S5206 in FIG. 52 and the process returns to FIG. 52. Moreover, when the reservation date selection screen 1900 displaying the candidate symbol 1906 is adopted, S5808 is omitted because the candidate reservation time 2201 is not displayed.

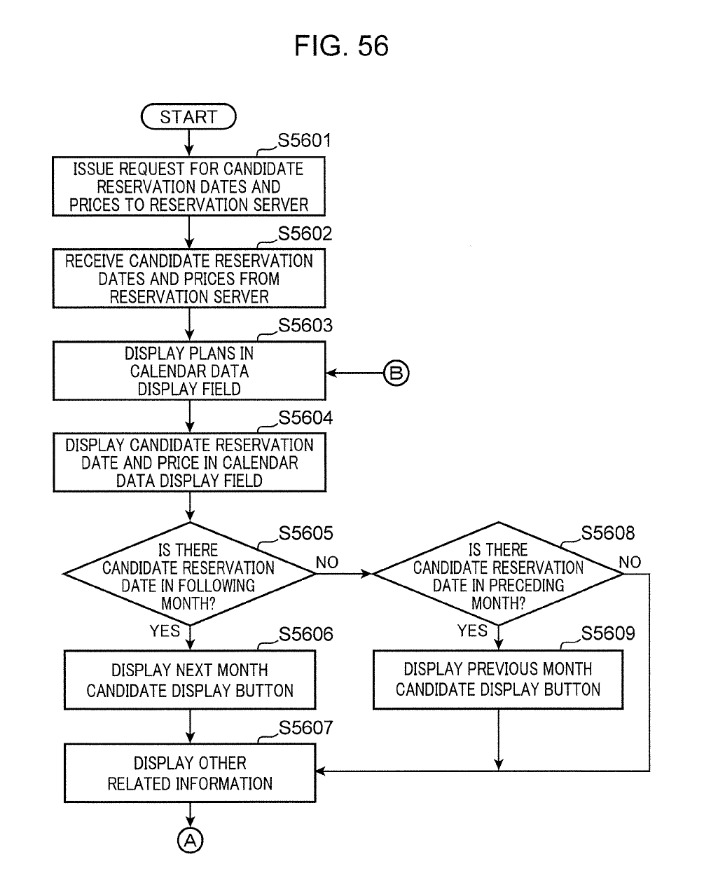

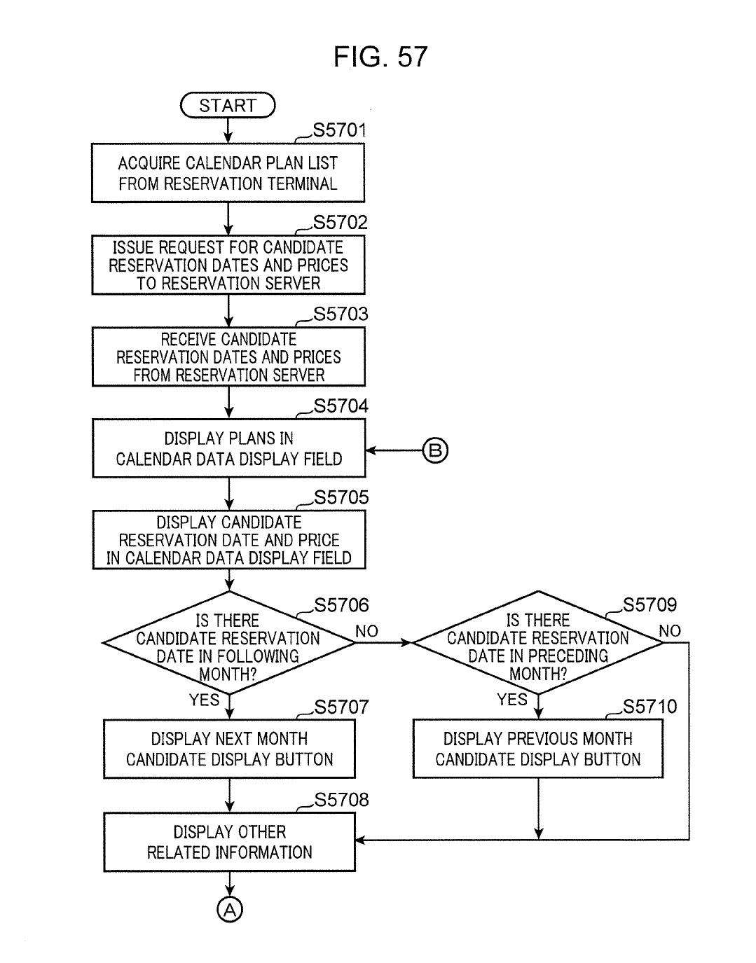

Subsequently, when the next month candidate display button 2001 is tapped (selected) (NO in S5808 and YES in S5810), the process advances to S5505 in FIG. 55, S5603 in FIG. 56 (to be described later), or S5704 in FIG. 57 (to be described later). In addition, when the previous month candidate display button 2101 is tapped (selected) (NO in S5810 and YES in S5811), the process advances to S5505 in FIG. 55, S5603 in FIG. 56 (to be described later), or S5704 in FIG. 57 (to be described later). On the other hand, when no operation is input by the user on the reservation date selection screen 1900 (NO in S5811), the process is returned to S5801 and the standby state for a selection operation by the user is maintained.

FIG. 56 is a flow chart showing a second example of the display process of the reservation date selection screen 1900 (S5204 in FIG. 52 and S5405 in FIG. 54). This flow chart corresponds to the process sequences S1-4 and S2-2 in which the reservation server 100 performs an extraction process of a candidate reservation date.

In FIG. 56, acquisition of the calendar plan list 3500 is performed by the reservation server 100 and an extraction process of a candidate reservation date is also performed by the reservation server 100.

To this end, the reservation terminal 200 first transmits a request for a candidate reservation date and a price to the reservation server 100 (S5601). Subsequently, the reservation terminal 200 receives a candidate reservation date and a price from the reservation server 100 (S5602). Subsequent processes S5603 to S5609 are the same as S5505 to S5511 in FIG. 55.

FIG. 57 is a flow chart showing a third example of the display process of the reservation date selection screen 1900 (S5204 in FIG. 52 and S5405 in FIG. 54). This flow chart corresponds to the process sequence S1-2 in which the reservation server 100 performs an extraction process of a candidate reservation date and the reservation terminal 200 manages the calendar plan list 3500.

First, the reservation screen generator 201 acquires the calendar plan list 3500 from the storage 203 (S5701). Subsequent processes S5702 to S5710 are the same as S5601 to S5609 in FIG. 56. However, in S5702, the reservation terminal 200 additionally transmits the calendar plan list 3500 acquired in S5701.

FIG. 59 is a flow chart showing a display process of the reservation completion screen 2700 (S5207 in FIG. 52). First, the reservation terminal 200 transmits a reservation request to the reservation server 100 (S5901). In this case, the reservation terminal 200 transmits the reservation request when the reservation button 2606 is tapped on the reservation content confirmation screen 2600. The reservation request includes, for example, a user ID, contents of a ticket that is a reservation object, and candidate reservation dates and times.

Next, the reservation server 100 receives the reservation request (S5911). Subsequently, the reservation server 100 executes a reservation process (S5912). At this point, the reservation server 100 may register information such as candidate reservation dates that are included in the reservation request in association with, for example, corresponding reservation available dates and times that are registered in the reservation available date list 3600. Accordingly, the candidate reservation dates and times specified in the reservation request are registered as reservation dates and times in the reservation server 100.

Subsequently, the reservation server 100 transmits a reservation result to the reservation terminal 200 (S5913). In this case, the reservation result includes information such as contents of the ticket that is a reservation object and reservation dates and times.

Next, the reservation terminal 200 receives the reservation result from the reservation server 100 (S5902). Subsequently, the reservation terminal 200 registers the reservation result in the calendar plan list 3500 (S5903).

In this case, when the reservation system adopts the process sequences S1-1 and S1-2, the reservation terminal 200 registers the reservation result in the calendar plan list 3500 that is managed by the reservation terminal 200. In addition, when the reservation system adopts the process sequences S1-3 and S1-4, the reservation terminal 200 transmits the reservation result to the reservation server 100 and causes the reservation result to be registered in the calendar plan list 3500 that is managed by the reservation server 100. Furthermore, when the reservation system adopts the process sequences S2-1 and S2-2, the reservation terminal 200 transmits the reservation result to the calendar server 500 and causes the reservation result to be registered in the calendar plan list 3500 that is managed by the calendar server 500.

Next, the reservation terminal 200 displays the schedule icon 1907 representing a plan of the user in the calendar data display field 1904 on the reservation completion screen 2700 (S5904).

Subsequently, the reservation terminal 200 displays a reservation date and time in the calendar data display field 1904 on the reservation completion screen 2700 (S5905).

Next, the reservation terminal 200 displays other related information on the reservation completion screen 2700 (S5906).

Subsequently, the reservation terminal 200 enters a standby state for a selection operation by the user on the reservation completion screen 2700 (S5907).

Next, when the top button 2701 is tapped and “top” is selected by the user (YES in S5908), the reservation terminal 200 executes the display process (FIG. 53) of the top screen 1400 (S5909).

On the other hand, when no operation is input by the user on the reservation completion screen 2700 (NO in S5908), the process is returned to S5907 and the standby state is maintained.

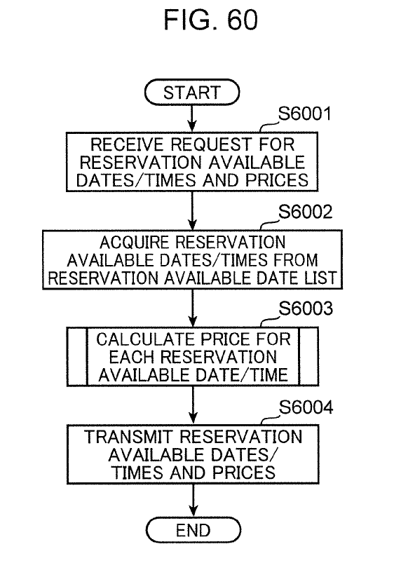

FIG. 60 is a flow chart showing a process of a first example of the reservation server 100. Moreover, this flow chart shows a process in a case where the reservation system adopts the process sequences S1-1, S1-3, and S2-1.

First, the reservation server 100 receives an acquisition request for reservation available dates and times and a price from the reservation terminal 200 (S6001). Subsequently, the reservation server 100 acquires reservation available dates and times from the reservation available date list 3600 (S6002). In this case, for example, the reservation server 100 may acquire reservation available dates and times in a month including the present day and a following month among the reservation available dates and times registered in the reservation available date list 3600.

Next, the reservation server 100 calculates a price for each of the acquired reservation available dates and times (S6003). Subsequently, the reservation server 100 transmits the reservation available dates and times and the prices to the reservation terminal 200 (S6004).

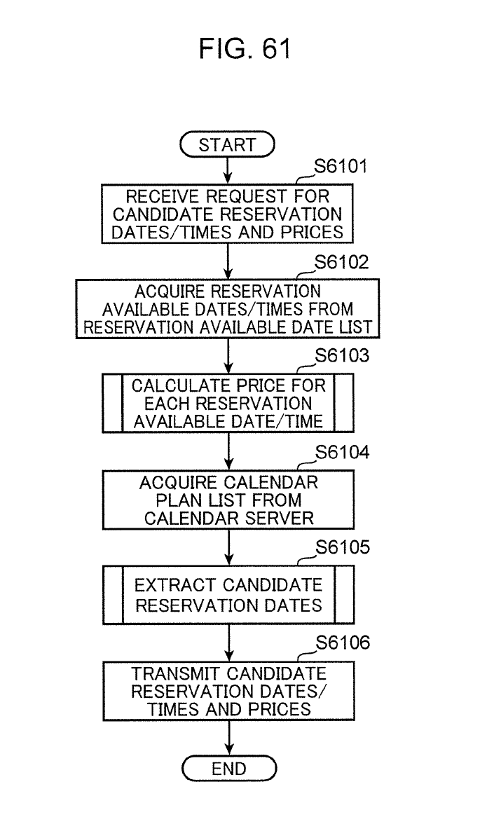

FIG. 61 is a flow chart showing a process of a second example of the reservation server 100. Moreover, this flow chart shows a process in a case where the reservation system adopts the process sequences S1-4 and S2-2. S6101 to S6103 are the same as S6001 to S6003 in FIG. 60.

In this flow chart, the calendar plan list 3500 is managed by the calendar server 500. Therefore, in S6104, the calendar plan list 3500 is acquired from the calendar server 500. In addition, in the flow chart, an extraction process of candidate reservation dates and times is performed by the reservation server 100. Therefore, in S6105, the reservation server 100 performs the extraction process of candidate reservation dates and times. Subsequently, the reservation server 100 transmits the extracted reservation available dates and times and prices to the reservation terminal 200 (S6106).

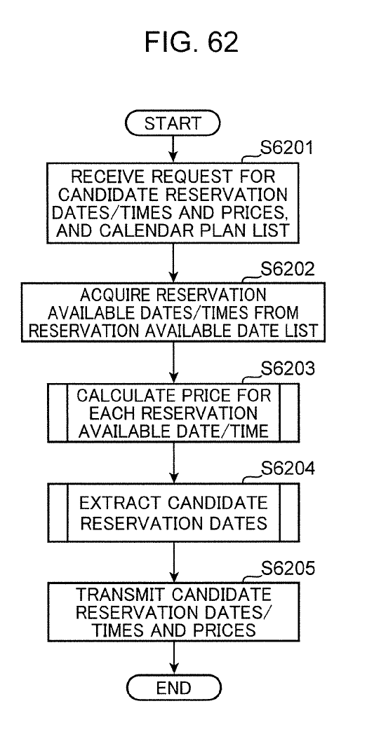

FIG. 62 is a flow chart showing a process of a third example of the reservation server 100. Moreover, this flow chart shows a process in a case where the reservation system adopts the process sequence S1-2.

In this flow chart, the calendar plan list 3500 is managed by the reservation terminal 200. Therefore, in S6201, the reservation server 100 receives the calendar plan list 3500 in addition to an acquisition request for candidate reservation dates and times and prices.

Subsequent processes S6202, S6203, S6204, and S6205 are the same as S6102, S6103, S6105, and S6106 in FIG. 61.

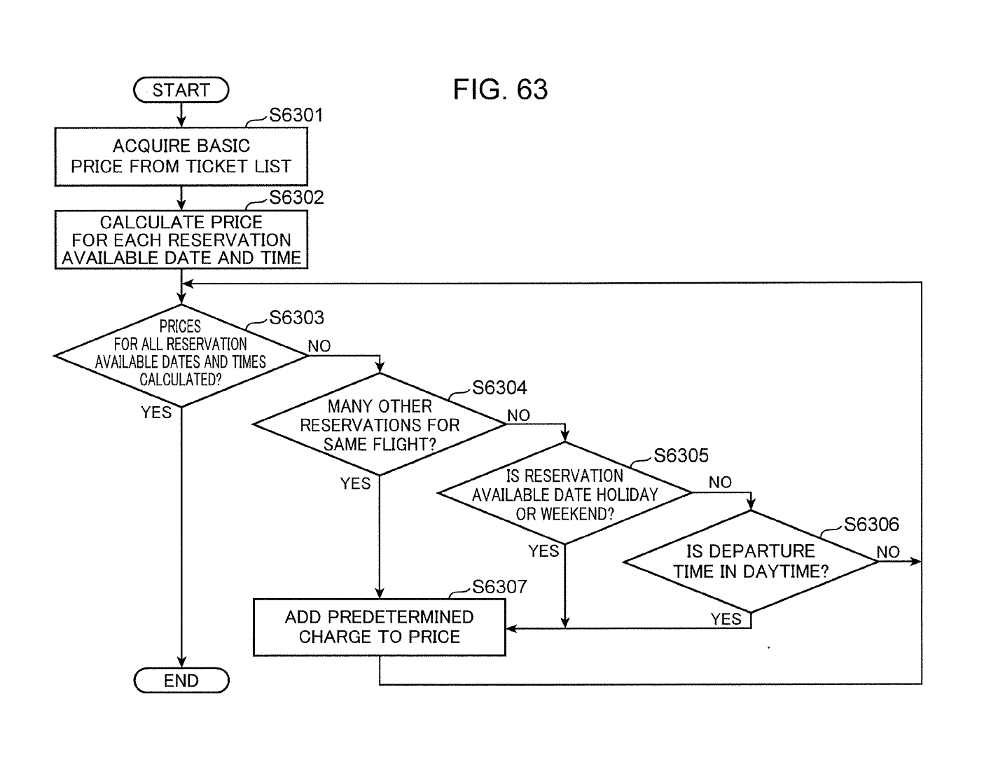

FIG. 63 is a flow chart showing an example of a process of calculating a price for each reservation available date and time (S6003 in FIG. 60, S6103 in FIG. 61, and S6203 in FIG. 62). First, the reservation server 100 acquires a basic price with respect to each ticket (in this case, an airline ticket is assumed) from the ticket list 3300 (S6301). Next, the reservation server 100 calculates a price for each acquired reservation available date and time using the acquired basic price (S6302). In this case, a basic price is calculated for each of the respective reservation available dates and times acquired in S6002 in FIG. 60, S6102 in FIG. 61, or S6202 in FIG. 62.

Next, when the calculation of prices with respect to all reservation available dates and times is completed (YES in S6303), the reservation server 100 ends the process. On the other hand, when the calculation of prices with respect to all reservation available dates and times is not completed (NO in S6303), the reservation server 100 determines whether or not there is a large number of reservations for the airline ticket (S6304). At this point, when the number of reservations for the airline ticket is not smaller than a specified value, the reservation server 100 may make a determination of YES in S6304, and when the number of reservations for the airline ticket is smaller than the specified value, the reservation server 100 may make a determination of NO in S6304. When a determination of YES is made in S6304, the process advances to S6307, and when a determination of NO is made in S6304, the process advances to S6305.

Subsequently, the reservation server 100 determines whether or not a reservation available date to which a reservation available date and time that is a price calculation object belongs corresponds to a holiday or a weekend (S6305). In this case, for example, a Sunday or a public holiday is adopted as the holiday. In addition, for example, a Saturday is adopted as the weekend.

The reservation server 100 makes a determination of YES in S6305 when the corresponding reservation available date is a holiday or a weekend and makes a determination of NO in S6305 when the corresponding reservation available date is not a holiday or a weekend. When a determination of YES is made in S6305, the process advances to S6307, and when a determination of NO is made in S6305, the process advances to S6306.

In S6306, a determination is made on whether the departure time of the ticket of concern is in the daytime (S6306). When the departure time is in the daytime (YES in S6306), the process is advanced to S6307, and when the departure time is not in the daytime (NO in

S6306), the process is returned to S6303. In addition, in S6303, a next reservation available date and time is decided as a price calculation object and subsequent processes are to be performed. In this case, for example, 10:00 to 15:00 corresponds to the daytime.

In S6307, the reservation server 100 adds a prescribed charge to the price calculated in S6302 with respect to the corresponding reservation available date and time and returns the process to S6303. In this case, for example, the reservation server 100 may add addition values respectively determined in advance for each of a case where YES is determined in S6304, a case where YES is determined in S6305, and a case where YES is determined in S6306 to the price calculated in S6302.

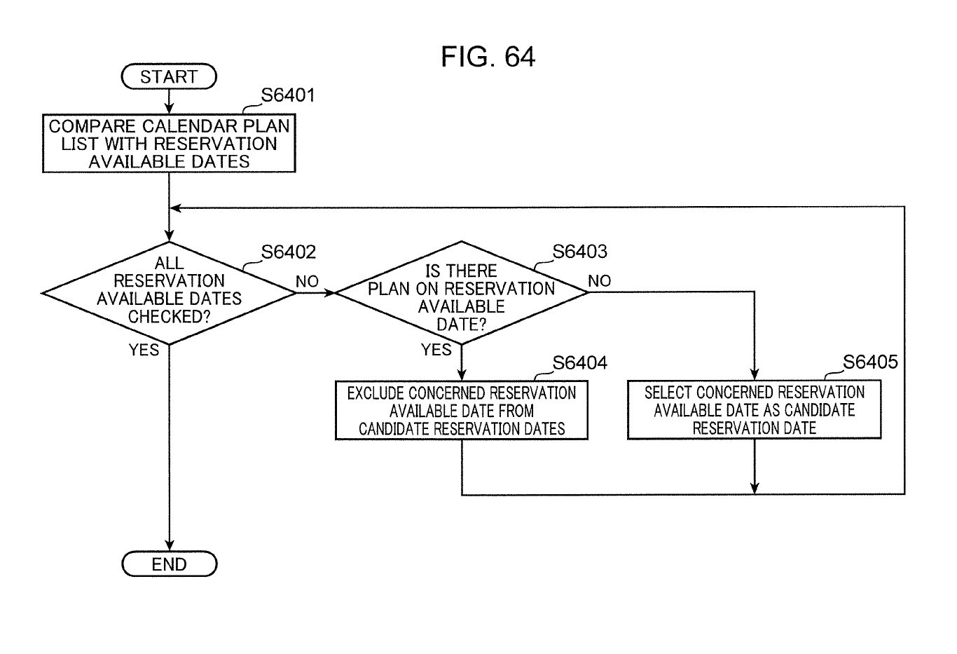

FIG. 64 is a flow chart showing a first example of an extraction process of a candidate reservation date by the reservation server 100 or the reservation terminal 200. A processing entity of the flow chart is the candidate reservation date selector 106 when the process is executed by the reservation server 100 and the candidate reservation date selector 202 when the process is executed by the reservation terminal 200.

First, the calendar plan list 3500 and reservation available dates are compared with each other (S6401). In this case, reservation available dates refer to the reservation available dates to which reservation available dates and times acquired in S5503 in FIG. 55, S6002 in FIG. 60, S6102 in FIG. 61, or S6202 in FIG. 62 belong.

When all reservation available dates are checked (YES in S6402), the process is ended, and when all reservation available dates are not checked (NO in S6402), the process advances to S6403.

In S6403, a determination is made on whether or not there is a plan of the user on a reservation available date. When there is a plan of the user (YES in S6403), the concerned reservation available date is excluded from candidate reservation dates (S6404) and the process is returned to S6402. In S6402, a next reservation available date is decided as a processing object.

When there are no plans of the user on the reservation available date (NO in S6403), the concerned reservation available date is selected as a candidate reservation date (S6405) and the process is returned to S6402.

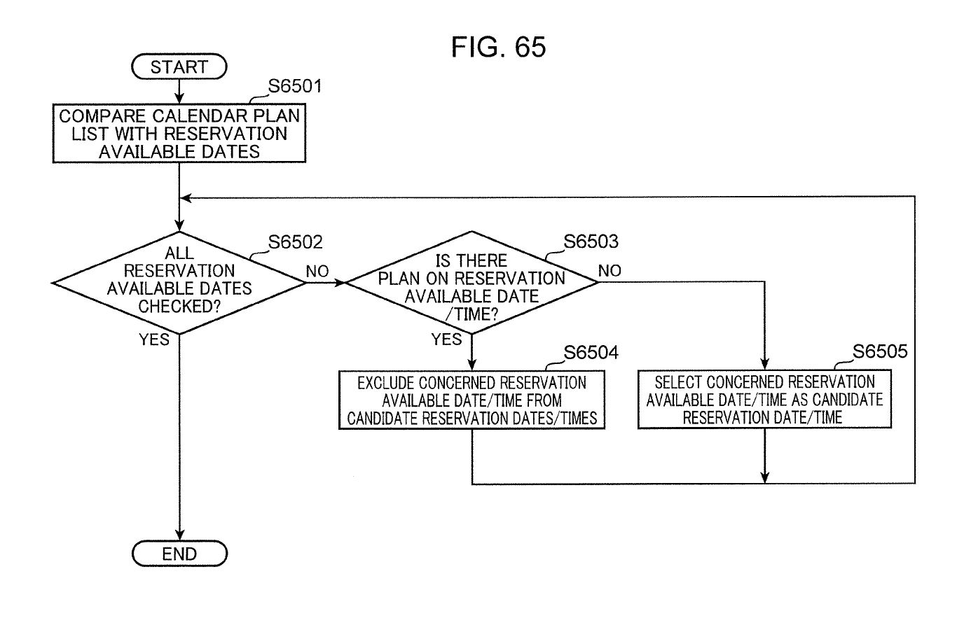

FIG. 65 is a flow chart showing a second example of the extraction process of a candidate reservation date by the reservation server 100 or the reservation terminal 200. S6501 and S6502 are the same as S6401 and S6402 in FIG. 64.

When a determination of NO is made in S6502, a determination is made on whether or not there is a plan of the user at a reservation available date and time belonging to a reservation available date (S6503). When there is a plan of the user at the reservation available date and time (YES in S6503), the concerned reservation available date and time is excluded from candidate reservation dates and times (S6504) and the process is returned to S6502. On the other hand, when there are no plans of the user on the reservation available date and time (NO in S6503), the concerned reservation available date and time is selected as a candidate reservation date and time (S6505) and the process is returned to S6502.

In other words, in S6503 to S6505, even when there is a plan of the user on a reservation available date, as long as a reservation available date and time does not overlap with a time slot of the plan of the user, the reservation available date and time is extracted as a candidate reservation date and time.

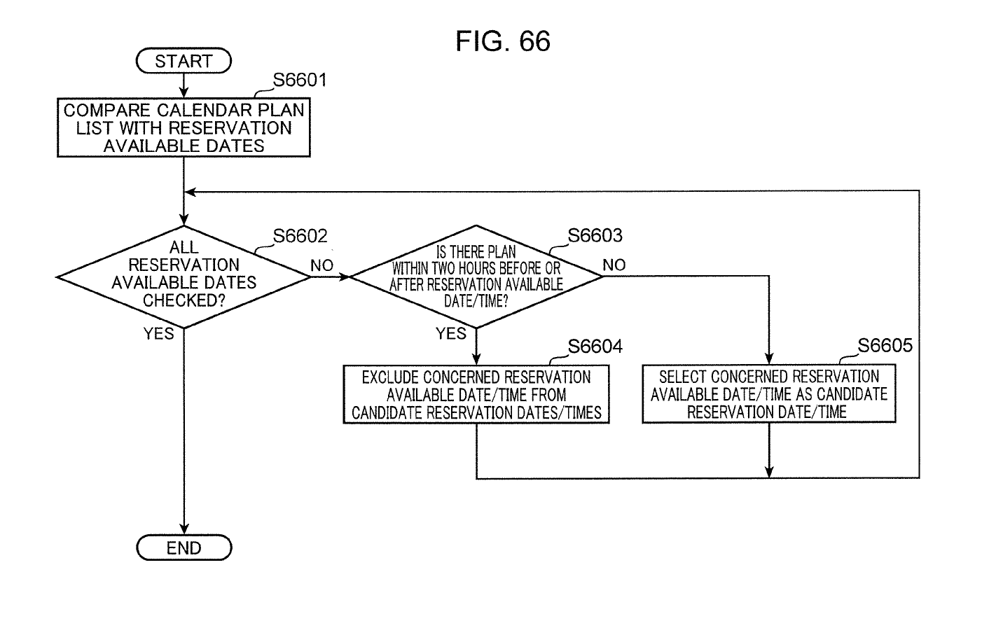

FIG. 66 is a flow chart showing a third example of the extraction process of a candidate reservation date by the reservation server 100 or the reservation terminal 200. S6601, S6602, S6604, and S6605 are the same as S6501, S6502, S6504, and S6505 in FIG. 65.

When a determination of NO is made in S6602, a determination is made on whether or not there is a plan of the user within two hours before or after a reservation available date and time (S6603). When there is a plan of the user within two hours before or after a reservation available date and time (YES in S6603), the process advances to S6604. On the other hand, when there are no plans of the user within two hours before or after a reservation available date and time (NO in S6603), the process advances to S6605.

In other words, in S6603, a margin is provided in the plans of the user to select a candidate reservation date and time. In this case, for example, assuming that a start time of a reservation available date and time is 13:00 and an end time thereof is 19:00, the two hours from 11:00 to 13:00 and the two hours from 19:00 to 21:00 correspond to the two hours before or after the reservation available date and time.

While two preceding or subsequent hours have been adopted in this case, alternatively, a value set in advance by the reservation system may be adopted or a preferred value set by the user may be adopted.

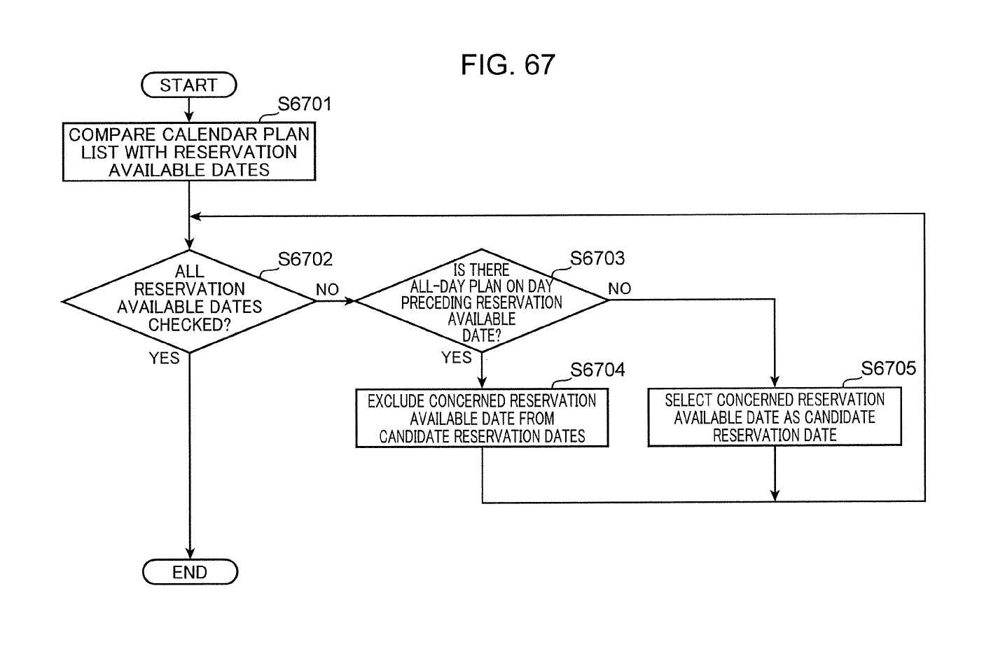

FIG. 67 is a flow chart showing a fourth example of the extraction process of a candidate reservation date by the reservation server 100 or the reservation terminal 200. S6701, S6702, S6704, and S6705 are the same as S6401, S6402, S6404, and S6405 in FIG. 64.

When a determination of NO is made in S6702, a determination is made on whether or not there is an all-day plan on the day preceding a reservation available date (S6703). When there is an all-day plan on the day preceding the reservation available date (YES in S6703), the process advances to S6704. On the other hand, where there is no all-day plan on the day preceding the reservation available date (NO in S6703), the process advances to S6705.

In this case, for example, a plan whose time slot is from 0:00 to 24:00 and which extends over a plurality of days such as a trip corresponds to an all-day plan. When there is an all-day plan on the previous day, the user may still pricel tired on the following day. It is unlikely that the user would select such a day as a reservation date. Therefore, in the fourth example, such dates that are unlikely to be selected as a reservation date by the user are excluded from candidate reservation dates.

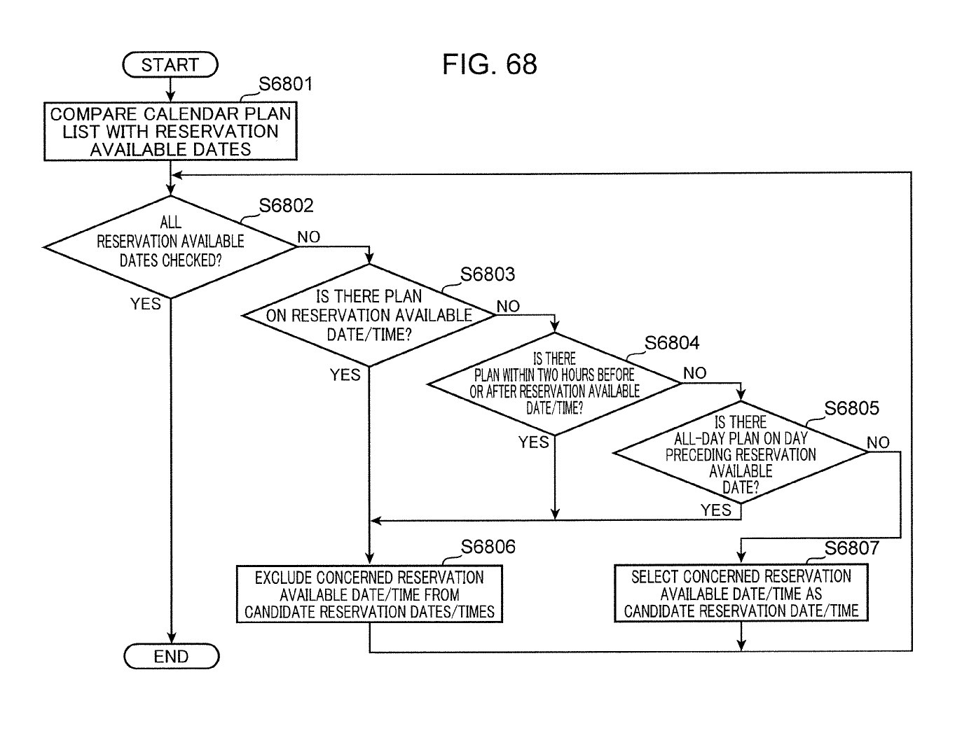

FIG. 68 is a flow chart showing a fifth example of the extraction process of a candidate reservation date by the reservation server 100 or the reservation terminal 200. S6801 to S6803, S6806, and S6807 are the same as S6501 to S6503, S6504, and S6505 in FIG. 65. S6804 is the same as S6603 in FIG. 66. S6805 is the same as S6703 in FIG. 67. Subsequently, when a determination of NO is made in S6803, the process advances to S6804. When a determination of YES is made in S6804, the process advances to S6806, and when a determination of NO is made in S6804, the process advances to S6805. When a determination of YES is made in S6805, the process advances to S6806, and when a determination of NO is made in S6805, the process advances to S6807. In other words, the fifth example combines the second to fourth examples.

Moreover, while the second to fourth examples are combined in FIG. 68, the present disclosure is not limited thereto. In the present disclosure, any combination may be adopted such as a combination of the second and third examples and a combination of the second and fourth examples.

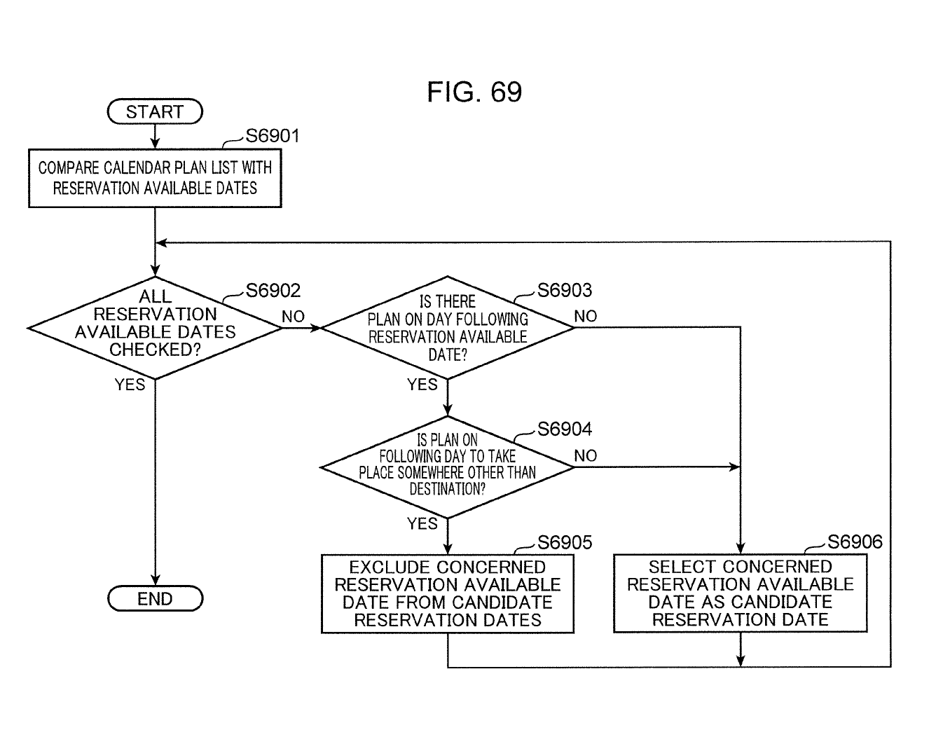

FIG. 69 is a flow chart showing a sixth example of the extraction process of a candidate reservation date by the reservation server 100 or the reservation terminal 200. S6901, S6902, S6905, and S6906 are the same as S6401, S6402, S6404, and S6405 in FIG. 64.

When a determination of NO is made in S6902, a determination is made on whether or not there is a plan on the day following a reservation available date (S6903). When there is a plan on the day following the reservation available date (YES in S6903), a determination is made on whether or not the plan on the following day is to take place somewhere other than the destination (S6904). When the plan on the following day is to take place somewhere other than the destination (YES in S6904), the process advances to S6905.

When there are no plans on the day following the reservation available date (NO in S6903) or when the plan on the following day is to take place at the destination (NO in S6904), the process advances to S6906.

As described above, in the sixth example, even when there is a plan on the day following the reservation available date, if the plan is to take place at the destination of the ticket, the reservation available date is not excluded from candidate reservation dates. For example, in the case of a ticket of an event such as a concert or a sports event, a city in which the event venue is located corresponds to the destination of the ticket. For example, in the case of an airline ticket, a city that is a travel destination corresponds to the destination of the ticket.

### INDUSTRIAL APPLICABILITY

The present disclosure is useful in a cloud system that manages plans of a user or manages reservation available dates of a ticket.

1. A method for controlling a communication device having a display and being used in an information management system, the information management system performing a reservation process of a ticket via a network connected to a ticket issuing institution of the ticket,
the communication device having a memory for storing schedule information of a user of the communication device,
the method causing a computer of the communication device to:
display display data on the display, the display data being generated using the stored schedule information with calendar data, the calendar data representing each day on a per month or per week basis;
access the information management system via the network to acquire available reservation dates and times of the ticket from the information management system when performing the reservation process of the ticket;
determine candidate reservation dates and times of the ticket by excluding each date and time, on which a plan of the user is stored in the memory, from the acquired available reservation dates and times of the ticket;
display each display representing each candidate reservation time based on the candidate reservation dates and times, in each region corresponding to each day represented in the calendar data, wherein when an interval between i) one acquired available reservation date and time of the ticket and ii) a date and time on which a plan of the user is stored in the memory is shorter than a predetermined value, the one acquired available reservation date and time is excluded from the determined candidate reservation dates and times of the ticket; and
display a reservation screen on the display when selection of one region is detected in the calendar data, the one region corresponding to one day in the calendar data and representing one candidate reservation time, the reservation screen being used for setting one candidate reservation date and time corresponding to the selected one region as a reservation date and time of the ticket.

2. The method according to claim 1, further causing the computer of the communication device to:
transmit a reservation request to the information management system via the network based on a result of a reservation made using the reservation screen, the reservation request indicating the one candidate reservation date and time corresponding to the selected one region; and
perform registration of the one candidate reservation date and time corresponding to the selected one region in the information management system, as the reservation date and time of the ticket.

3. The method according to claim 2, further causing the computer of the communication device to display the reservation date and time of the ticket within the one region in the calendar data, when the registration has been completed in the information management system.

4. The method according to claim 2, further causing the computer of the communication device to display on the display a message indicating completion of the registration, in association with the display of the calendar data.

5. The method according to claim 1, wherein
the information management system collects to manage customer information via the network, the customer information being associated with the user of the communication device, and
a notice is received from the information management system via the network when it is determined in the information management system based on the customer information that a ticket, which is in accordance with preferences of the user of the communication device, is present, wherein the notice indicates that the ticket is present.

6. The method according to claim 1, wherein the calendar data included in the display data represents each day of a concerned month,
the method further causing the computer of the communication device to:
in a case where the each display representing the each candidate reservation time of the ticket is included in respective displays of the concerned month and a following month, display a display notice in the display data which includes the calendar data representing each day of the concerned month, wherein the display notice indicates that each display representing each remaining candidate reservation time is to be displayed in each region corresponding to each day included in the display of the following month.

7. The method according to claim 1, wherein the calendar data included in the display data represents each day of a concerned week,
the method further causing the computer of the communication device to:
in a case where the each display representing the each candidate reservation time of the ticket is included in respective displays of the concerned week and a following week, display a display notice in the display data which includes the calendar data representing each day of the concerned week, wherein the display notice indicates that each display representing each remaining candidate reservation time is to be displayed in each region corresponding to each day included in the display of the following week.

8. The method according to claim 1, wherein
a region corresponding to a day, which includes a plan of the user in the calendar data, is displayed in a first display color, and
the each region corresponding to the each day, which includes the each display representing the each candidate reservation time of the ticket in the calendar data, is displayed in a second display color different from the first display color.

9. The method according to claim 1, wherein
a price of the ticket is displayed, when the each display representing the each candidate reservation time of the ticket is displayed in the each region corresponding to the each day represented in the calendar data.

10. The method according to claim 1, further causing the computer of the communication device to:
in a case where a region corresponding to a given day represented in the calendar data does not have an enough area to display all of displays which represent a plurality of candidate reservation times corresponding to the given day, display a display representing a candidate reservation date of the ticket in the region corresponding to the given day, without displaying all of the displays representing the plurality of the candidate reservation times corresponding to the given day in the region corresponding to the given day.

11. The method according to claim 1, wherein
the communication device is configured to be able to register the plan of the user in the each region corresponding to the each day represented in the calendar data.

12. A non-transitory computer-readable recording medium which stores a program to be executed in a communication device having a display and being used in an information management system, the information management system performing a reservation process of a ticket via a network connected to a ticket issuing institution of the ticket,
the communication device having a memory for storing schedule information of a user of the communication device,
the method causing a computer of the communication device to:
display display data on the display, the display data being generated using the stored schedule information with calendar data, the calendar data representing each day on a per month or per week basis;
access the information management system via the network to acquire available reservation dates and times of the ticket from the information management system when performing the reservation process of the ticket;
determine candidate reservation dates and times of the ticket by excluding each date and time, on which a plan of the user is stored in the memory, from the acquired available reservation dates and times of the ticket;
display each display representing each candidate reservation time based on the candidate reservation dates and times, in each region corresponding to each day represented in the calendar data, wherein when an interval between i) one acquired available reservation date and time of the ticket and ii) a date and time on which a plan of the user is stored in the memory is shorter than a predetermined value, the one acquired available reservation date and time is excluded from the determined candidate reservation dates and times of the ticket; and
display a reservation screen on the display when selection of one region is detected in the calendar data, the one region corresponding to one day in the calendar data and representing one candidate reservation time, the reservation screen being used for setting one candidate reservation date and time corresponding to the selected one region as a reservation date and time of the ticket.

13. A method for providing information in an information management system which performs a reservation process of a ticket via a network connected to a ticket issuing institution of the ticket, the method comprising:
receiving, from a communication device of an authenticated user, an inquiry signal and schedule information of the user via the network, the inquiry signal being related to the reservation process of the ticket, the schedule information of the user being stored in a memory of the communication device;
acquiring first candidate data using a database in response to the inquiry signal, the database storing available reservation dates and times of the ticket, the first candidate data indicating the available reservation dates and times of the ticket;
determining, using the acquired first candidate data and the received schedule information, candidate reservation dates and times of the ticket by excluding each date and time, on which a plan of the user is included in the received schedule information, from the available reservation dates and times of the ticket indicated by the acquired first candidate data;
transmitting second candidate data indicating the determined candidate reservation dates and times to the communication device via the network, wherein the communication device displays each display representing each candidate reservation time based on the candidate reservation dates and times indicated by the second candidate data, within each region corresponding to each day represented in calendar data that is generated using the schedule information at the communication device, wherein when an interval between i) one acquired available reservation date and time of the ticket and ii) a date and time on which a plan of the user is stored in the memory is shorter than a predetermined value, the one acquired available reservation date and time is excluded from the determined candidate reservation dates and times of the ticket; and
when selection of one region in the calendar data is detected in the communication device, the one region corresponding to one day in the calendar data and representing one candidate reservation time, and when a reservation request, which indicates one candidate reservation date and time corresponding to the selected one region, is received from the communication device via the network, registering the one candidate reservation date and time indicated by the reservation request as a reservation date and time of the ticket in the information management system.

14. The method according to claim 13, wherein
the reservation date and time of the ticket is displayed at the communication device within the one region represented in the calendar data when the registration has been completed in the information management system.

15. The method according to claim 13, wherein the information management system collects to manage customer information via the network, the customer information being associated with the user of the communication device,
the method further comprising:
transmitting a notice to the communication device via the network, when it is determined based on the customer information that a ticket, which is in accordance with preferences of the user of the communication device, is present, wherein the notice indicates that the ticket is present.

16. A method for controlling a communication device having a display and being used in an information management system, the information management system performing a reservation process of a ticket via a network connected to a ticket issuing institution of the ticket,
the information management system managing schedule information of a user of the communication device,
the method causing a computer of the communication device to:
access the information management system via the network to acquire i) schedule information of the user of the communication device and ii) available reservation dates and times of the ticket from the information management system when performing the reservation process of the ticket;
display display data on the display, the display data being generated using the acquired schedule information with calendar data, the calendar data representing each day on a per month or per week basis;
determine candidate reservation dates and times of the ticket by excluding each date and time, on which a plan of the user is acquired from the information management system, from the acquired available reservation dates and times of the ticket;
display each display representing each candidate reservation time based on the determined candidate reservation dates and times, in each region corresponding to each day represented in the calendar data, wherein when an interval between i) one acquired available reservation date and time of the ticket and ii) a date and time on which a plan of the user is acquired from the information management system is shorter than a predetermined value, the one acquired available reservation date and time is excluded from the determined candidate reservation dates and times of the ticket; and
display a reservation screen on the display when selection of one region is detected in the calendar data, the one region corresponding to one day in the calendar data and representing one candidate reservation time, the reservation screen being used for setting one candidate reservation date and time corresponding to the selected one region as a reservation date and time of the ticket.

17. The method according to claim 16, further causing the computer of the communication device to:
transmit a reservation request to the information management system via the network based on a result of a reservation made using the reservation screen, the reservation request indicating the one candidate reservation date and time corresponding to the selected one region; and
perform registration of the one candidate reservation date and time corresponding to the selected one region in the information management system, as the reservation date and time of the ticket.

18. The method according to claim 17, further causing the computer of the communication device to display the reservation date and time of the ticket within the one region in the calendar data, when the registration has been completed in the information management system.

19. The method according to claim 17, further causing the computer of the communication device to display on the display a message indicating completion of the registration, in association with the display of the calendar data.

20. The method according to claim 16, wherein
the information management system collects to manage customer information via the network, the customer information being associated with the user of the communication device, and
a notice is received from the information management system via the network when it is determined in the information management system based on the customer information that a ticket, which is in accordance with preferences of the user of the communication device, is present, wherein the notice indicates that the ticket is present.

21. The method according to claim 16, wherein
the communication device is configured to be able to register the plan of the user in the each region corresponding to the each day represented in the calendar data.

22. A non-transitory computer-readable recording medium which stores a program to be executed in a communication device having a display and being used in an information management system, the information management system performing a reservation process of a ticket via a network connected to a ticket issuing institution of the ticket,
the information management system managing schedule information of a user of the communication device,
the program causing a computer of the communication device to:
access the information management system via the network to acquire i) schedule information of the user of the communication device and ii) available reservation dates and times of the ticket from the information management system when performing the reservation process of the ticket;
display display data on the display, the display data being generated using the acquired schedule information with calendar data, the calendar data representing each day on a per month or per week basis;
determine candidate reservation dates and times of the ticket by excluding each date and time, on which a plan of the user is acquired from the information management system, from the acquired available reservation dates and times of the ticket;
display each display representing each candidate reservation time based on the determined candidate reservation dates and times, in each region corresponding to each day represented in the calendar data, wherein when an interval between i) one acquired available reservation date and time of the ticket and ii) a date and time on which a plan of the user is acquired from the information management system is shorter than a predetermined value, the one acquired available reservation date and time is excluded from the determined candidate reservation dates and times of the ticket; and
display a reservation screen on the display when selection of one region is detected in the calendar data, the one region corresponding to one day in the calendar data and representing one candidate reservation time, the reservation screen being used for setting one candidate reservation date and time corresponding to the selected one region as a reservation date and time of the ticket.

23. A method for providing information in an information management system which performs a reservation process of a ticket via a network connected to a ticket issuing institution of the ticket, the method comprising:
receiving an inquiry signal from a communication device of an authenticated user via the network, the inquiry signal being related to the reservation process of the ticket;
acquiring schedule information of the user of the communication device using a first database in response to the inquiry signal, the first database storing the schedule information of the user of the communication device;
acquiring first candidate data using a second database in response to the inquiry signal, the second database storing available reservation dates and times of the ticket, the first candidate data indicating the available reservation dates and times of the ticket;
determining, using the acquired schedule information and the acquired first candidate data, candidate reservation dates and times of the ticket by excluding each date and time, on which a plan of the user is included in the acquired schedule information, from the available reservation dates and times of the ticket indicated by the acquired first candidate data;
transmitting second candidate data indicating the determined candidate reservation dates and times to the communication device via the network, wherein the communication device displays each display representing each candidate reservation time based on the candidate reservation dates and times indicated by the second candidate data, within each region corresponding to each day represented in calendar data that is generated using the schedule information at the communication device, wherein when an interval between i) one acquired available reservation date and time of the ticket and ii) a date and time on which a plan of the user is included in the acquired schedule information is shorter than a predetermined value, the one acquired available reservation date and time is excluded from the determined candidate reservation dates and times of the ticket; and
when selection of one region is detected in the communication device, the one region corresponding to one day in the calendar data and representing one candidate reservation time, and when a reservation request, which indicates one candidate reservation date and time corresponding to the selected one region, is received from the communication device via the network, registering the one candidate reservation date and time indicated by the reservation request as a reservation date and time of the ticket in the information management system.

24. The method according to claim 23, wherein
the reservation date and time of the ticket is displayed at the communication device within the one region represented in the calendar data when the registration has been completed in the information management system.

25. The method according to claim 23, wherein the information management system collects to manage customer information via the network, the customer information being associated with the user of the communication device,
the method further comprising:
transmitting a notice to the communication device via the network, when it is determined based on the customer information that a ticket, which is in accordance with preferences of the user of the communication device, is present, wherein the notice indicates that the ticket is present.
